(19) United States
(12) Patent Application Publication
(10) Pub. No.: US 2012/0274596 A1
(43) Pub. Date: Nov. 1, 2012

(54) USE OF ORGANIC LIGHT EMITTING DIODE (OLED) DISPLAYS AS A HIGH-RESOLUTION OPTICAL TACTILE SENSOR FOR HIGH DIMENSIONAL TOUCHPAD (HDTP) USER INTERFACES

(76) Inventor: Lester F. LUDWIG, Belmont, CA (US)

(21) Appl. No.: 13/547,024

(22) Filed: Jul. 11, 2012

Related U.S. Application Data
(60) Provisional application No. 61/506,634, filed on Jul. 11, 2011.

(51) Int. Cl. G06F 3/041; G09G 3/30

(52) U.S. Cl. 345/173; 345/76

(57) ABSTRACT

A finger-operated touch interface system is physically associated with a visual display. The system includes a processor executing a software algorithm and an array of transparent organic light emitting diodes (OLEDs) communicating with the processor. The system operates a group of OLEDS from the OLED array in light sensing mode. These OLEDs detect light via photoelectric effect and communicate light detection measurements to the processor. The software algorithm produces tactile measurement information responsive to light reflected by a finger proximate to the OLED array, and reflected light is received by at least one OLED in the transparent OLED array and originates from a software-controlled light source. In one approach, the reflected light is modulated and the system is responsive to reflected modulated light. The processor generates a control signal responsive to the reflected light. The system can be used to implement an optical touchscreen without an RF capacitive matrix.

### CROSS-REFERENCE TO RELATED APPLICATIONS

Pursuant to 35 U.S.C. §119(e), this application claims benefit of priority from Provisional U.S. Patent application Ser. No. 61/506,634, filed Jul. 11, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

The invention relates to user interfaces providing an additional number of simultaneously-adjustable interactively-controlled discrete (clicks, taps, discrete gestures) and pseudo-continuous (downward pressure, roll, pitch, yaw, multi-touch geometric measurements, continuous gestures, etc.) user-adjustable settings and parameters, and in particular to the sequential selective tracking of subsets of parameters, and further how these can be used in applications.

By way of general introduction, a touchscreen comprises a visual display and a sensing arrangement physically associated with the visual display that can detect at least the presence and current location of one or more fingers, parts of hand, stylus, etc that are in physical contact with the surface of the visual display oriented towards the user. Typically the visual display renders visual information that is coordinated with the interpretation of the presence, current location, and perhaps other information of one or more fingers, parts of hand, stylus, etc that are in physical contact with the surface of the visual display oriented towards the user. For example, the visual display can render text, graphics, images, or other visual information in specific locations on the display, and the presence, current location, and perhaps other information of one or more fingers, parts of hand, stylus, etc that are in physical contact with the surface of the visual display at (or in many cases sufficiently near) those specific locations where the text, graphics, images, or other visual information is rendered will result in a context-specific interpretation and result. Touchscreens can accordingly implement “soft-keys” that operate as software-defined and software-labeled control buttons or selection icons.

Touchscreen technology can further be configured to operate in more sophisticated ways, such as implementing slider controls, rotating knobs, scrolling features, controlling the location of a cursor, changing the display dimensions of an image, causing the rotation of a displayed image, etc. Many such more sophisticated operations employ a physical touch-oriented metaphor, for example nudging, flicking, stretching, etc. The visual information rendered on the visual display can originate from operating system software, embedded controller software, application software, or one or more combinations of these. Similarly, interpretation of the touch measurements can be provided by operating system software, embedded controller software, application software, or one or more combinations of these. In a typical usage, application software caused the display of visual information in a specific location on the visual display, and a user touches the display on or near that specific location on the visual display, perhaps modifying the touch in some way (such as moving a touching finger from one touch location on the display to another location on the display), and the application responds in some way, often at least immediately involving a change in the visual information rendered on the visual display.

Touchscreens are often implemented by overlaying a transparent sensor over a visual display device such as an LCD, CRT, etc.) although other arrangements have certainly been used. Recently, touchscreens implemented with a transparent capacitive-matrix sensor array overlaid upon a visual display device such as an LCD have received tremendous attention because of their associated ability to facilitate the addition multi-touch sensing, metaphors, and gestures to a touchscreen-based user experience. After an initial commercial appearance in the products of FingerWorks, multi-touch sensing, metaphors, and gestures have obtained great commercial success from their defining role in the touchscreen operation of the Apple iPhone and subsequent adaptations in PDAs and other types of cell phones and hand-held devices by many manufacturers. It is noted that despite this popular notoriety and the many associated patent filings, tactile array sensors implemented as transparent touchscreens and the finger flick gesture were taught in the 1999 filings of issued U.S. Pat. No. 6,570,078 and pending U.S. patent application Ser. No. 11/761,978.

Despite many popular touch interfaces and gestures, there remains a wide range of additional control capabilities that can yet be provided by further enhanced user interface technologies. A number of enhanced touch user interface features are described in U.S. Pat. Nos. 6,570,078 and 8,169,414, pending U.S. patent application Ser. Nos. 11/761,978, 12/418,605, 12/541,948, and related pending U.S. patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications. Implementations of the HTDP provide advanced multi-touch capabilities far more sophisticated that those popularized by FingerWorks, Apple, NYU, Microsoft, Gesturetek, and others.

Further, pending U.S. patent application Ser. No. 13/180,345 teaches among other things various physical, electrical, and operational approaches to integrating a touchscreen with organic light emitting diode (OLED) arrays, displays, inorganic LED arrays, and liquid crystal displays (LCDs), etc. as well as using such arrangements to integrate other applications.

The present invention is directed to the use of OLED displays as a high-resolution optical tactile sensor for High Dimensional Touchpad (HDTP) and other touch-based user interfaces. Such an implementation can be of special interest to handheld devices such as cellphones, smartphones, Personal Digital Assistants (PDAs), tablet computers, and similar types of devices, as well as other types of systems and devices.

### SUMMARY

For purposes of summarizing, certain aspects, advantages, and novel features are described herein. Not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

The present invention is directed to the use of OLED displays as a high-resolution optical tactile sensor for HDTP user interfaces. Such an implementation can be of special interest in handheld devices such as cellphones, smartphones, PDAs, tablet computers, and similar types of devices, as well as other types of systems and devices.

One aspect of the present invention is directed to using an OLED array as a high spatial resolution of the tactile sensor.

Another aspect of the present invention is directed to using an OLED array as both a display and as a high spatial resolution of the tactile sensor.

Another aspect of the present invention is directed to using an OLED array as a high spatial resolution tactile sensor in touchscreen implementation.

Another aspect of the present invention is directed to using an OLED array as both a display and as a high spatial resolution tactile sensor in touchscreen implementation.

Another aspect of the present invention is directed to using an OLED array as a high spatial resolution tactile sensor in a touch-based user interface that provides multi-touch capabilities.

Another aspect of the present invention is directed to using an OLED array as both a display and as a high spatial resolution tactile sensor in a touch-based user interface that provides multi-touch capabilities.

Another aspect of the present invention is directed to using an OLED array as a high spatial resolution tactile sensor in an HDTP implementation.

Another aspect of the present invention is directed to using an OLED array as both a display and as a high spatial resolution tactile sensor in an HDTP implementation.

Another aspect of the present invention is directed to using an OLED array as a high spatial resolution tactile sensor in a touch-based user interface that provides at least single-touch measurement of finger contact angles and downward pressure.

Another aspect of the present invention is directed to using an OLED array as both a display and as a high spatial resolution tactile sensor in a touch-based user interface that provides at least single-touch measurement of finger contact angles and downward pressure.

Another aspect of the present invention is directed to using an OLED array as a high spatial resolution tactile sensor in a touch-based user interface that provides at least single-touch measurement of finger contact angles with the touch sensor.

Another aspect of the present invention is directed to using an OLED array as both a display and as a high spatial resolution tactile sensor in a touch-based user interface that provides at least single-touch measurement of finger contact angles with the touch sensor.

Another aspect of the present invention is directed to using an OLED array as a high spatial resolution tactile sensor in a touch-based user interface that provides at least single-touch measurement of downward pressure asserted on the touch sensor by a user finger.

Another aspect of the present invention is directed to using an OLED array as both a display and as a high spatial resolution tactile sensor in a touch-based user interface that provides at least single-touch measurement of downward pressure asserted on the touch sensor by a user finger.

Another aspect of the present invention is directed to arrangements wherein an (inorganic LED or OLED) LED array is partitioned into two subsets, one subset employed as a display and the other subset employed as a tactile sensor.

Another aspect of the present invention is directed to arrangements wherein a transparent (inorganic LED or OLED) LED array is used as a touch sensor, and overlaid atop an LCD display.

Another aspect of the present invention is directed to arrangements wherein a transparent OLED array overlaid upon an LCD display, which is in turn overlaid on a (typically) LED backlight used to create and direct light though the LCD display from behind.

Another aspect of the present invention is directed to arrangements wherein a transparent (inorganic LED or OLED) LED array is overlaid upon a second (inorganic LED or OLED) LED array, wherein one LED array is used for at least optical sensing and the other LED array used for at least visual display.

Another aspect of the present invention is directed to arrangements wherein a first transparent (inorganic LED or OLED) LED array used for at least optical sensing overlaid upon a second OLED array used for at least visual display.

Another aspect of the present invention is directed to arrangements wherein a first transparent (inorganic LED or OLED) LED array used for at least visual display overlaid upon a second OLED array used for at least optical sensing.

Another aspect of the present invention is directed to arrangements wherein an LCD display, used for at least visual display, overlaid upon a (inorganic LED or OLED) LED array, used for at least backlighting of the LCD and optical sensing.

Another aspect of the invention provides a touch interface system for the operation by at least one finger, the touch interface physically associated with a visual display, the system comprising a processor executing at least one software algorithm, and a light emitting diode (LED) array comprising a plurality of transparent organic light emitting diodes (OLEDs) forming a transparent OLED array, the transparent OLED array configured to communicate with the processor. The at least one software algorithm is configured to operate at least a first group of OLEDS from the transparent OLED array in at least a light sensing mode. The OLEDs in the at least a first group of OLEDs are configured to detect light using a photoelectric effect when light is received for an interval of time and communicates the light detection to the processor. The at least one software algorithm is configured to produce tactile measurement information, the tactile measurement information responsive to light reflected by at least a finger proximate to the OLED array, and a portion of the reflected light is reflected to at least one OLED of the first group of the transparent OLED array, the reflected light originating from a software-controlled light source. The processor is configured to generate at least one control signal responsive to light reflected by at least one finger proximate to the OLED array.

In another aspect of the invention, the software-controlled light source is another LED array.

In another aspect of the invention, the LED array is acting as the software-controlled light source is another OLED array.

In another aspect of the invention, the software-controlled light source is implemented by a second group of the transparent OLEDs from the transparent OLED array.

In another aspect of the invention, the first group of OLEDs and the second group of OLEDs are distinct.

In another aspect of the invention, the first group of the transparent OLEDs and the second group of the transparent OLEDs both comprise at least one OLED that common to both groups.

In another aspect of the invention, the first group of the transparent OLEDs and the second group of the transparent OLEDs are the same group.

In another aspect of the invention, the transparent OLED array is configured to perform light sensing for at least an interval of time.

In another aspect of the invention, the software-controlled light source comprises a Liquid Crystal Display.

In another aspect of the invention, the processor and the at least one software algorithm are configured to operate the transparent OLED array in a light emitting mode.

In another aspect of the invention, the software-controlled light source is configured to emit modulated light.

In another aspect of the invention, the reflected light comprises the modulated light.

In another aspect of the invention, the system is further configured to provide the at least one control signal responsive to the reflected light.

In another aspect of the invention, the system is further configured so that the at least one control signal comprises a high spatial resolution reflected light measurement responsive to the reflected light.

In another aspect of the invention, the system is used to implement a tactile user interface.

In another aspect of the invention, the system is used to implement a touch-based user interface.

In another aspect of the invention, the system is used to implement a touchscreen.

In another aspect of the invention, the processor is configured to generate at least one control signal responsive to changes in the light reflected by at least one finger proximate to the OLED array.

In another aspect of the invention, the processor is configured to generate at least one control signal responsive to a touch gesture performed by at least one finger proximate to the OLED array.

### BRIEF DESCRIPTION OF THE DRAWINGS

The above and other aspects, features and advantages of the present invention will become more apparent upon consideration of the following description of preferred embodiments taken in conjunction with the accompanying drawing figures.

FIGS. 1a-1g depict a number of arrangements and embodiments employing the HDTP technology.

FIGS. 2a-2e and FIGS. 3a-3b depict various integrations of an HDTP into the back of a conventional computer mouse as taught in U.S. Pat. No. 7,557,797 and in pending U.S. patent application Ser. No. 12/619,678.

FIG. 4 illustrates the side view of a finger lightly touching the surface of a tactile sensor array.

FIG. 5a is a graphical representation of a tactile image produced by contact of a human finger on a tactile sensor array. FIG. 5b provides a graphical representation of a tactile image produced by contact with multiple human fingers on a tactile sensor array.

FIG. 6 depicts a signal flow in a HDTP implementation.

FIG. 7 depicts a pressure sensor array arrangement.

FIG. 8 depicts a popularly accepted view of a typical cell phone or PDA capacitive proximity sensor implementation.

FIG. 9 depicts a multiplexed LED array acting as a reflective optical proximity sensing array.

FIGS. 10a-10c depict cameras for direct viewing of at least portions of the human hand, wherein the camera image array is employed as an HDTP tactile sensor array.

FIG. 11 depicts an arrangement comprising a video camera capturing the image of the contact of parts of the hand with a transparent or translucent surface.

FIGS. 12a-12b depicts an arrangement comprising a video camera capturing the image of a deformable material whose image varies according to applied pressure.

FIG. 13 depicts an optical or acoustic diffraction or absorption arrangement that can be used for contact or pressure sensing of tactile contact.

FIG. 14 shows a finger image wherein rather than a smooth gradient in pressure or proximity values there is radical variation due to non-uniformities in offset and scaling terms among the sensors.

FIG. 15 shows a sensor-by-sensor compensation arrangement.

FIG. 16 (adapted from http://labs.moto.com/diy-touchscreen-analysis/) depicts the comparative performance of a group of contemporary handheld devices wherein straight lines were entered using the surface of the respective touchscreens.

FIGS. 17a-17f illustrate the six independently adjustable degrees of freedom of touch from a single finger that can be simultaneously measured by the HDTP technology.

FIG. 18 suggests general ways in which two or more of these independently adjustable degrees of freedom adjusted at once.

FIG. 19 demonstrates a few two-finger multi-touch postures or gestures from the many that can be readily recognized by HTDP technology.

FIG. 20 illustrates the pressure profiles for a number of example hand contacts with a pressure-sensor array.

FIG. 21 depicts one of a wide range of tactile sensor images that can be measured by using more of the human hand

FIGS. 22a-22c depict various approaches to the handling of compound posture data images.

FIG. 23 illustrates correcting tilt coordinates with knowledge of the measured yaw angle, compensating for the expected tilt range variation as a function of measured yaw angle, and matching the user experience of tilt with a selected metaphor interpretation.

FIG. 24a depicts an embodiment wherein the raw tilt measurement is used to make corrections to the geometric center measurement under at least conditions of varying the tilt of the finger. FIG. 24b depicts an embodiment for yaw angle compensation in systems and situations wherein the yaw measurement is sufficiently affected by tilting of the finger.

FIG. 25 shows an arrangement wherein raw measurements of the six quantities of FIGS. 17a-17f, together with multi-touch parsing capabilities and shape recognition for distinguishing contact with various parts of the hand and the touchpad can be used to create a rich information flux of parameters, rates, and symbols.

FIG. 26 shows an approach for incorporating posture recognition, gesture recognition, state machines, and parsers to create an even richer human/machine tactile interface system capable of incorporating syntax and grammars.

FIGS. 27a-27d depict operations acting on various parameters, rates, and symbols to produce other parameters, rates, and symbols, including operations such as sample/hold, interpretation, context, etc.

FIG. 28 depicts a user interface input arrangement incorporating one or more HDTPs that provides user interface input event and quantity routing.

FIGS. 29a-29c depict methods for interfacing the HDTP with a browser.

FIG. 30a depicts a user-measurement training procedure wherein a user is prompted to touch the tactile sensor array in a number of different positions. FIG. 30b depicts additional postures for use in a measurement training procedure for embodiments or cases wherein a particular user does not provide sufficient variation in image shape the training. FIG. 30c depicts boundary-tracing trajectories for use in a measurement training procedure.

FIG. 31 depicts an example HDTP signal flow chain for an HDTP realization implementing multi-touch, shape and constellation (compound shape) recognition, and other features.

FIG. 32a depicts a side view of a finger and illustrating the variations in the pitch angle. FIGS. 32b-32f depict exemplary tactile image measurements (proximity sensing, pressure sensing, contact sensing, etc.) as a finger in contact with the touch sensor array is positioned at various pitch angles with respect to the surface of the sensor.

FIGS. 33a-33e depict the effect of increased downward pressure on the respective contact shapes of FIGS. 32b-32f.

FIG. 34a depicts a top view of a finger and illustrating the variations in the roll angle. FIGS. 34b-34f depict tactile image measurements (proximity sensing, pressure sensing, contact sensing, etc.) as a finger in contact with the touch sensor array is positioned at various roll angles with respect to the surface of the sensor.

FIG. 35 depicts a causal chain of calculation.

FIG. 36 depicts a utilization of this causal chain as a sequence flow of calculation blocks, albeit not a dataflow representation.

FIG. 37 depicts calculations for the left-right (“x”), front-back (“y”), downward pressure (“p”), roll (“φ”), pitch (“θ”), and yaw (“ψ”) measurements from blob data.

FIG. 38 depicts the additional parameter refinement processing comprises two or more internal parameter refinement stages that can be interconnected as advantageous.

FIG. 39 depicts a visual classification representation showing inorganic-LEDs and OLEDs as mutually-exclusive types of LEDs.

FIG. 40 depicts the spread of electron energy levels as a function of the number of associated electrons in a system such as a lattice of semiconducting material resultant from quantum state exclusion processes. (The relative positions vertically and from column-to-column are schematic and not to scale, and electron pairing effects are not accurately represented.)

FIG. 41 depicts electron energy distribution for metals, (wherein the filled valance band overlaps with the conduction band).

FIG. 42 depicts electron energy distribution for semiconductors (wherein the filled valance band is separated from the conduction band by a gap in energy values; this gap is the “band gap”).

FIG. 43 depicts a schematic representation of the relationships between valance bands and conduction bands in materials distinctly classified as metals, semiconductors, and insulators. (Adapted from Pieter Kuiper, http://en.wikipedia.org/wiki/Electronic_band_structure, visited Mar. 22, 2011.)

FIG. 44 depicts the how the energy distribution of electrons in the valance band and conduction band vary as a function of the density of electron states, and the resultant growth of the band gap as the density of electron states increases. (Adapted from Pieter Kuiper, http://en.wikipedia.org/wiki/Band_gap, visited Mar. 22, 2011.)

FIG. 45 depicts three types of electron-hole creation processes resulting from absorbed photons that contribute to current flow in a PN diode (adapted from A. Yariv, Optical Electronics, 4th edition, Saunders College Press, 1991, p. 423).

FIG. 46 depicts electron energy distribution among bonding and antibonding molecular orbitals in conjugated or aromatic organic compounds (adapted from Y. Divayana, X. Sung, Electroluminescence in Organic Light-Emitting Diodes, VDM Verlag Dr. Müller, Saarbrücken, 2009, ISBN 978-3-639-17790-9, FIG. 2.2, p. 13).

FIG. 47 depicts an optimization space for semiconductor diodes comprising attributes of signal switching performance, light emitting performance, and light detection performance.

FIG. 48 depicts a metric space of device realizations for optoelectronic devices and regions of optimization and co-optimization.

FIGS. 49-52 depict circuits demonstrating approaches to detecting light with an LED.

FIG. 53 depicts a selectable grounding capability for a two-dimensional array of LEDs.

FIG. 54 depicts the arrangement depicted in FIG. 53 that is controlled by an address decoder so that the selected subset can be associated with a unique binary address.

FIG. 55 depicts a highly-scalable electrically-multiplexed LED array display that also functions as a light field detector.

FIGS. 56 and 57 depict functional cells that can be used in a large scale array.

FIGS. 58-60 depict digital circuit measurement and display arrangements as a combination.

FIGS. 61-64 depict state diagrams for the operation of the LED and the use of input signals and output signals.

FIG. 65 shows an arrangement employed in contemporary cellphones, smartphones, PDAs, tablet computers, and other portable devices wherein a transparent capacitive matrix proximity sensor is overlaid over an LCD display, which is in turn overlaid on a (typically LED) backlight used to create and direct light though the LCD display from behind; each of the capacitive matrix and the LCD have considerable associated electronic circuitry and software associated with them.

FIG. 66 depicts a modification of the arrangement depicted in FIG. 65 wherein the LCD display and backlight are replaced with an OLED array used as a visual display; such an arrangement has started to be incorporated in recent contemporary cellphone, smartphone, PDA, tablet computers, and other portable device products by several manufacturers.

FIG. 67 depicts an arrangement provided for by the invention comprising only a LED array. The LEDs in the LED array can be OLEDs or inorganic LEDs. Such an arrangement can be used as a visual display and as a tactile user interface.

FIG. 68a depicts an arrangement wherein an (inorganic LED or OLED) LED array is partitioned into two subsets, one subset employed as a display and the other subset employed as a tactile sensor.

FIG. 69a depicts an arrangement wherein a transparent inorganic LED or OLED array is used as a touch sensor, and overlaid atop an LCD display.

FIG. 69b depicts a transparent OLED array overlaid upon an LCD display, which is in turn overlaid on a (typically) LED backlight used to create and direct light though the LCD display from behind.

FIG. 70a depicts an example arrangement wherein a transparent inorganic LED or OLED array is overlaid upon a second inorganic LED or OLED array, wherein one LED array is used for at least optical sensing and the other LED array used for at least visual display.

FIG. 70b depicts a first transparent inorganic LED or OLED array used for at least optical sensing overlaid upon a second OLED array used for at least visual display.

FIG. 71 depicts an example implementation comprising a first transparent inorganic LED or OLED array used for at least visual display overlaid upon a second OLED array used for at least optical sensing.

FIG. 72 depicts an LCD display, used for at least visual display, overlaid upon a inorganic LED or OLED array, used for at least backlighting of the LCD and optical sensing.

FIG. 73 depicts an LED array preceded by a vignetting arrangement useful for implementing a lensless imaging camera as taught in U.S. Pat. No. 8,125,559, pending U.S. patent application Ser. Nos. 12/419,229 (priority date Jan. 27, 1999), 13/072,588, and 13/452,461.

FIG. 74 depicts an LED designated to act as a light sensor surrounded by immediately-neighboring LEDs designated to emit light to illuminate the finger for example as depicted in FIG. 9.

FIG. 75 depicts an exemplary LED designated to act as a light sensor is surrounded by immediately-neighboring LEDs designated to serve as a “guard” area, for example not emitting light, these in turn surrounded by immediately-neighboring LEDs designated to emit light used to illuminate the finger for example as depicted in FIG. 9.

FIG. 76 depicts mobile devices such as cellphones, smartphones, PDAs, and tablet computers, as well as other devices.

FIG. 77 depicts FIG. 76 wherein an LED array replaces the display, camera, and touch sensor and is interfaced by a common processor that replaces associated support hardware.

FIG. 78 depicts a variation of FIG. 77 wherein the common processor associated with the LED array further executes at least some touch-based user interface software.

FIG. 79 depicts a variation of FIG. 77 wherein the common processor associated with the LED array further executes all touch-based user interface software.

### DETAILED DESCRIPTION OF THE PREFERRED EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

Despite the many popular touch interfaces and gestures in contemporary information appliances and computers, there remains a wide range of additional control capabilities that can yet be provided by further enhanced user interface technologies. A number of enhanced touch user interface features are described in U.S. Pat. Nos. 6,570,078 and 8,169,414, pending U.S. patent application Ser. Nos. 11/761,978, 12/418,605, 12/541,948, and related pending U.S. patent applications. These patents and patent applications also address popular contemporary gesture and touch features. The enhanced user interface features taught in these patents and patent applications, together with popular contemporary gesture and touch features, can be rendered by the “High Definition Touch Pad” (HDTP) technology taught in those patents and patent applications.

The present invention is directed to the use of OLED displays as a high-resolution optical tactile sensor for HDTP user interfaces.

Overview of HDTP User Interface Technology

Before providing details specific to the present invention, some embodiments of HDTP technology is provided. This will be followed by a summarizing overview of HDTP technology. With the exception of a few minor variations and examples, the material presented in this overview section is draw from U.S. Pat. Nos. 6,570,078, 8,169,414, and 8,170,346, pending U.S. patent application Ser. Nos. 11/761,978, 12/418,605, 12/541,948, 13/026,248, and related pending U.S. patent applications and is accordingly attributed to the associated inventors.

Embodiments Employing a Touchpad and Touchscreen form of a HDTP

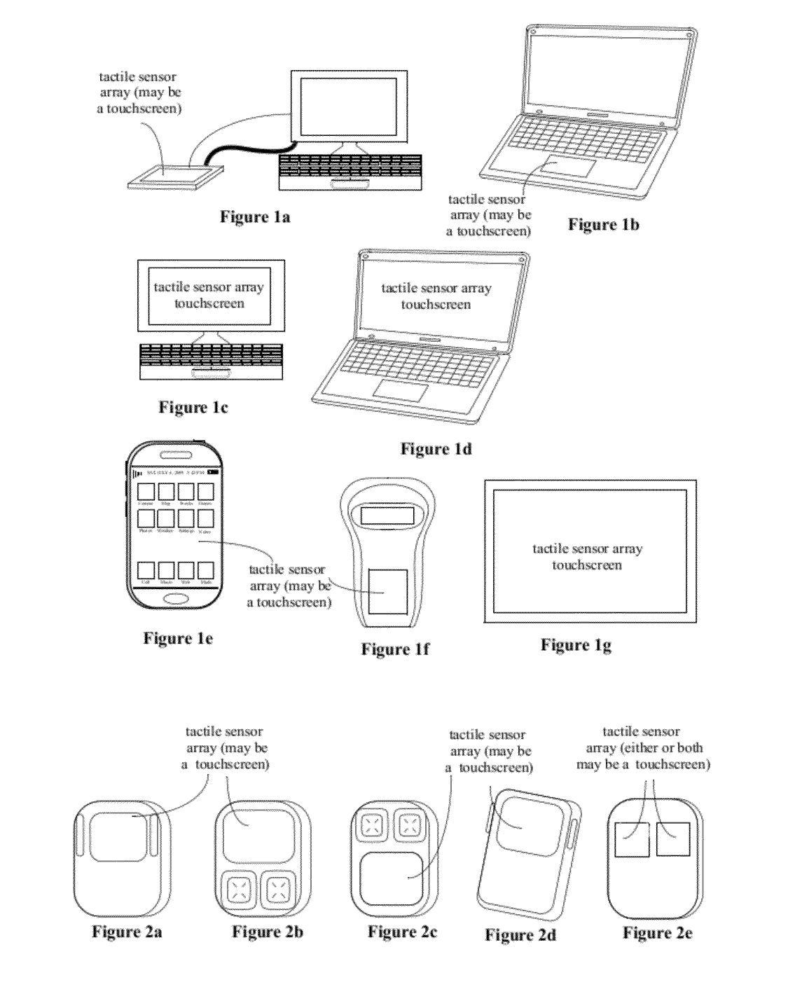

FIGS. 1a-1g (adapted from U.S. patent application Ser. No. 12/418,605) and 2a-2e (adapted from U.S. Pat. No. 7,557,797) depict a number of arrangements and embodiments employing the HDTP technology. FIG. 1a illustrates an HDTP as a peripheral that can be used with a desktop computer (shown) or laptop) not shown). FIG. 1b depicts an HDTP integrated into a laptop in place of the traditional touchpad pointing device. In FIGS. 1a-1b the HDTP tactile sensor can be a stand-alone component or can be integrated over a display so as to form a touchscreen. FIG. 1c depicts an HDTP integrated into a desktop computer display so as to form a touchscreen. FIG. 1d shows the HDTP integrated into a laptop computer display so as to form a touchscreen.

FIG. 1e depicts an HDTP integrated into a cell phone, smartphone, PDA, or other hand-held consumer device. FIG. 1f shows an HDTP integrated into a test instrument, portable service-tracking device, portable service-entry device, field instrument, or other hand-held industrial device. In FIGS. 1e-1f the HDTP tactile sensor can be a stand-alone component or can be integrated over a display so as to form a touchscreen.

FIG. 1g depicts an HDTP touchscreen configuration that can be used in a tablet computer, wall-mount computer monitor, digital television, video conferencing screen, kiosk, etc.

In at least the arrangements of FIGS. 1a, 1c, 1d, and 1g, or other sufficiently large tactile sensor implementation of the HDTP, more than one hand can be used an individually recognized as such.

Embodiments incorporating the HDTP into a Traditional or Contemporary Generation Mouse

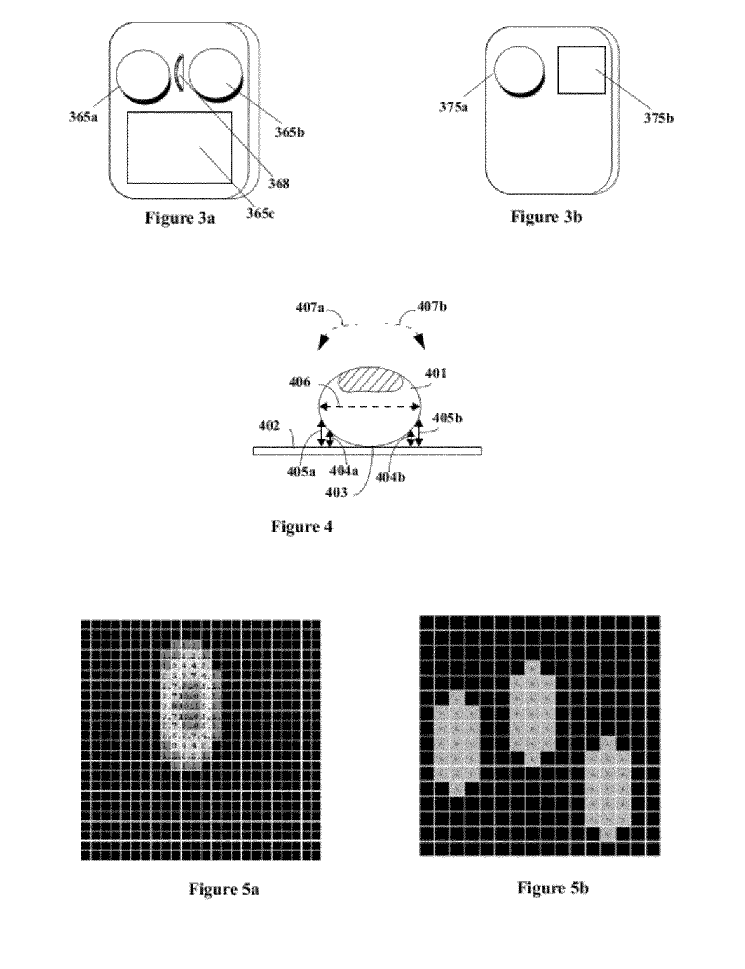

FIGS. 2a-2e and FIGS. 3a-3b (these adapted from U.S. Pat. No. 7,557,797) depict various integrations of an HDTP into the back of a conventional computer mouse. Any of these arrangements can employ a connecting cable, or the device can be wireless.

In the integrations depicted in FIGS. 2a-2d the HDTP tactile sensor can be a stand-alone component or can be integrated over a display so as to form a touchscreen. Such configurations have very recently become popularized by the product release of Apple “Magic Mouse™” although such combinations of a mouse with a tactile sensor array on its back responsive to multi-touch and gestures were taught earlier in pending U.S. patent application Ser. No. 12/619,678 (priority date Feb. 12, 2004) entitled “User Interface Mouse with Touchpad Responsive to Gestures and Multi-Touch.”

In another embodiment taught in the specification of issued U.S. Pat. No. 7,557,797 and associated pending continuation applications more than two touchpads can be included in the advance mouse embodiment, for example as suggested in the arrangement of FIG. 2e. As with the arrangements of FIGS. 2a-2d, one or more of the plurality of HDTP tactile sensors or exposed sensor areas of arrangements such as that of FIG. 2e can be integrated over a display so as to form a touchscreen. Other advance mouse arrangements include the integrated trackball/touchpad/mouse combinations of FIGS. 3a-3b taught in U.S. Pat. No. 7,557,797.

Overview of HDTP User Interface Technology

The information in this section provides an overview of HDTP user interface technology as described in U.S. Pat. Nos. 6,570,078 and 8,169,414, pending U.S. patent application Ser. Nos. 11/761,978, 12/418,605, 12/541,948, and related pending U.S. patent applications.

In an embodiment, a touchpad used as a pointing and data entry device can comprise an array of sensors. The array of sensors is used to create a tactile image of a type associated with the type of sensor and method of contact by the human hand.

In one embodiment, the individual sensors in the sensor array are pressure sensors and a direct pressure-sensing tactile image is generated by the sensor array.

In another embodiment, the individual sensors in the sensor array are proximity sensors and a direct proximity tactile image is generated by the sensor array. Since the contacting surfaces of the finger or hand tissue contacting a surface typically increasingly deforms as pressure is applied, the sensor array comprised of proximity sensors also provides an indirect pressure-sensing tactile image.

In another embodiment, the individual sensors in the sensor array can be optical sensors. In one variation of this, an optical image is generated and an indirect proximity tactile image is generated by the sensor array. In another variation, the optical image can be observed through a transparent or translucent rigid material and, as the contacting surfaces of the finger or hand tissue contacting a surface typically increasingly deforms as pressure is applied, the optical sensor array also provides an indirect pressure-sensing tactile image.

In some embodiments, the array of sensors can be transparent or translucent and can be provided with an underlying visual display element such as an alphanumeric, graphics, or image display. The underlying visual display can comprise, for example, an LED array display, a backlit LCD, etc. Such an underlying display can be used to render geometric boundaries or labels for soft-key functionality implemented with the tactile sensor array, to display status information, etc. Tactile array sensors implemented as transparent touchscreens are taught in the 1999 filings of issued U.S. Pat. No. 6,570,078 and pending U.S. patent application Ser. No. 11/761,978.

In an embodiment, the touchpad or touchscreen can comprise a tactile sensor array obtains or provides individual measurements in every enabled cell in the sensor array that provides these as numerical values. The numerical values can be communicated in a numerical data array, as a sequential data stream, or in other ways. When regarded as a numerical data array with row and column ordering that can be associated with the geometric layout of the individual cells of the sensor array, the numerical data array can be regarded as representing a tactile image. The only tactile sensor array requirement to obtain the full functionality of the HDTP is that the tactile sensor array produce a multi-level gradient measurement image as a finger, part of hand, or other pliable object varies is proximity in the immediate area of the sensor surface.

Such a tactile sensor array should not be confused with the “null/contact” touchpad which, in normal operation, acts as a pair of orthogonally responsive potentiometers. These “null/contact” touchpads do not produce pressure images, proximity images, or other image data but rather, in normal operation, two voltages linearly corresponding to the location of a left-right edge and forward-back edge of a single area of contact. Such “null/contact” touchpads, which are universally found in existing laptop computers, are discussed and differentiated from tactile sensor arrays in issued U.S. Pat. No. 6,570,078 and pending U.S. patent application Ser. No. 11/761,978. Before leaving this topic, it is pointed out that these the “null/contact” touchpads nonetheless can be inexpensively adapted with simple analog electronics to provide at least primitive multi-touch capabilities as taught in issued U.S. Pat. No. 6,570,078 and pending U.S. patent application Ser. No. 11/761,978 (pre-grant publication U.S. 2007/0229477 and therein, paragraphs [0022]-[0029], for example).

More specifically, FIG. 4 (adapted from U.S. patent application Ser. No. 12/418,605) illustrates the side view of a finger 401 lightly touching the surface 402 of a tactile sensor array. In this example, the finger 401 contacts the tactile sensor surface in a relatively small area 403. In this situation, on either side the finger curves away from the region of contact 403, where the non-contacting yet proximate portions of the finger grow increasingly far 404a, 405a, 404b, 405b from the surface of the sensor 402. These variations in physical proximity of portions of the finger with respect to the sensor surface should cause each sensor element in the tactile proximity sensor array to provide a corresponding proximity measurement varying responsively to the proximity, separation distance, etc. The tactile proximity sensor array advantageously comprises enough spatial resolution to provide a plurality of sensors within the area occupied by the finger (for example, the area comprising width 406). In this case, as the finger is pressed down, the region of contact 403 grows as the more and more of the pliable surface of the finger conforms to the tactile sensor array surface 402, and the distances 404a, 405a, 404b, 405b contract. If the finger is tilted, for example by rolling in the user viewpoint counterclockwise (which in the depicted end-of-finger viewpoint clockwise 407a) the separation distances on one side of the finger 404a, 405a will contract while the separation distances on one side of the finger 404b, 405b will lengthen. Similarly if the finger is tilted, for example by rolling in the user viewpoint clockwise (which in the depicted end-of-finger viewpoint counterclockwise 407b) the separation distances on the side of the finger 404b, 405b will contract while the separation distances on the side of the finger 404a, 405a will lengthen.

In many various embodiments, the tactile sensor array can be connected to interface hardware that sends numerical data responsive to tactile information captured by the tactile sensor array to a processor. In various embodiments, this processor will process the data captured by the tactile sensor array and transform it various ways, for example into a collection of simplified data, or into a sequence of tactile image “frames” (this sequence akin to a video stream), or into highly refined information responsive to the position and movement of one or more fingers and other parts of the hand.

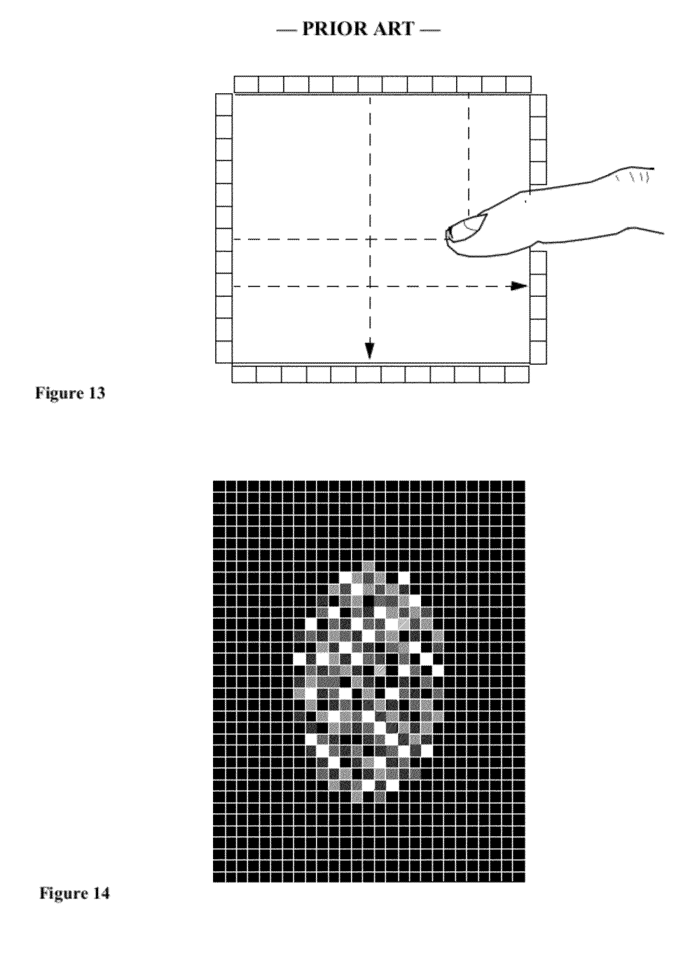

As to further detail of the latter example, a “frame” can refer to a 2-dimensional list, number of rows by number of columns, of tactile measurement value of every pixel in a tactile sensor array at a given instance. The time interval between one frame and the next one depends on the frame rate of the system and the number of frames in a unit time (usually frames per second). However, these features are and are not firmly required. For example, in some embodiments a tactile sensor array can not be structured as a 2-dimensional array but rather as row-aggregate and column-aggregate measurements (for example row sums and columns sums as in the tactile sensor of year 2003-2006 Apple Powerbooks, row and column interference measurement data as can be provided by a surface acoustic wave or optical transmission modulation sensor as discussed later in the context of FIG. 13, etc.). Additionally, the frame rate can be adaptively-variable rather than fixed, or the frame can be segregated into a plurality regions each of which are scanned in parallel or conditionally (as taught in U.S. Pat. No. 6,570,078 and pending U.S. patent application Ser. No. 12/418,605), etc.

FIG. 5a (adapted from U.S. patent application Ser. No. 12/418,605) depicts a graphical representation of a tactile image produced by contact with the bottom surface of the most outward section (between the end of the finger and the most nearby joint) of a human finger on a tactile sensor array. In this tactile array, there are 24 rows and 24 columns; other realizations can have significantly more (hundreds or thousands) of rows and columns. Tactile measurement values of each cell are indicated by the numbers and shading in each cell. Darker cells represent cells with higher tactile measurement values. Similarly, FIG. 5b (also adapted from U.S. patent application Ser. No. 12/418,605) provides a graphical representation of a tactile image produced by contact with multiple human fingers on a tactile sensor array. In other embodiments, there can be a larger or smaller number of pixels for a given images size, resulting in varying resolution. Additionally, there can be larger or smaller area with respect to the image size resulting in a greater or lesser potential measurement area for the region of contact to be located in or move about.

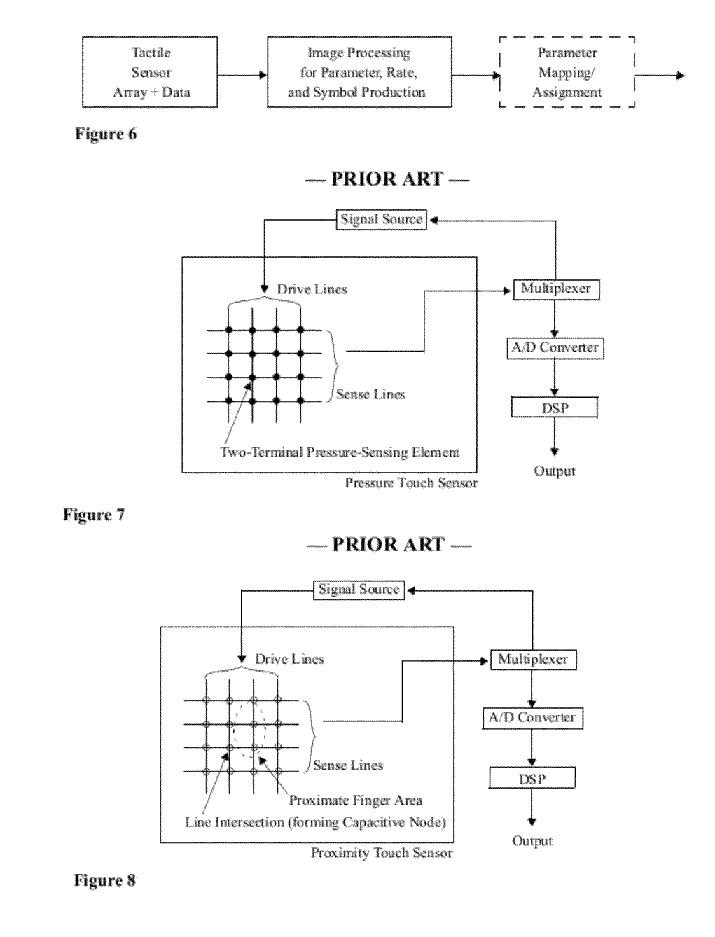

FIG. 6 (adapted from U.S. patent application Ser. No. 12/418,605) depicts a realization wherein a tactile sensor array is provided with real-time or near-real-time data acquisition capabilities. The captured data reflects spatially distributed tactile measurements (such as pressure, proximity, etc.). The tactile sensory array and data acquisition stage provides this real-time or near-real-time tactile measurement data to a specialized image processing arrangement for the production of parameters, rates of change of those parameters, and symbols responsive to aspects of the hand's relationship with the tactile or other type of sensor array. In some applications, these measurements can be used directly. In other situations, the real-time or near-real-time derived parameters can be directed to mathematical mappings (such as scaling, offset, and nonlinear warpings) in real-time or near-real-time into real-time or near-real-time application-specific parameters or other representations useful for applications. In some embodiments, general purpose outputs can be assigned to variables defined or expected by the application.

Types of Tactile Sensor Arrays

The tactile sensor array employed by HDTP technology can be implemented by a wide variety of means, for example:
Pressure sensor arrays (implemented by for example—although not limited to—one or more of resistive, capacitive, piezo, optical, acoustic, or other sensing elements);
Pressure sensor arrays (implemented by for example—although not limited to—one or more of resistive, capacitive, piezo, optical, acoustic, or other sensing elements);
Proximity sensor arrays (implemented by for example—although not limited to—one or more of capacitive, optical, acoustic, or other sensing elements);
Surface-contact sensor arrays (implemented by for example—although not limited to—one or more of resistive, capacitive, piezo, optical, acoustic, or other sensing elements).

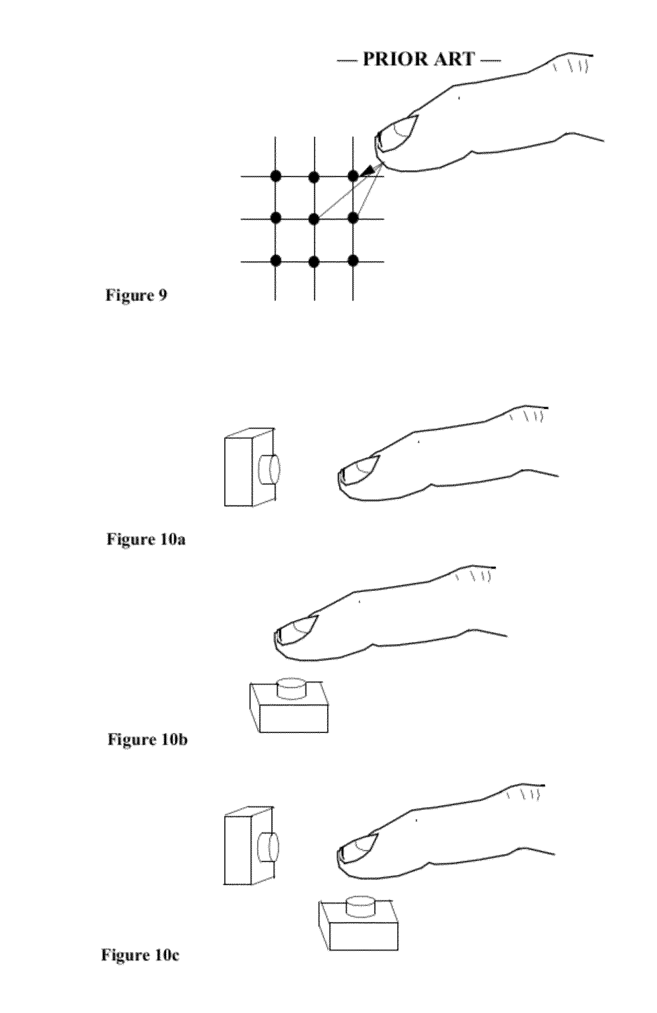

Below a few specific examples of the above are provided by way of illustration; however these are by no means limiting. The examples include:
Pressure sensor arrays comprising arrays of isolated sensors (FIG. 7);
Capacitive proximity sensors (FIG. 8);
Multiplexed LED optical reflective proximity sensors (FIG. 9);

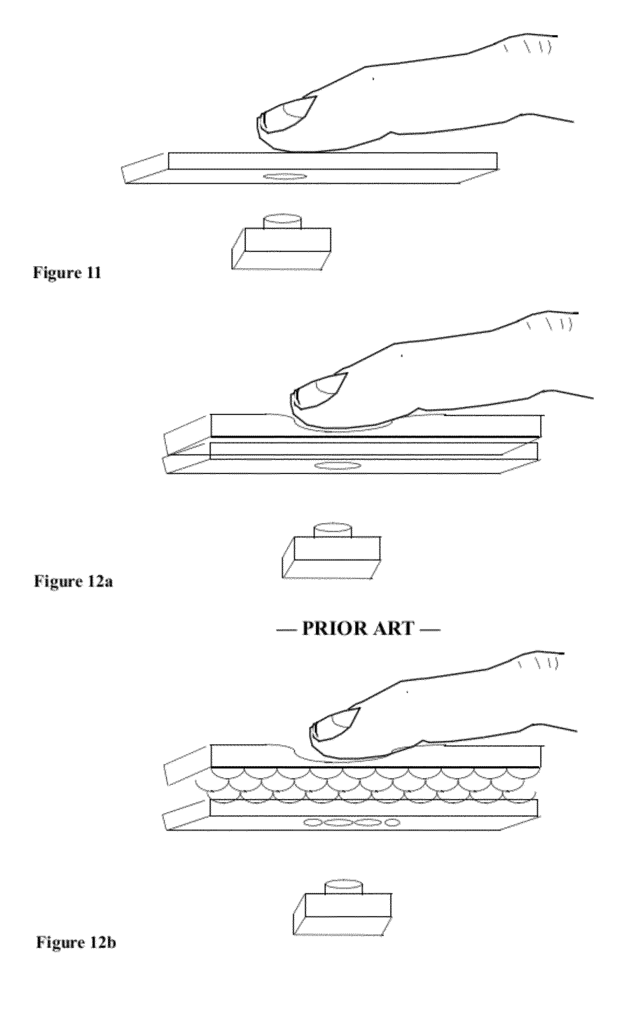

Video camera optical reflective sensing (as taught in U.S. Pat. No. 6,570,078 and U.S. patent application Ser. Nos. 10/683,915 and 11/761,978):
direct image of hand (FIGS. 10a-10c);
image of deformation of material (FIG. 11);
Surface contract refraction/absorption (FIG. 12)

An example implementation of a tactile sensor array is a pressure sensor array. Pressure sensor arrays discussed in U.S. Pat. No. 6,570,078 and pending U.S. patent application Ser. No. 11/761,978. FIG. 7 depicts a pressure sensor array arrangement comprising a rectangular array of isolated individual two-terminal pressure sensor elements. Such two-terminal pressure sensor elements typically operate by measuring changes in electrical (resistive, capacitive) or optical properties of an elastic material as the material is compressed. In typical embodiment, each sensor element in the sensor array can be individually accessed via multiplexing arrangement, for example as shown in FIG. 7, although other arrangements are possible and provided for by the invention. Examples of prominent manufacturers and suppliers of pressure sensor arrays include Tekscan, Inc. (307 West First Street., South Boston, Mass., 02127, www.tekscan.com), Pressure Profile Systems (5757 Century Boulevard, Suite 600, Los Angeles, Calif. 90045, www.pressureprofile.com), Sensor Products, Inc. (300 Madison Avenue, Madison, N.J. 07940 USA, www.sensorprod.com), and Xsensor Technology Corporation (Suite 111, 319-2nd Ave SW, Calgary, Alberta T2P 005, Canada, www.xsensor.com).

Capacitive proximity sensors can be used in various handheld devices with touch interfaces (see for example, among many, http://electronics.howstuffworks.com/iphone2.htm, http://www.veritasetvisus.com/VVTP-12,%20Walker.pdf). Prominent manufacturers and suppliers of such sensors, both in the form of opaque touchpads and transparent touchscreens, include Balda AG (Bergkirchener Str. 228, 32549 Bad Oeynhausen, Del., www.balda.de), Cypress (198 Champion Ct., San Jose, Calif. 95134, www.cypress.com), and Synaptics (2381 Bering Dr., San Jose, Calif. 95131, www.synaptics.com). In such sensors, the region of finger contact is detected by variations in localized capacitance resulting from capacitive proximity effects induced by an overlapping or otherwise nearly-adjacent finger. More specifically, the electrical field at the intersection of orthogonally-aligned conductive buses is influenced by the vertical distance or gap between the surface of the sensor array and the skin surface of the finger. Such capacitive proximity sensor technology is low-cost, reliable, long-life, stable, and can readily be made transparent. FIG. 8 (adapted from http://www.veritasetvisus.com/VVTP-12,%20Walker.pdf with slightly more functional detail added) shows a popularly accepted view of a typical cell phone or PDA capacitive proximity sensor implementation. Capacitive sensor arrays of this type can be highly susceptible to noise and various shielding and noise-suppression electronics and systems techniques can need to be employed for adequate stability, reliability, and performance in various electric field and electromagnetically-noisy environments. In some embodiments of an HDTP, the present invention can use the same spatial resolution as current capacitive proximity touchscreen sensor arrays. In other embodiments of the present invention, a higher spatial resolution is advantageous.

Forrest M. Mims is credited as showing that an LED can be used as a light detector as well as a light emitter. Recently, light-emitting diodes have been used as a tactile proximity sensor array (for example, as depicted in the video available at http://cs.nyu.edu/˜jhan/ledtouch/index.html). Such tactile proximity array implementations typically need to be operated in a darkened environment (as seen in the video in the above web link). In one embodiment provided for by the invention, each LED in an array of LEDs can be used as a photodetector as well as a light emitter, although a single LED can either transmit or receive information at one time. Each LED in the array can sequentially be selected to be set to be in receiving mode while others adjacent to it are placed in light emitting mode. A particular LED in receiving mode can pick up reflected light from the finger, provided by said neighboring illuminating-mode LEDs. FIG. 9 depicts an implementation. The invention provides for additional systems and methods for not requiring darkness in the user environment in order to operate the LED array as a tactile proximity sensor. In one embodiment, potential interference from ambient light in the surrounding user environment can be limited by using an opaque pliable or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art. In another embodiment, potential interference from ambient light in the surrounding user environment can be limited by employing amplitude, phase, or pulse width modulated circuitry or software to control the underlying light emission and receiving process. For example, in an implementation the LED array can be configured to emit modulated light modulated at a particular carrier frequency or variational waveform and respond to only modulated light signal components extracted from the received light signals comprising that same carrier frequency or variational waveform. Such a system and method can be readily implemented in a wide variety of ways as is clear to one skilled in the art.

Use of video cameras for gathering control information from the human hand in various ways is discussed in U.S. Pat. No. 6,570,078 and Pending U.S. patent application Ser. No. 10/683,915. Here the camera image array is employed as an HDTP tactile sensor array. Images of the human hand as captured by video cameras can be used as an enhanced multiple-parameter interface responsive to hand positions and gestures, for example as taught in U.S. patent application Ser. No. 10/683,915 Pre-Grant-Publication 2004/0118268 (paragraphs [314], [321]-[332], [411], [653], both stand-alone and in view of [325], as well as [241]-[263]). FIGS. 10a and 10b depict single camera implementations, while FIG. 10c depicts a two camera implementation. As taught in the aforementioned references, a wide range of relative camera sizes and positions with respect to the hand are provided for, considerably generalizing the arrangements shown in FIGS. 10a-10c.

In another video camera tactile controller embodiment, a flat or curved transparent or translucent surface or panel can be used as sensor surface. When a finger is placed on the transparent or translucent surface or panel, light applied to the opposite side of the surface or panel reflects light in a distinctly different manner than in other regions where there is no finger or other tactile contact. The image captured by an associated video camera will provide gradient information responsive to the contact and proximity of the finger with respect to the surface of the translucent panel. For example, the parts of the finger that are in contact with the surface will provide the greatest degree of reflection while parts of the finger that curve away from the surface of the sensor provide less reflection of the light. Gradients of the reflected light captured by the video camera can be arranged to produce a gradient image that appears similar to the multilevel quantized image captured by a pressure sensor. By comparing changes in gradient, changes in the position of the finger and pressure applied by the finger can be detected. FIG. 11 depicts an implementation.

FIGS. 12a-12b depict an implementation of an example arrangement comprising a video camera capturing the image of a deformable material whose image varies according to applied pressure. In the example of FIG. 12a, the deformable material serving as a touch interface surface can be such that its intrinsic optical properties change in response to deformations, for example by changing color, index of refraction, degree of reflectivity, etc. In another approach, the deformable material can be such that exogenous optic phenomena are modulated n response to the deformation. As an example, the arrangement of FIG. 12b is such that the opposite side of the deformable material serving as a touch interface surface comprises deformable bumps which flatten out against the rigid surface of a transparent or translucent surface or panel. The diameter of the image as seen from the opposite side of the transparent or translucent surface or panel increases as the localized pressure from the region of hand contact increases. Such an approach was created by Professor Richard M. White at U.C. Berkeley in the 1980's.

FIG. 13 depicts an optical or acoustic diffraction or absorption arrangement that can be used for contact or pressure sensing of tactile contact. Such a system can employ, for example light or acoustic waves. In this class of methods and systems, contact with or pressure applied onto the touch surface causes disturbances (diffraction, absorption, reflection, etc.) that can be sensed in various ways. The light or acoustic waves can travel within a medium comprised by or in mechanical communication with the touch surface. A slight variation of this is where surface acoustic waves travel along the surface of, or interface with, a medium comprised by or in mechanical communication with the touch surface.

Compensation for Non-Ideal Behavior of Tactile Sensor Arrays

Individual sensor elements in a tactile sensor array produce measurements that vary sensor-by-sensor when presented with the same stimulus. Inherent statistical averaging of the algorithmic mathematics can damp out much of this, but for small image sizes (for example, as rendered by a small finger or light contact), as well as in cases where there are extremely large variances in sensor element behavior from sensor to sensor, the invention provides for each sensor to be individually calibrated in implementations where that can be advantageous. Sensor-by-sensor measurement value scaling, offset, and nonlinear warpings can be invoked for all or selected sensor elements during data acquisition scans. Similarly, the invention provides for individual noisy or defective sensors can be tagged for omission during data acquisition scans.

FIG. 14 shows a finger image wherein rather than a smooth gradient in pressure or proximity values there is radical variation due to non-uniformities in offset and scaling terms among the sensors.

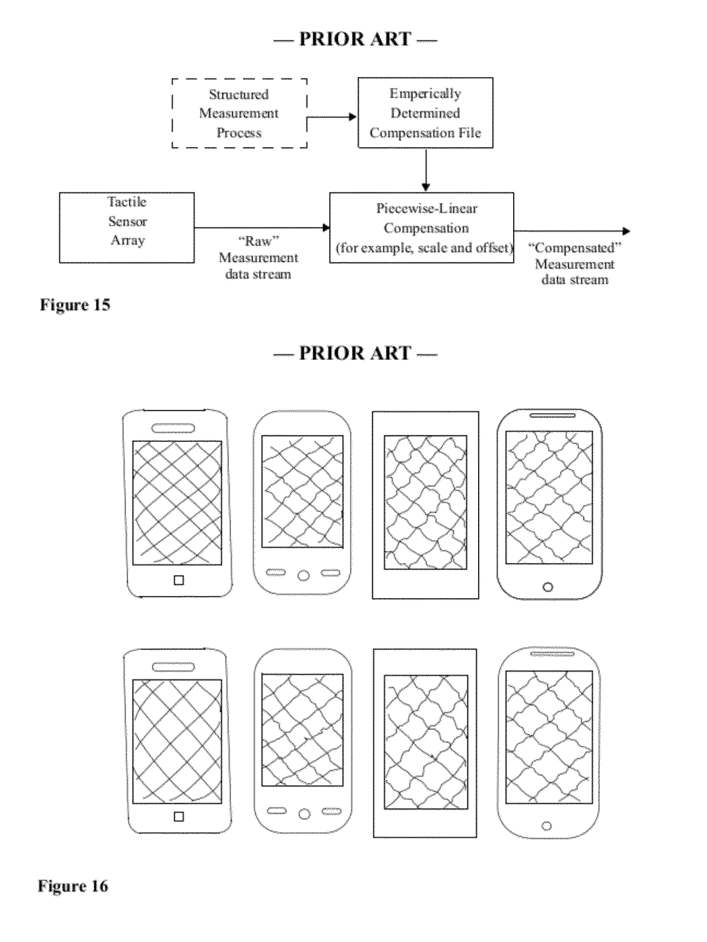

FIG. 15 shows a sensor-by-sensor compensation arrangement for such a situation. A structured measurement process applies a series of known mechanical stimulus values (for example uniform applied pressure, uniform simulated proximity, etc.) to the tactile sensor array and measurements are made for each sensor. Each measurement data point for each sensor is compared to what the sensor should read and a piecewise-linear correction is computed. In an embodiment, the coefficients of a piecewise-linear correction operation for each sensor element are stored in a file. As the raw data stream is acquired from the tactile sensor array, sensor-by-sensor the corresponding piecewise-linear correction coefficients are obtained from the file and used to invoke a piecewise-linear correction operation for each sensor measurement. The value resulting from this time-multiplexed series of piecewise-linear correction operations forms an outgoing “compensated” measurement data stream. Such an arrangement is employed, for example, as part of the aforementioned Tekscan resistive pressure sensor array products.

Additionally, the macroscopic arrangement of sensor elements can introduce nonlinear spatial warping effects. As an example, various manufacturer implementations of capacitive proximity sensor arrays and associated interface electronics are known to comprise often dramatic nonlinear spatial warping effects. FIG. 16 (adapted from http://labs.moto.com/diy-touchscreen-analysis/) depicts the comparative performance of a group of contemporary handheld devices wherein straight lines were entered using the surface of the respective touchscreens. A common drawing program was used on each device, with widely-varying type and degrees of nonlinear spatial warping effects clearly resulting. For simple gestures such as selections, finger-flicks, drags, spreads, etc., such nonlinear spatial warping effects introduce little consequence. For more precision applications, such nonlinear spatial warping effects introduce unacceptable performance. Close study of FIG. 16 shows different types of responses to tactile stimulus in the direct neighborhood of the relatively widely-spaced capacitive sensing nodes versus tactile stimulus in the boundary regions between capacitive sensing nodes. Increasing the number of capacitive sensing nodes per unit area can reduce this, as can adjustments to the geometry of the capacitive sensing node conductors. In many cases improved performance can be obtained by introducing or more carefully implementing interpolation mathematics.

Types of Hand Contact Measurements and Features provided by HDTP Technology

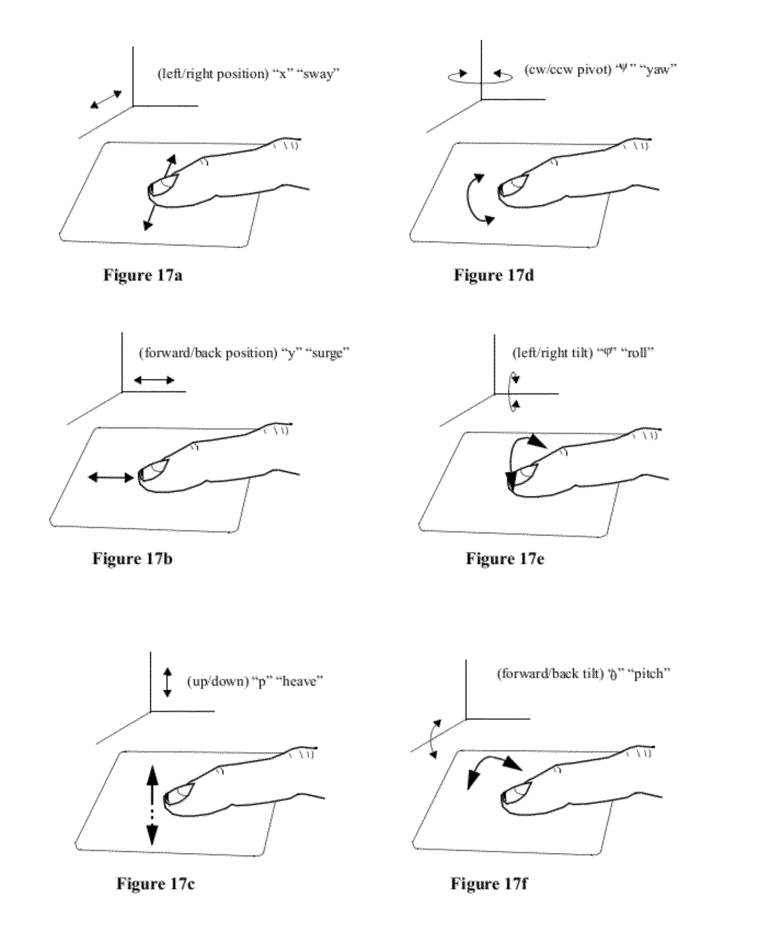

FIGS. 17a-17f (adapted from U.S. patent application Ser. No. 12/418,605 and described in U.S. Pat. No. 6,570,078) illustrate six independently adjustable degrees of freedom of touch from a single finger that can be simultaneously measured by the HDTP technology. The depiction in these figures is from the side of the touchpad. FIGS. 17a-17c show actions of positional change (amounting to applied pressure in the case of FIG. 17c) while FIGS. 17d-17f show actions of angular change. Each of these can be used to control a user interface parameter, allowing the touch of a single fingertip to control up to six simultaneously-adjustable quantities in an interactive user interface.

Each of the six parameters listed above can be obtained from operations on a collection of sums involving the geometric location and tactile measurement value of each tactile measurement sensor. Of the six parameters, the left-right geometric center, forward-back geometric center, and clockwise-counterclockwise yaw rotation can be obtained from binary threshold image data. The average downward pressure, roll, and pitch parameters are in some embodiments beneficially calculated from gradient (multi-level) image data. One remark is that because binary threshold image data is sufficient for the left-right geometric center, forward-back geometric center, and clockwise-counterclockwise yaw rotation parameters, these also can be discerned for flat regions of rigid non-pliable objects, and thus the HDTP technology thus can be adapted to discern these three parameters from flat regions with striations or indentations of rigid non-pliable objects.

These ‘Position Displacement’ parameters FIGS. 17a-17c can be realized by various types of unweighted averages computed across the blob of one or more of each the geometric location and tactile measurement value of each above-threshold measurement in the tactile sensor image. The pivoting rotation can be calculated from a least-squares slope which in turn involves sums taken across the blob of one or more of each the geometric location and the tactile measurement value of each active cell in the image; alternatively a high-performance adapted eigenvector method taught in U.S. Pat. No. 8,170,346 can be used. The last two angle (i.e., finger “tilt”) parameters, pitch and roll, can be calculated via real-time curve fitting taught in pending U.S. patent application Ser. Nos. 13/038,372 and 13/544,960, as well as by performing calculations on various types of weighted averages and moments calculated from blob measurements and other methods (for example, such as those taught in pending U.S. patent application Ser. Nos. 13/009,845 and 61/522,239.

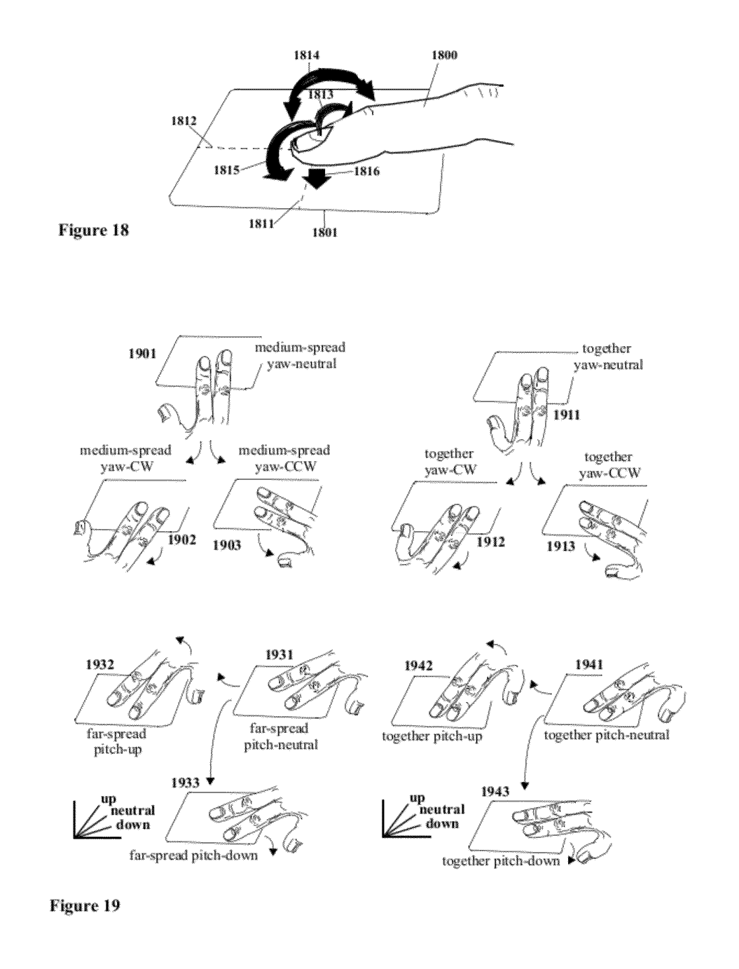

Each of the six parameters portrayed in FIGS. 17a-17f can be measured separately and simultaneously in parallel. FIG. 18 (adapted from U.S. Pat. No. 6,570,078) suggests general ways in which two or more of these independently adjustable degrees of freedom adjusted at once.

The HDTP technology provides for multiple points of contact, these days referred to as “multi-touch.” FIG. 19 (adapted from U.S. patent application Ser. No. 12/418,605 and described in U.S. Pat. No. 6,570,078) demonstrates a few two-finger multi-touch postures or gestures from the hundreds that can be readily recognized by HTDP technology. HTDP technology can also be configured to recognize and measure postures and gestures involving three or more fingers, various parts of the hand, the entire hand, multiple hands, etc. Accordingly, the HDTP technology can be configured to measure areas of contact separately, recognize shapes, fuse measures or pre-measurement data so as to create aggregated measurements, and other operations.

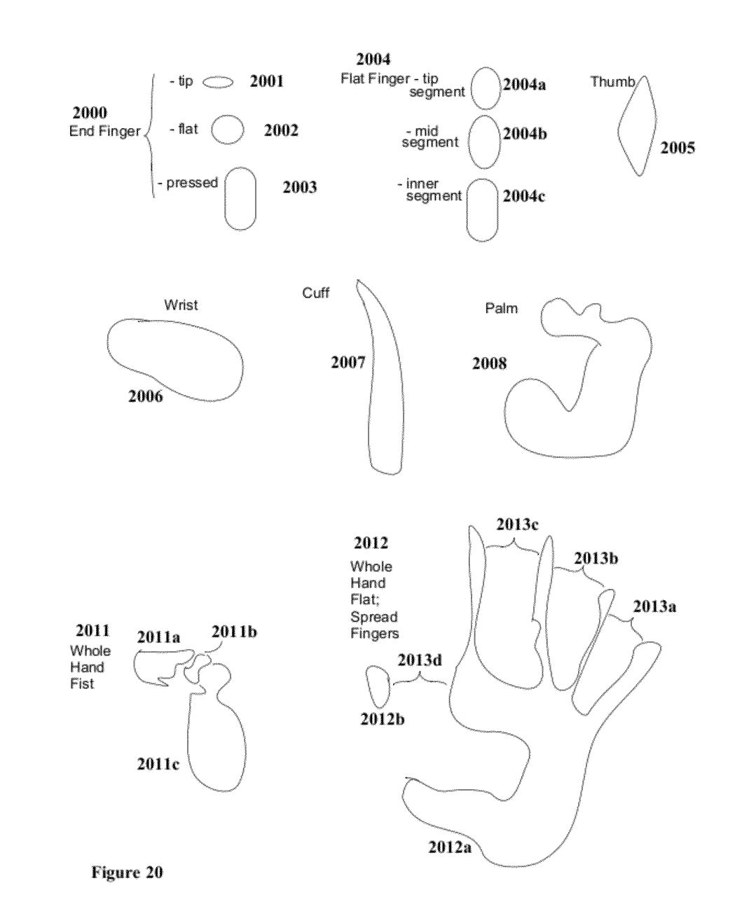

By way of example, FIG. 20 (adapted from U.S. Pat. No. 6,570,078) illustrates the pressure profiles for a number of example hand contacts with a pressure-sensor array. In the case 2000 of a finger's end, pressure on the touch pad pressure-sensor array can be limited to the finger tip, resulting in a spatial pressure distribution profile 2001; this shape does not change much as a function of pressure. Alternatively, the finger can contact the pad with its flat region, resulting in light pressure profiles 2002 which are smaller in size than heavier pressure profiles 2003. In the case 2004 where the entire finger touches the pad, a three-segment pattern (2004a, 2004b, 2004c) will result under many conditions; under light pressure a two segment pattern (2004b or 2004c missing) could result. In all but the lightest pressures the thumb makes a somewhat discernible shape 2005 as do the wrist 2006, edge-of-hand “cuff” 2007, and palm 2008; at light pressures these patterns thin and can also break into disconnected regions. Whole hand patterns such the fist 2011 and flat hand 2012 have more complex shapes. In the case of the fist 2011, a degree of curl can be discerned from the relative geometry and separation of sub-regions (here depicted, as an example, as 2011a, 2011b, and 2011c). In the case of the whole flat hand 2000, there can be two or more sub-regions which can be in fact joined (as within 2012a) or disconnected (as an example, as 2012a and 2012b are); the whole hand also affords individual measurement of separation “angles” among the digits and thumb (2013a, 2013b, 2013c, 2013d) which can easily be varied by the user.

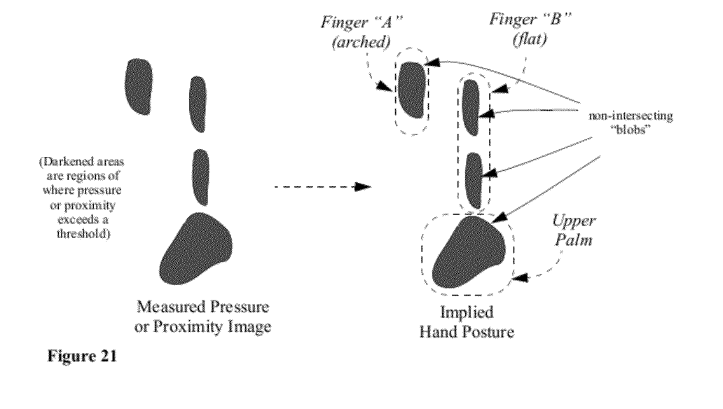

HDTP technology robustly provides feature-rich capability for tactile sensor array contact with two or more fingers, with other parts of the hand, or with other pliable (and for some parameters, non-pliable) objects. In one embodiment, one finger on each of two different hands can be used together to at least double number of parameters that can be provided. Additionally, new parameters particular to specific hand contact configurations and postures can also be obtained. By way of example, FIG. 21 (adapted from U.S. patent application Ser. No. 12/418,605 and described in U.S. Pat. No. 6,570,078) depicts one of a wide range of tactile sensor images that can be measured by using more of the human hand. U.S. Pat. No. 6,570,078 and pending U.S. patent application Ser. No. 11/761,978 provide additional detail on use of other parts of hand. Within the context of the example of FIG. 21:
multiple fingers can be used with the tactile sensor array, with or without contact by other parts of the hand;
The whole hand can be tilted & rotated;
The thumb can be independently rotated in yaw angle with respect to the yaw angle held by other fingers of the hand;
Selected fingers can be independently spread, flatten, arched, or lifted;
The palms and wrist cuff can be used;
Shapes of individual parts of the hand and combinations of them can be recognized.
   Selected combinations of such capabilities can be used to provide an extremely rich pallet of primitive control signals that can be used for a wide variety of purposes and applications.

Other HDTP Processing, Signal Flows, and Operations

In order to accomplish this range of capabilities, HDTP technologies must be able to parse tactile images and perform operations based on the parsing. In general, contact between the tactile-sensor array and multiple parts of the same hand forfeits some degrees of freedom but introduces others. For example, if the end joints of two fingers are pressed against the sensor array as in FIG. 21, it will be difficult or impossible to induce variations in the image of one of the end joints in six different dimensions while keeping the image of the other end joints fixed. However, there are other parameters that can be varied, such as the angle between two fingers, the difference in coordinates of the finger tips, and the differences in pressure applied by each finger.

In general, compound images can be adapted to provide control over many more parameters than a single contiguous image can. For example, the two-finger postures considered above can readily pro-vide a nine-parameter set relating to the pair of fingers as a separate composite object adjustable within an ergonomically comfortable range. One example nine-parameter set the two-finger postures consider above is:
composite average x position;
inter-finger differential x position;
composite average y position;
inter-finger differential y position;
composite average pressure;
inter-finger differential pressure;
composite roll;
composite pitch;
composite yaw.

As another example, by using the whole hand pressed flat against the sensor array including the palm and wrist, it is readily possible to vary as many as sixteen or more parameters independently of one another. A single hand held in any of a variety of arched or partially-arched postures provides a very wide range of postures that can be recognized and parameters that can be calculated.

When interpreted as a compound image, extracted parameters such as geometric center, average downward pressure, tilt (pitch and roll), and pivot (yaw) can be calculated for the entirety of the asterism or constellation of smaller blobs. Additionally, other parameters associated with the asterism or constellation can be calculated as well, such as the aforementioned angle of separation between the fingers. Other examples include the difference in downward pressure applied by the two fingers, the difference between the left-right (“x”) centers of the two fingertips, and the difference between the two forward-back (“y”) centers of the two fingertips. Other compound image parameters are possible and are provided by HDTP technology.

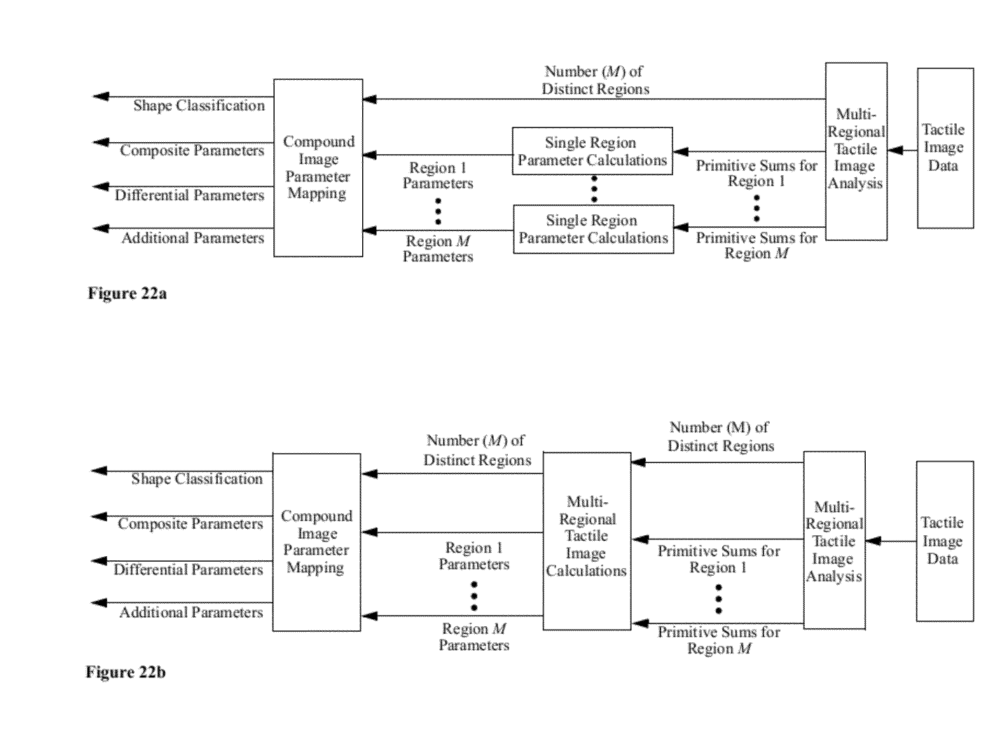

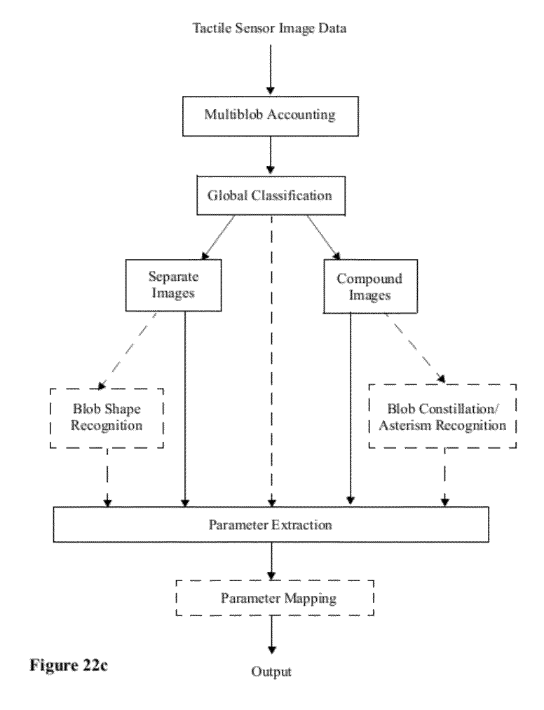

There are number of ways for implementing the handling of compound posture data images. Two contrasting examples are depicted in FIGS. 22a-22b (adapted from U.S. patent application Ser. No. 12/418,605) although many other possibilities exist and are provided for by the invention. In the embodiment of FIG. 22a, tactile image data is examined for the number “M” of isolated blobs (“regions”) and the primitive running sums are calculated for each blob. This can be done, for example, with the algorithms described earlier. Post-scan calculations can then be performed for each blob, each of these producing an extracted parameter set (for example, x position, y position, average pressure, roll, pitch, yaw) uniquely associated with each of the M blobs (“regions”). The total number of blobs and the extracted parameter sets are directed to a compound image parameter mapping function to produce various types of outputs, including:
Shape classification (for example finger tip, first-joint flat finger, two-joint flat finger, three joint-flat finger, thumb, palm, wrist, compound two-finger, compound three-finger, composite 4-finger, whole hand, etc.);
Composite parameters (for example composite x position, composite y position, composite average pressure, composite roll, composite pitch, composite yaw, etc.);
Differential parameters (for example pair-wise inter-finger differential x position, pair-wise inter-finger differential y position, pair-wise inter-finger differential pressure, etc.);
Additional parameters (for example, rates of change with respect to time, detection that multiple finger images involve multiple hands, etc.).

FIG. 22b depicts an alternative embodiment, tactile image data is examined for the number M of isolated blobs (“regions”) and the primitive running sums are calculated for each blob, but this information is directed to a multi-regional tactile image parameter extraction stage. Such a stage can include, for example, compensation for minor or major ergonomic interactions among the various degrees of postures of the hand. The resulting compensation or otherwise produced extracted parameter sets (for example, x position, y position, average pressure, roll, pitch, yaw) uniquely associated with each of the M blobs and total number of blobs are directed to a compound image parameter mapping function to produce various types of outputs as described for the arrangement of FIG. 22a.

Additionally, embodiments of the invention can be set up to recognize one or more of the following possibilities:
Single contact regions (for example a finger tip);
Multiple independent contact regions (for example multiple fingertips of one or more hands);
Fixed-structure (“constellation”) compound regions (for example, the palm, multiple-joint finger contact as with a flat finger, etc.);
Variable-structure (“asterism”) compound regions (for example, the palm, multiple-joint finger contact as with a flat finger, etc.).

Embodiments that recognize two or more of these possibilities can further be able to discern and process combinations of two more of the possibilities.

FIG. 22c (adapted from U.S. patent application Ser. No. 12/418,605) depicts a simple system for handling one, two, or more of the above listed possibilities, individually or in combination. In the general arrangement depicted, tactile sensor image data is analyzed (for example, in the ways described earlier) to identify and isolate image data associated with distinct blobs. The results of this multiple-blob accounting is directed to one or more global classification functions set up to effectively parse the tactile sensor image data into individual separate blob images or individual compound images. Data pertaining to these individual separate blob or compound images are passed on to one or more parallel or serial parameter extraction functions. The one or more parallel or serial parameter extraction functions can also be provided information directly from the global classification function(s). Additionally, data pertaining to these individual separate blob or compound images are passed on to additional image recognition function(s), the output of which can also be provided to one or more parallel or serial parameter extraction function(s). The output(s) of the parameter extraction function(s) can then be either used directly, or first processed further by parameter mapping functions. Clearly other implementations are also possible to one skilled in the art and these are provided for by the invention.

Refining of the HDTP User Experience

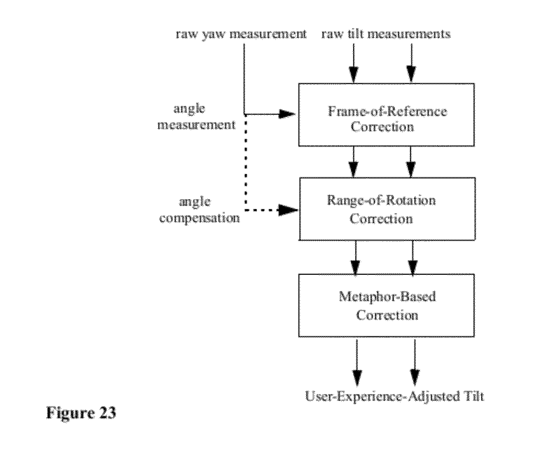

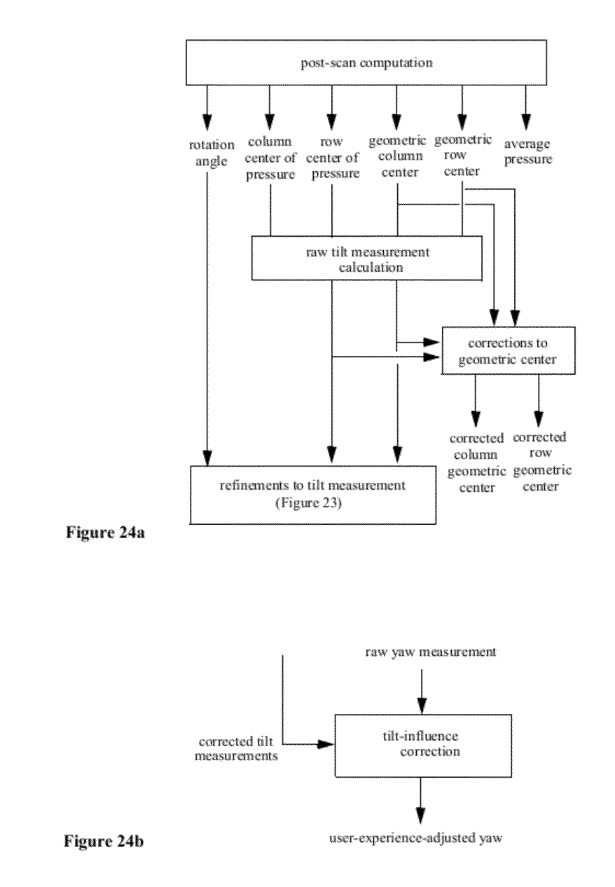

As an example of user-experience correction of calculated parameters, it is noted that placement of hand and wrist at a sufficiently large yaw angle can affect the range of motion of tilting. As the rotation angle increases in magnitude, the range of tilting motion decreases as mobile range of human wrists gets restricted. The invention provides for compensation for the expected tilt range variation as a function of measured yaw rotation angle. An embodiment is depicted in the middle portion of FIG. 23 (adapted from U.S. patent application Ser. No. 12/418,605). As another example of user-experience correction of calculated parameters, the user and application can interpret the tilt measurement in a variety of ways. In one variation for this example, tilting the finger can be interpreted as changing an angle of an object, control dial, etc. in an application. In another variation for this example, tilting the finger can be interpreted by an application as changing the position of an object within a plane, shifting the position of one or more control sliders, etc. Typically each of these interpretations would require the application of at least linear, and typically nonlinear, mathematical transformations so as to obtain a matched user experience for the selected metaphor interpretation of tilt. In one embodiment, these mathematical transformations can be performed as illustrated in the lower portion of FIG. 23. The invention provides for embodiments with no, one, or a plurality of such metaphor interpretation of tilt.

As the finger is tilted to the left or right, the shape of the area of contact becomes narrower and shifts away from the center to the left or right. Similarly as the finger is tilted forward or backward, the shape of the area of contact becomes shorter and shifts away from the center forward or backward. For a better user experience, the invention provides for embodiments to include systems and methods to compensate for these effects (i.e. for shifts in blob size, shape, and center) as part of the tilt measurement portions of the implementation. Additionally, the raw tilt measures can also typically be improved by additional processing. FIG. 24a (adapted from U.S. patent application Ser. No. 12/418,605) depicts an embodiment wherein the raw tilt measurement is used to make corrections to the geometric center measurement under at least conditions of varying the tilt of the finger. Additionally, the invention provides for yaw angle compensation for systems and situations wherein the yaw measurement is sufficiently affected by tilting of the finger. An embodiment of this correction in the data flow is shown in FIG. 24b (adapted from U.S. patent application Ser. No. 12/418,605).

Additional HDTP Processing, Signal Flows, and Operations

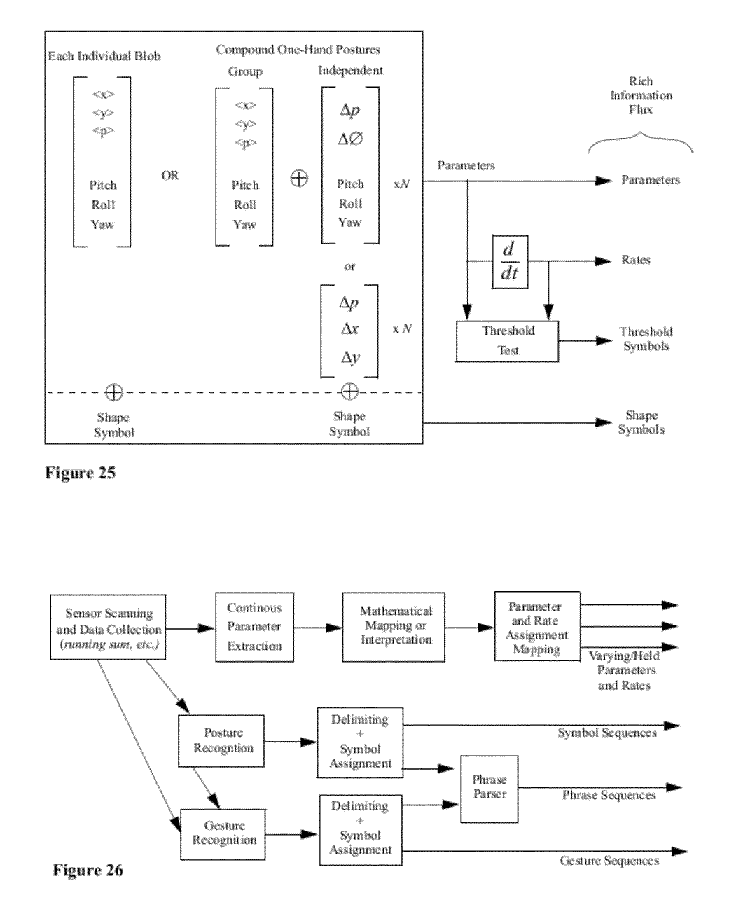

FIG. 25 (adapted from U.S. patent application Ser. No. 12/418,605 and described in U.S. Pat. No. 6,570,078) shows an example of how raw measurements of the six quantities of FIGS. 17a-17f, together with shape recognition for distinguishing contact with various parts of hand and touchpad, can be used to create a rich information flux of parameters, rates, and symbols.

FIG. 26 (adapted from U.S. patent application Ser. No. 12/418,605 and described in U.S. Pat. No. 6,570,078) shows an approach for incorporating posture recognition, gesture recognition, state machines, and parsers to create an even richer human/machine tactile interface system capable of incorporating syntax and grammars.

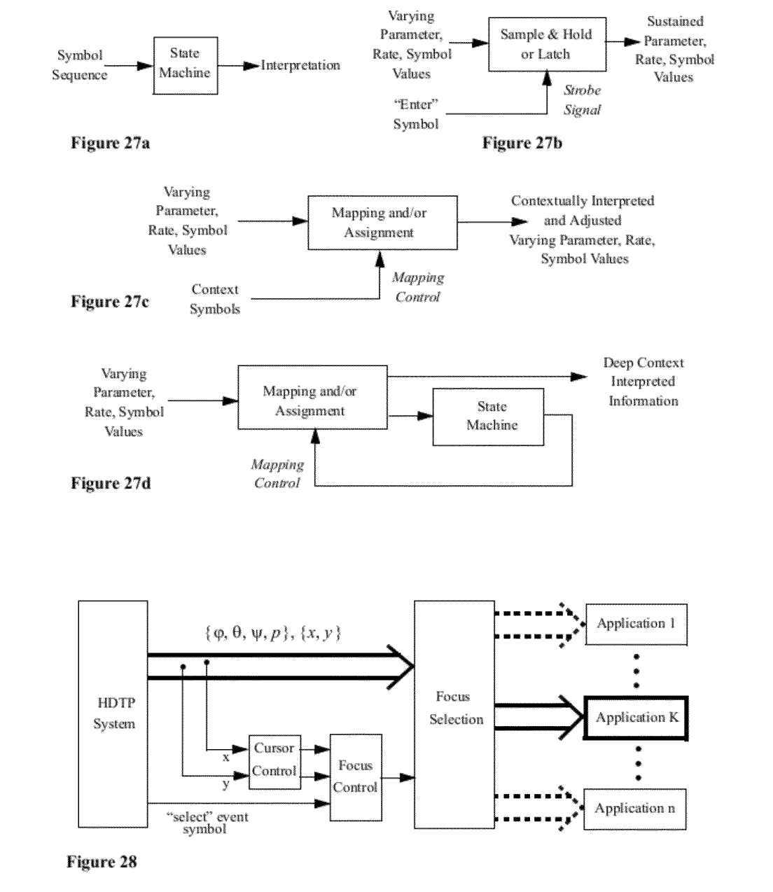

The HDTP affords and provides for yet further capabilities. For example, sequence of symbols can be directed to a state machine, as shown in FIG. 27a (adapted from U.S. patent application Ser. No. 12/418,605 and described in U.S. Pat. No. 6,570,078), to produce other symbols that serve as interpretations of one or more possible symbol sequences. In an embodiment, one or more symbols can be designated the meaning of an “Enter” key, permitting for sampling one or more varying parameter, rate, and symbol values and holding the value(s) until, for example, another “Enter” event, thus producing sustained values as illustrated in FIG. 27b (adapted from U.S. patent application Ser. No. 12/418,605 and described in U.S. Pat. No. 6,570,078). In an embodiment, one or more symbols can be designated as setting a context for interpretation or operation and thus control mapping or assignment operations on parameter, rate, and symbol values as shown in FIG. 27c (adapted from U.S. patent application Ser. No. 12/418,605 and described in U.S. Pat. No. 6,570,078). The operations associated with FIGS. 27a-27c can be combined to provide yet other capabilities. For example, the arrangement of FIG. 26d shows mapping or assignment operations that feed an interpretation state machine which in turn controls mapping or assignment operations. In implementations where context is involved, such as in arrangements such as those depicted in FIGS. 27b-27d, the invention provides for both context-oriented and context-free production of parameter, rate, and symbol values. The parallel production of context-oriented and context-free values can be useful to drive multiple applications simultaneously, for data recording, diagnostics, user feedback, and a wide range of other uses.

FIG. 28 (adapted from U.S. Pat. No. 8,169,414 and U.S. patent application Ser. No. 13/026,097) depicts a user arrangement incorporating one or more HDTP system(s) or subsystem(s) that provide(s) user interface input event and routing of HDTP produced parameter values, rate values, symbols, etc. to a variety of applications. In an embodiment, these parameter values, rate values, symbols, etc. can be produced for example by utilizing one or more of the individual systems, individual methods, and individual signals described above in conjunction with the discussion of FIGS. 25, 26, and 27a-27b. As discussed later, such an approach can be used with other rich multiparameter user interface devices in place of the HDTP. The arrangement of FIG. 27 is taught in U.S. Pat. No. 8,169,414 and FIG. 28 is adapted from FIG. 6e of its pending parent U.S. patent application Ser. No. 12/502,230 for use here. Some aspects of this (in the sense of general workstation control) is anticipated in U.S. Pat. No. 6,570,078 and further aspects of this material are taught in pending U.S. patent application Ser. No. 13/026,097 “Window Manger Input Focus Control for High Dimensional Touchpad (HDTP), Advanced Mice, and Other Multidimensional User Interfaces.”

In an arrangement such as the one of FIG. 28, or in other implementations, at least two parameters are used for navigation of the cursor when the overall interactive user interface system is in a mode recognizing input from cursor control. These can be, for example, the left-right (“x”) parameter and forward/back (“y”) parameter provided by the touchpad. The arrangement of FIG. 28 includes an implementation of this.

Alternatively, these two cursor-control parameters can be provided by another user interface device, for example another touchpad or a separate or attached mouse.

In some situations, control of the cursor location can be implemented by more complex means. One example of this would be the control of location of a 3D cursor wherein a third parameter must be employed to specify the depth coordinate of the cursor location. For these situations, the arrangement of FIG. 28would be modified to include a third parameter (for use in specifying this depth coordinate) in addition to the left-right (“x”) parameter and forward/back (“y”) parameter described earlier.

Focus control is used to interactively routing user interface signals among applications. In most current systems, there is at least some modality wherein the focus is determined by either the current cursor location or a previous cursor location when a selection event was made. In the user experience, this selection event typically involves the user interface providing an event symbol of some type (for example a mouse click, mouse double-click touchpad tap, touchpad double-tap, etc). The arrangement of FIG. 28 includes an implementation wherein a select event generated by the touchpad system is directed to the focus control element. The focus control element in this arrangement in turn controls a focus selection element that directs all or some of the broader information stream from the HDTP system to the currently selected application. (In FIG. 28, “Application K” has been selected as indicated by the thick-lined box and information-flow arrows.)

In some embodiments, each application that is a candidate for focus selection provides a window displayed at least in part on the screen, or provides a window that can be deiconified from an icon tray or retrieved from beneath other windows that can be obfuscating it. In some embodiments, if the background window is selected, focus selection element that directs all or some of the broader information stream from the HDTP system to the operating system, window system, and features of the background window. In some embodiments, the background window can be in fact regarded as merely one of the applications shown in the right portion of the arrangement of FIG. 28. In other embodiments, the background window can be in fact regarded as being separate from the applications shown in the right portion of the arrangement of FIG. 28. In this case the routing of the broader information stream from the HDTP system to the operating system, window system, and features of the background window is not explicitly shown in FIG. 28.

Use of the Additional HDTP Parameters by Applications

The types of human-machine geometric interaction between the hand and the HDTP facilitate many useful applications within a visualization environment. A few of these include control of visualization observation viewpoint location, orientation of the visualization, and controlling fixed or selectable ensembles of one or more of viewing parameters, visualization rendering parameters, pre-visualization operations parameters, data selection parameters, simulation control parameters, etc. As one example, the 6D orientation of a finger can be naturally associated with visualization observation viewpoint location and orientation, location and orientation of the visualization graphics, etc. As another example, the 6D orientation of a finger can be naturally associated with a vector field orientation for introducing synthetic measurements in a numerical simulation.

As another example, at least some aspects of the 6D orientation of a finger can be naturally associated with the orientation of a robotically positioned sensor providing actual measurement data. As another example, the 6D orientation of a finger can be naturally associated with an object location and orientation in a numerical simulation. As another example, the large number of interactive parameters can be abstractly associated with viewing parameters, visualization rendering parameters, pre-visualization operations parameters, data selection parameters, numeric simulation control parameters, etc.

In yet another example, the x and y parameters provided by the HDTP can be used for focus selection and the remaining parameters can be used to control parameters within a selected GUI.

In still another example, x and y parameters provided by the HDTP can be regarded as a specifying a position within an underlying base plane and the roll and pitch angles can be regarded as a specifying a position within a superimposed parallel plane. In a first extension of the previous two-plane example, the yaw angle can be regarded as the rotational angle between the base and superimposed planes. In a second extension of the previous two-plane example, the finger pressure can be employed to determine the distance between the base and superimposed planes. In a variation of the previous two-plane example, the base and superimposed plane are not fixed parallel but rather intersect in an angle responsive to the finger yaw angle. In each example, either or both of the two planes can represent an index or indexed data, a position, a pair of parameters, etc. of a viewing aspect, visualization rendering aspect, pre-visualization operations, data selection, numeric simulation control, etc.

A large number of additional approaches are possible as is appreciated by one skilled in the art. These are provided for by the invention.

Many specific applications and used examples are described in the specifications of U.S. Pat. Nos. 8,169,414 and 6,570,078 and in pending U.S. patent application Ser. Nos. 13/026,248 (extending hypermedia objects and browsers to additional numbers of simultaneously adjustable user interface control dimensions), 13/198,691 (further game applications), 13/464,946 (further Computer Aided Design and drawing applications) 12/875,128 (data visualization), and 12/817,196 (multichannel data sonification). A large number of additional applications are possible as is appreciated by one skilled in the art. These are also provided for by the invention.

Support for Additional Parameters Via Browser Plug-Ins

The additional interactively-controlled parameters provided by the HDTP provide more than the usual number supported by conventional browser systems and browser networking environments. This can be addressed in a number of ways, for example as taught in pending U.S. patent application Ser. Nos. 12/875,119 and 13/026,248. The following examples of HDTP arrangements for use with browsers and servers are taught in pending U.S. patent application Ser. No. 12/875,119 entitled “Data Visualization Environment with Dataflow Processing, Web, Collaboration, High-Dimensional User Interfaces, Spreadsheet Visualization, and Data Sonification Capabilities.”

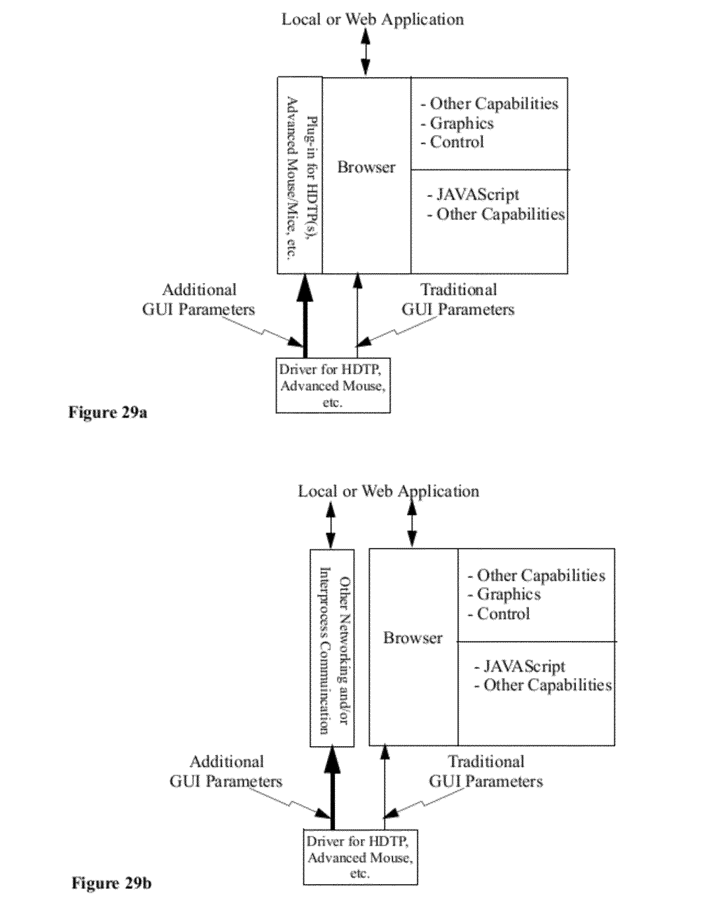

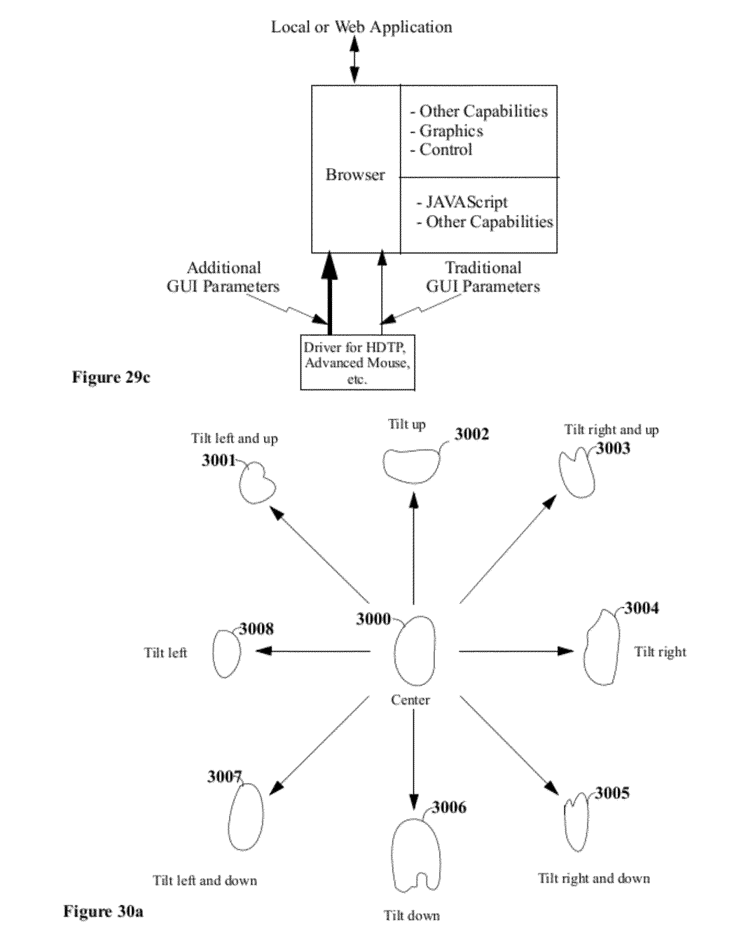

In a first approach, an HDTP interfaces with a browser both in a traditional way and additionally via a browser plug-in. Such an arrangement can be used to capture the additional user interface input parameters and pass these on to an application interfacing to the browser. An example of such an arrangement is depicted in FIG. 29a.

In a second approach, an HDTP interfaces with a browser in a traditional way and directs additional GUI parameters though other network channels. Such an arrangement can be used to capture the additional user interface input parameters and pass these on to an application interfacing to the browser. An example of such an arrangement is depicted in FIG. 29b.

In a third approach, an HDTP interfaces all parameters to the browser directly. Such an arrangement can be used to capture the additional user interface input parameters and pass these on to an application interfacing to the browser. An example of such an arrangement is depicted in FIG. 29c.

The browser can interface with local or web-based applications that drive the visualization and control the data source(s), process the data, etc. The browser can be provided with client-side software such as JAVA Script or other alternatives. The browser can provide also be configured advanced graphics to be rendered within the browser display environment, allowing the browser to be used as a viewer for data visualizations, advanced animations, etc., leveraging the additional multiple parameter capabilities of the HDTP. The browser can interface with local or web-based applications that drive the advanced graphics. In an embodiment, the browser can be provided with Simple Vector Graphics (“SVG”) utilities (natively or via an SVG plug-in) so as to render basic 2D vector and raster graphics. In another embodiment, the browser can be provided with a 3D graphics capability, for example via the Cortona 3D browser plug-in.

Multiple Parameter Extensions to Traditional Hypermedia Objects

As taught in pending U.S. patent application Ser. No. 13/026,248 entitled “Enhanced Roll-Over, Button, Menu, Slider, and Hyperlink Environments for High Dimensional Touchpad (HTPD), other Advanced Touch User Interfaces, and Advanced Mice”, the HDTP can be used to provide extensions to the traditional and contemporary hyperlink, roll-over, button, menu, and slider functions found in web browsers and hypermedia documents leveraging additional user interface parameter signals provided by an HTPD. Such extensions can include, for example:
In the case of a hyperlink, button, slider and some menu features, directing additional user input into a hypermedia “hotspot” by clicking on it;
In the case of a roll-over and other menu features: directing additional user input into a hypermedia “hotspot” simply from cursor overlay or proximity (i.e., without clicking on it);
   The resulting extensions will be called “Multiparameter Hypermedia Objects” (“MHOs”).

Potential uses of the MHOs and more generally extensions provided for by the invention include:
Using the additional user input to facilitate a rapid and more detailed information gathering experience in a low-barrier sub-session;
Potentially capturing notes from the sub-session for future use;
Potentially allowing the sub-session to retain state (such as last image displayed);
Leaving the hypermedia “hotspot” without clicking out of it.

A number of user interface metaphors can be employed in the invention and its use, including one or more of:
Creating a pop-up visual or other visual change responsive to the rollover or hyperlink activation;
Rotating an object using rotation angle metaphors provided by the APD;
Rotating a user-experience observational viewpoint using rotation angle metaphors provided by the APD, for example, as described in U.S. Pat. No. 8,169,414 by Lim;
Navigating at least one (1-dimensional) menu, (2-dimensional) pallet or hierarchical menu, or (3-dimensional) space.

These extensions, features, and other aspects of the present invention permit far faster browsing, shopping, information gleaning through the enhanced features of these extended functionality roll-over and hyperlink objects.

In addition to MHOs that are additional-parameter extensions of traditional hypermedia objects, new types of MHOs unlike traditional or contemporary hypermedia objects can be implemented leveraging the additional user interface parameter signals and user interface metaphors that can be associated with them. Illustrative examples include:
Visual joystick (can keep position after release, or return to central position after release);
Visual rocker-button (can keep position after release, or return to central position after release);
Visual rotating trackball, cube, or other object (can keep position after release, or return to central position after release);
A small miniature touchpad).

Yet other types of MHOs are possible and provided for by the invention. For example:
The background of the body page can be configured as an MHO;
The background of a frame or isolated section within a body page can be configured as an MHO;
An arbitrarily-shaped region, such as the boundary of an entity on a map, within a photograph, or within a graphic can be configured as an MHO.

In any of these, the invention provides for the MHO to be activated or selected by various means, for example by clicking or tapping when the cursor is displayed within the area, simply having the cursor displayed in the area (i.e., without clicking or tapping, as in rollover), etc. Further, it is anticipated that variations on any of these and as well as other new types of MHOs can similarly be crafted by those skilled in the art and these are provided for by the invention.

User Training

Since there is a great deal of variation from person to person, it is useful to include a way to train the invention to the particulars of an individual's hand and hand motions. For example, in a computer-based application, a measurement training procedure will prompt a user to move their finger around within a number of different positions while it records the shapes, patterns, or data derived from it for later use specifically for that user.

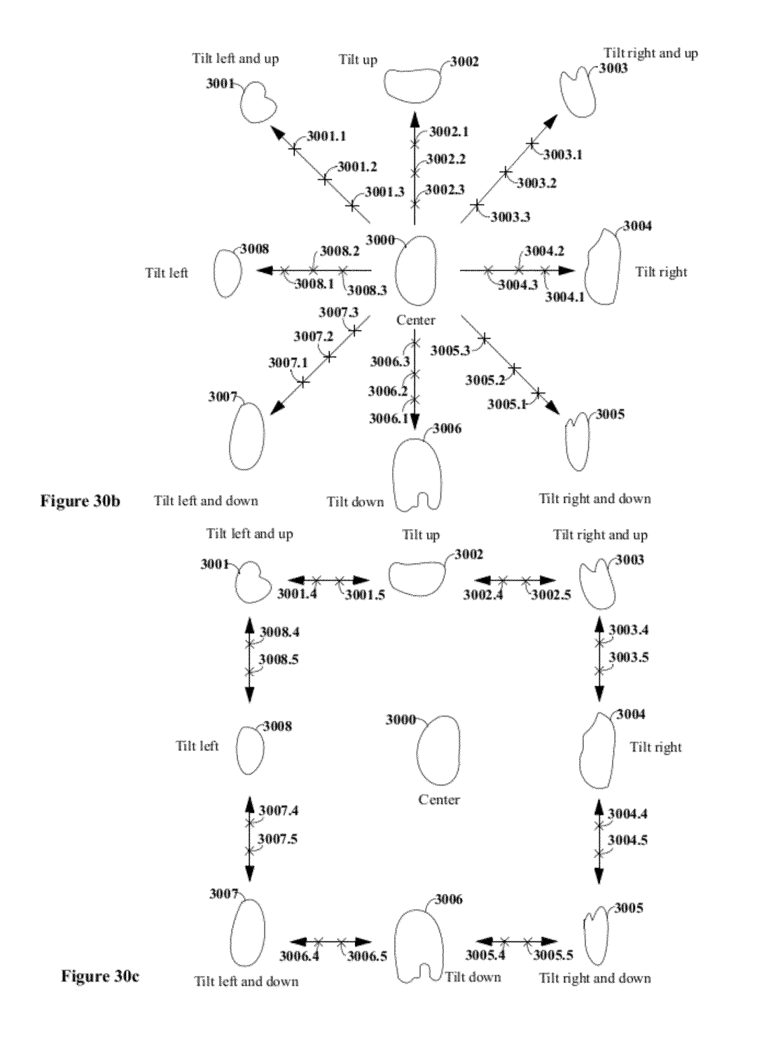

Typically most finger postures make a distinctive pattern. In one embodiment, a user-measurement training procedure could involve having the user prompted to touch the tactile sensor array in a number of different positions, for example as depicted in FIG. 30a (adapted from U.S. patent application Ser. No. 12/418,605). In some embodiments only representative extreme positions are recorded, such as the nine postures 3000-3008. In yet other embodiments, or cases wherein a particular user does not provide sufficient variation in image shape, additional postures can be included in the measurement training procedure, for example as depicted in FIG. 30b (adapted from U.S. patent application Ser. No. 12/418,605). In some embodiments, trajectories of hand motion as hand contact postures are changed can be recorded as part of the measurement training procedure, for example the eight radial trajectories as depicted in FIGS. 30a-30b, the boundary-tracing trajectories of FIG. 30c (adapted from U.S. patent application Ser. No. 12/418,605), as well as others that would be clear to one skilled in the art. All these are provided for by the invention.

The range in motion of the finger that can be measured by the sensor can subsequently be re-corded in at least two ways. It can either be done with a timer, where the computer will prompt user to move his finger from position 3000 to position 3001, and the tactile image imprinted by the finger will be recorded at points 3001.3, 3001.2 and 3001.1. Another way would be for the computer to query user to tilt their finger a portion of the way, for example “Tilt your finger ⅔ of the full range” and record that imprint. Other methods are clear to one skilled in the art and are provided for by the invention.

Additionally, this training procedure allows other types of shapes and hand postures to be trained into the system as well. This capability expands the range of contact possibilities and applications considerably. For example, people with physical handicaps can more readily adapt the system to their particular abilities and needs.

Data Flow and Parameter Refinement

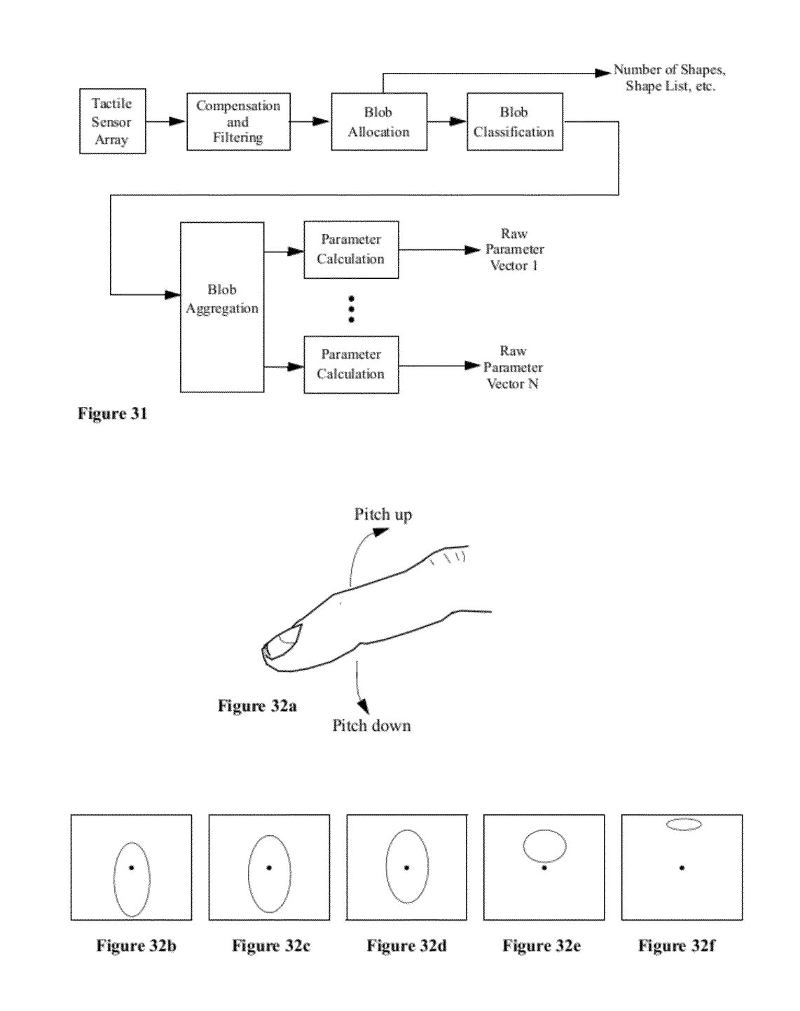

FIG. 31 depicts a HDTP signal flow chain for an HDTP realization that can be used, for example, to implement multi-touch, shape and constellation (compound shape) recognition, and other HDTP features. After processing steps that can for example, comprise one or more of blob allocation, blob classification, and blob aggregation (these not necessarily in the order and arrangement depicted in FIG. 31), the data record for each resulting blob is processed so as to calculate and refine various parameters (these not necessarily in the order and arrangement depicted in FIG. 31).

For example, a blob allocation step can assign a data record for each contiguous blob found in a scan or other processing of the pressure, proximity, or optical image data obtained in a scan, frame, or snapshot of pressure, proximity, or optical data measured by a pressure, proximity, or optical tactile sensor array or other form of sensor. This data can be previously preprocessed (for example, using one or more of compensation, filtering, thresholding, and other operations) as shown in the figure, or can be presented directly from the sensor array or other form of sensor. In some implementations, operations such as compensation, thresholding, and filtering can be implemented as part of such a blob allocation step. In some implementations, the blob allocation step provides one or more of a data record for each blob comprising a plurality of running sum quantities derived from blob measurements, the number of blobs, a list of blob indices, shape information about blobs, the list of sensor element addresses in the blob, actual measurement values for the relevant sensor elements, and other information. A blob classification step can include for example shape information and can also include information regarding individual noncontiguous blobs that can or should be merged (for example, blobs representing separate segments of a finger, blobs representing two or more fingers or parts of the hand that are in at least a particular instance are to be treated as a common blob or otherwise to be associated with one another, blobs representing separate portions of a hand, etc.). A blob aggregation step can include any resultant aggregation operations including, for example, the association or merging of blob records, associated calculations, etc. Ultimately a final collection of blob records are produced and applied to calculation and refinement steps used to produce user interface parameter vectors. The elements of such user interface parameter vectors can comprise values responsive to one or more of forward-back position, left-right position, downward pressure, roll angle, pitch angle, yaw angle, etc from the associated region of hand input and can also comprise other parameters including rates of change of there or other parameters, spread of fingers, pressure differences or proximity differences among fingers, etc. Additionally there can be interactions between refinement stages and calculation stages, reflecting, for example, the kinds of operations described earlier in conjunction with FIGS. 23, 24a, and 24b.

The resulting parameter vectors can be provided to applications, mappings to applications, window systems, operating systems, as well as to further HDTP processing. For example, the resulting parameter vectors can be further processed to obtain symbols, provide additional mappings, etc. In this arrangement, depending on the number of points of contact and how they are interpreted and grouped, one or more shapes and constellations can be identified, counted, and listed, and one or more associated parameter vectors can be produced. The parameter vectors can comprise, for example, one or more of forward-back, left-right, downward pressure, roll, pitch, and yaw associated with a point of contact. In the case of a constellation, for example, other types of data can be in the parameter vector, for example inter-fingertip separation differences, differential pressures, etc.

Example First-Level Measurement Calculation Chain

Attention is now directed to particulars of roll and pitch measurements of postures and gestures. FIG. 32a depicts a side view of an exemplary finger and illustrating the variations in the pitch angle. FIGS. 32b-32f depict exemplary tactile image measurements (proximity sensing, pressure sensing, contact sensing, etc.) as a finger in contact with the touch sensor array is positioned at various pitch angles with respect to the surface of the sensor. In these, the small black dot denotes the geometric center corresponding to the finger pitch angle associated with FIG. 32d. As the finger pitch angle is varied, it can be seen that:
the eccentricity of the oval shape changes and in the cases associated with FIGS. 32e-32f the eccentricity change is such that the orientation of major and minor axes of the oval exchange roles;
The position of the oval shape migrates and in the cases of FIGS. 32b-32c and FIGS. 32e-32f have a geometric center shifted from that of FIG. 32d, and in the cases of FIGS. 32e-32f the oval shape migrates enough to no longer even overlap the geometric center of FIG. 32d.

From the user experience viewpoint, however, the user would not feel that a change in the front-back component of the finger's contact with the touch sensor array has changed. This implies the front-back component (“y”) of the geometric center of contact shape as measured by the touch sensor array should be corrected responsive to the measured pitch angle. This suggests a final or near-final measured pitch angle value should be calculated first and used to correct the final value of the measured front-back component (“y”) of the geometric center of contact shape.

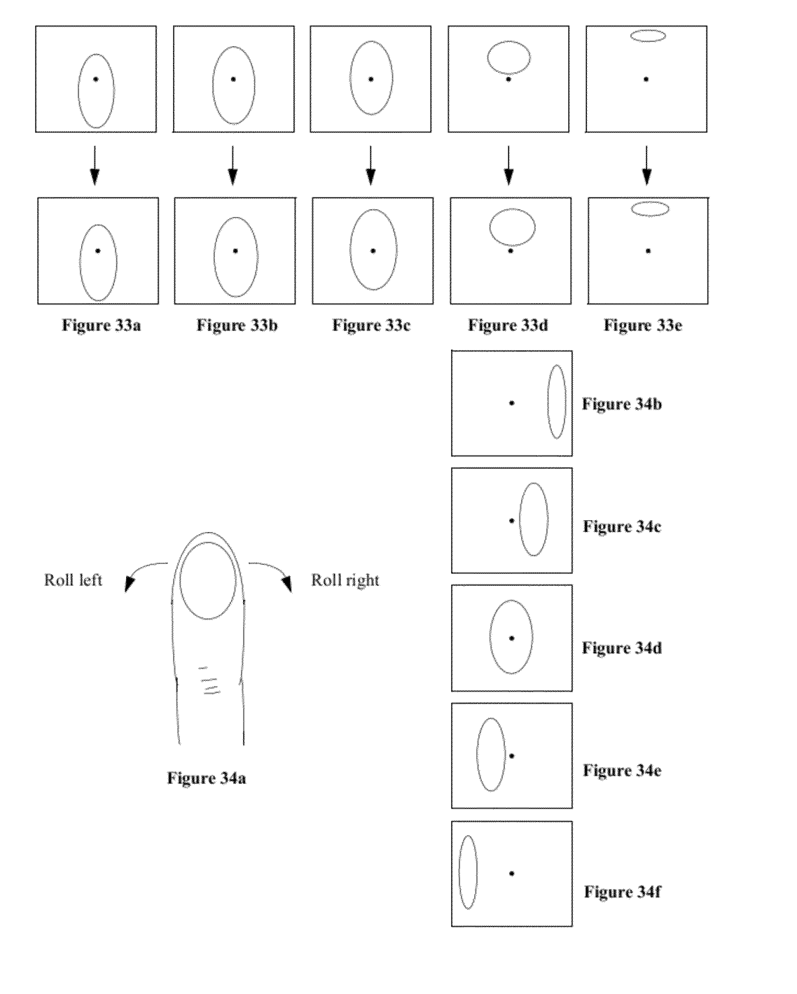

Additionally, FIGS. 33a-33e depict the effect of increased downward pressure on the respective contact shapes of FIGS. 32b-32f. More specifically, the top row of FIGS. 33a-33e are the respective contact shapes of FIGS. 32b-32f, and the bottom row show the effect of increased downward pressure. In each case the oval shape expands in area (via an observable expansion in at least one dimension of the oval) which could thus shift the final value of the measured front-back component (“y”). (It is noted that for the case of a pressure sensor array, the measured pressure values measured by most or all of the sensors in the contact area would also increase accordingly.)

These and previous considerations imply:
the pitch angle as measured by the touch sensor array could be corrected responsive to the measured downward pressure. This suggests a final or near-final measured downward pressure value should be calculated first and used to correct the final value of measured downward pressure (“p”);
the front-back component (“y”) of the geometric center of contact shape as measured by the touch sensor array could be corrected responsive to the measured downward pressure. This suggests a final or near-final measured pitch angle value could be calculated first and used to correct the final value of measured downward pressure (“p”).
   In one approach, correction to the pitch angle responsive to measured downward pressure value can be used to correct for the effect of downward pressure on the front-back component (“y”) of the geometric center of the contact shape.

FIG. 34a depicts a top view of an exemplary finger and illustrating the variations in the roll angle. FIGS. 34b-34f depict exemplary tactile image measurements (proximity sensing, pressure sensing, contact sensing, etc.) as a finger in contact with the touch sensor array is positioned at various roll angles with respect to the surface of the sensor. In these, the small black dot denotes the geometric center corresponding to the finger roll angle associated with FIG. 34d. As the finger roll angle is varied, it can be seen that:
The eccentricity of the oval shape changes;
The position of the oval shape migrates and in the cases of FIGS. 34b-34c and FIGS. 34e-34f have a geometric center shifted from that of FIG. 34d, and in the cases of FIGS. 34e-34f the oval shape migrates enough to no longer even overlap the geometric center of FIG. 34d.
   From the user experience, however, the user would not feel that the left-right component of the finger's contact with the touch sensor array has changed. This implies the left-right component (“x”) of the geometric center of contact shape as measured by the touch sensor array should be corrected responsive to the measured roll angle. This suggests a final or near-final measured roll angle value should be calculated first and used to correct the final value of the measured left-right component (“x”) of the geometric center of contact shape.

As with measurement of the finger pitch angle, increasing downward pressure applied by the finger can also invoke variations in contact shape involved in roll angle measurement, but typically these variations are minor and less significant for roll measurements than they are for pitch measurements. Accordingly, at least to a first level of approximation, effects of increasing the downward pressure can be neglected in calculation of roll angle.

Depending on the method used in calculating the pitch and roll angles, it is typically advantageous to first correct for yaw angle before calculating the pitch and roll angles. One source reason for this is that (dictated by hand and wrist physiology) from the user experience a finger at some non-zero yaw angle with respect to the natural rest-alignment of the finger would impart intended roll and pitch postures or gestures from the vantage point of the yawed finger position. Without a yaw-angle correction somewhere, the roll and pitch postures and movements of the finger would resolve into rotated components. As an extreme example of this, if the finger were yawed at a 90-degree angle with respect to a natural rest-alignment, roll postures and movements would measure as pitch postures and movements while pitch postures and movements would measure as roll postures and movements. As a second example of this, if the finger were yawed at a 45-degree angle, each roll and pitch posture and movement would case both roll and pitch measurement components. Additionally, some methods for calculating the pitch and roll angles (such as curve fitting and polynomial regression methods as taught in pending U.S. patent application Ser. No. 13/038,372) work better if the blob data on which they operate is not rotated by a yaw angle. This suggests that a final or near-final measured yaw angle value should be calculated first and used in a yaw-angle rotation correction to the blob data applied to calculation of roll and pitch angles.

Regarding other calculations, at least to a first level of approximation downward pressure measurement in principle should not be affected by yaw angle. Also at least to a first level of approximation, for geometric center calculations sufficiently corrected for roll and pitch effects in principle should not be affected by yaw angle. (In practice there can be at least minor effects, to be considered and addressed later).

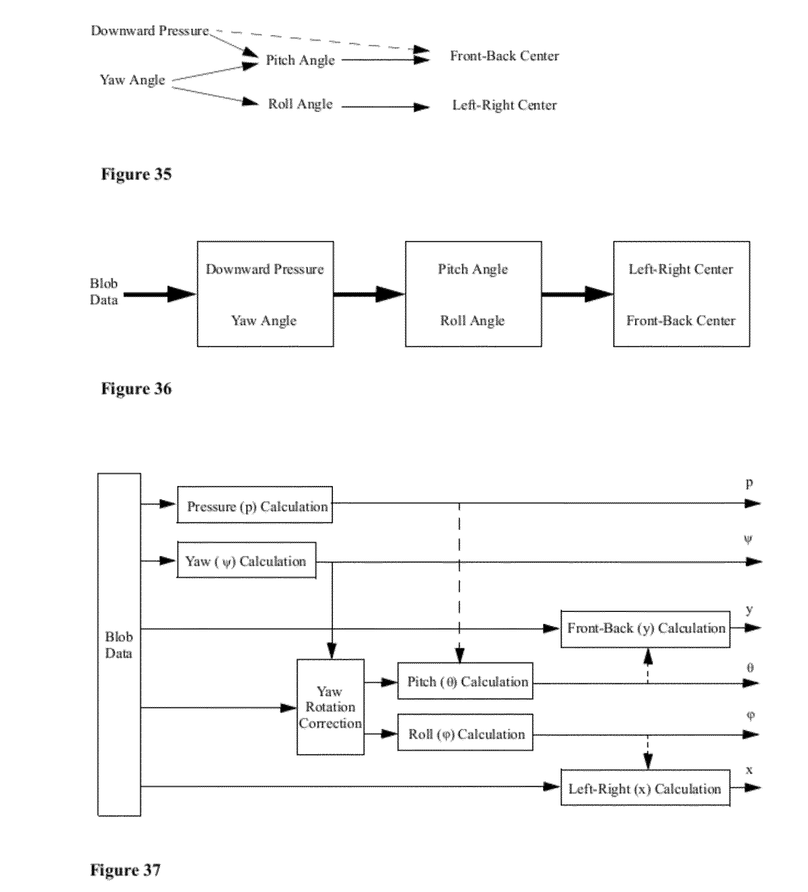

The example working first level of approximation conclusions together suggest a causal chain of calculation such as that depicted in FIG. 35. FIG. 36 depicts a utilization of this causal chain as a sequence flow of calculation blocks. FIG. 36 does not, however, represent a data flow since calculations in subsequent blocks depend on blob data in ways other than as calculated in preceding blocks. More specifically as to this, FIG. 37 depicts an example implementation of a real-time calculation chain for the left-right (“x”), front-back (“y”), downward pressure (“p”), roll (“φ”), pitch (“θ”), and yaw (“ψ”) measurements that can be calculated from blob data such as that produced in the exemplary arrangement of FIG. 31. Examples of methods, systems, and approaches to downward pressure calculations from tactile image data in a multi-touch context are provided in pending U.S. patent application Ser. No. 12/418,605 and U.S. Pat. No. 6,570,078. Examples methods, systems, and approaches to yaw angle calculations from tactile image data are provided in pending U.S. Pat. No. 8,170,346; these can be applied to a multi-touch context via arrangements such as the depicted in FIG. 31. Examples methods, systems, and approaches to roll angle and pitch angle calculations from tactile image data in a multi-touch context are provided in pending U.S. patent application Ser. No. 12/418,605 and 13/038,372 as well as in U.S. Pat. No. 6,570,078 and include yaw correction considerations. Examples methods, systems, and approaches to front-back geometric center and left-right geometric center calculations from tactile image data in a multi-touch context are provided in pending U.S. patent application Ser. No. 12/418,605 and U.S. Pat. No. 6,570,078.

The yaw rotation correction operation depicted in FIG. 37 operates on blob data as a preprocessing step prior to calculations of roll angle and pitch angle calculations from blob data (and more generally from tactile image data). The yaw rotation correction operation can, for example, comprise a rotation matrix or related operation which internally comprises sine and cosine functions as is appreciated by one skilled in the art. Approximations of the full needed range of yaw angle values (for example from nearly −90 degrees through zero to nearly +90 degrees, or in a more restricted system from nearly −45 degrees through zero to nearly +45 degrees) can therefore not be realistically approximated by a linear function. The need range of yaw angles can be adequately approximated by piecewise-affine functions such as those to be described in the next section. In some implementations it will be advantageous to implement the rotation operation with sine and cosine functions in the instruction set or library of a computational processor. In other implementations it will be advantageous to implement the rotation operation with piecewise-affine functions (such as those to be described in the next section) on a computational processor.

FIG. 37 further depicts optional data flow support for correction of pitch angle measurement using downward pressure measurement (as discussed earlier). In one embodiment this correction is not done in the context of FIG. 37 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these. Linear, piecewise-linear, affine, and piecewise-affine functions will be considered in the next section.

FIG. 37 further depicts optional data flow support for correction of front-back geometric center measurement using pitch angle measurement (as discussed earlier). In one embodiment this correction is not done in the context of FIG. 37 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these.

FIG. 37 further depicts optional data flow support for correction of left-right geometric center measurement using roll angle measurement (as discussed earlier). In one embodiment this correction is not done in the context of FIG. 37 and the dashed signal path is not implemented. In such circumstances either no such correction is provided, or the correction is provided in a later stage. If the correction is implemented, it can be implemented in various ways depending on approximations chosen and other considerations. The various ways include a linear function, a piecewise-linear function, an affine function, a piecewise-affine function, a nonlinear function, or combinations of two or more of these.

FIG. 37 does not depict optional data flow support for correction of front-back geometric center measurement using downward pressure measurement (as discussed earlier). In one embodiment this correction is not done in the context of FIG. 37 and either no such correction is provided, or the correction is provided in a later stage. In another embodiment this correction is implemented in the example arrangement of FIG. 37, for example through the addition of downward pressure measurement data flow support to the front-back geometric center calculation and additional calculations performed therein. In either case, if the correction is implemented, it can be implemented in various ways depending on approximations chosen and other considerations. The various ways include a linear function, a piecewise-linear function, an affine function, a piecewise-affine function, a nonlinear function, or combinations of two or more of these.

Additionally, FIG. 37 does not depict optional data flow support for the tilt refinements described in conjunction with FIG. 24a, the tilt-influent correction to measured yaw angle described in conjunction with FIG. 24b, the range-of-rotation correction described in conjunction with FIG. 23, the correction of left-right geometric center measurement using downward pressure measurement (as discussed just a bit earlier), the correction of roll angle using downward pressure measurement (as discussed just a bit earlier), or the direct correction of front-back geometric center measurement using downward pressure measurement. There are many further possible corrections and user experience improvements that can be added in similar fashion. In one embodiment any one or more such additional corrections are not performed in the context of FIG. 37 and either no such correction is provided, or such corrections are provided in a later stage after an arrangement such as that depicted in FIG. 37. In another embodiment one or more such corrections are implemented in the example arrangement of FIG. 37, for example through the addition of relevant data flow support to the relevant calculation step and additional calculations performed therein. In either case, any one or more such corrections can be implemented in various ways depending on approximations chosen and other considerations. The various ways include use of a linear function, a piecewise-linear function, an affine function, a piecewise-affine function, a nonlinear function, or combinations of two or more of these.

In one approach, one or more shared environments for linear function, a piecewise-linear function, an affine function, a piecewise-affine function, or combinations of two or more of these can be provided. In an embodiment of such an approach, one or more of these one or more shared environments can be incorporated into the calculation chain depicted in FIG. 37.

In another or related embodiment of such an approach, one or more of these one or more shared environments can be implemented in a processing stage subsequent to the calculation chain depicted in FIG. 37. In these circumstances, the output values from the calculation chain depicted in FIG. 37 can be regarded as “first-order” or “unrefined” output values which, upon further processing by these one or more shared environments produce “second-order” or refined” output values.

Additional Parameter Refinement

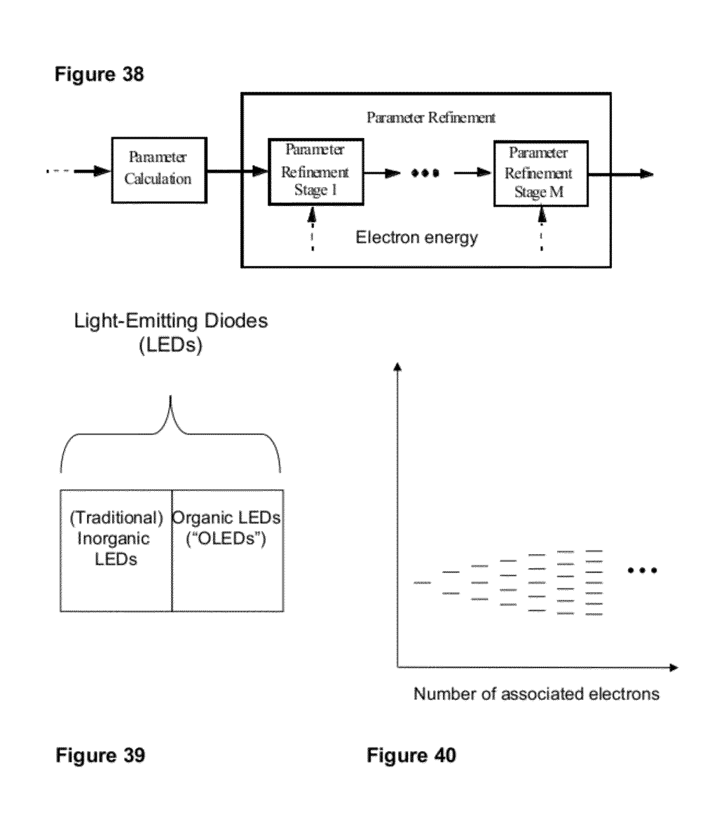

Additional refinement of the parameters can be obtained by additional processing. As an example, FIG. 38 shows an arrangement of FIG. 31 wherein each raw parameter vector is provided to additional parameter refinement processing to produce a corresponding refined parameter vector. The additional parameter refinement can comprise a single stage, or can internally comprise two or more internal parameter refinement stages as suggested in FIG. 38. The internal parameter refinement stages can be interconnected in various ways, including a simple chain, feedback and/or control paths (as suggested by the dash-line arrows within the Parameter Refinement box), as well as parallel paths (not explicitly suggested in FIG. 38), combinations, or other topologies as can be advantageous. The individual parameter refinement stages can comprise various approaches systems and methods, for example Kalman and/or other types of statistical filters, matched filters, artificial neural networks (such as but not limited to those taught in pending U.S. provisional patent application 61/309,421), linear or piecewise-linear transformations (such as but not limited to those taught in pending U.S. Provisional Patent Application 61/327,458), nonlinear transformations, pattern recognition operations, dynamical systems, etc. In an embodiment, the parameter refinement can be provided with other information, such as the measured area of the associated blob, external shape classification of the associated blob, etc.

Use of OLED Displays as a High-Resolution Optical Tactile Sensor HDTP User Interfaces

Throughout the discussion, although “OLED” is in places called out specifically, an “Organic Light Emitting Diode” (OLED) is a type of “Light Emitting Diode” (LED). The term “inorganic-LED” is used to specifically signify traditional LEDs made of non-organic materials such as silicon, indium-phosphide, etc. FIG. 39 depicts a visual classification representation showing inorganic-LEDs and Organic Light Emitting Diodes (OLEDs) as mutually-exclusive types of Light Emitting Diodes (LEDs).

Color OLED array displays are of particular interest, in general and as pertaining to the present invention, because:
They can be fabricated (along with associated electrical wiring conductors) via printed electronics on a wide variety of surfaces such as glass, Mylar, plastics, paper, etc.;
Leveraging some such surface materials, they can be readily bent, printed on curved surfaces, etc.;
They can be transparent (and be interconnected with transparent conductors);
Leveraging such transparency, they can be:
   Stacked vertically,
   Used as an overlay element atop an LCD or other display,
   Used as an underlay element between an LCD and its associated backlight.

LEDs as Light Sensors

Light detection is typically performed by photosite CCD (charge-coupled device) elements, phototransistors, CMOS photodetectors, and photodiodes. Photodiodes are often viewed as the simplest and most primitive of these, and typically comprise a PIN (P-type/Intrinstic/N-type) junction rather than the more abrupt PIN (P-type/N-type) junction of conventional signal and rectifying diodes.

However, virtually all diodes are capable of various photoelectric properties to some extent. In particular, LEDs, which are diodes that have been structured and doped specific types of optimized light emission, can also behave as (at least low-to moderate performance) photodiodes. In popular circles Forrest M. Mims has often been credited as calling attention to the fact that that a conventional LED can be used as a photovoltaic light detector as well as a light emitter (Mims III, Forrest M. “Sun Photometer with Light-emitting diodes as spectrally selective detectors” Applied Optics, Vol. 31, No. 33, Nov. 20, 1992), and as a photodetector LEDs exhibit spectral selectivity associated with the LED's emission wavelength. More generally, inorganic-LEDs, organic LEDs (“OLEDs”), organic field effect transistors, and other related devices exhibit a range of readily measurable photo-responsive electrical properties, such as photocurrents and related photovoltages and accumulations of charge in the junction capacitance of the LED.

Further, the relation between the spectral detection band and the spectral emission bands of each of a plurality of colors and types of color inorganic-LEDs, OLEDs, and related devices can be used to create a color light-field sensor from, for example, a color inorganic-LED, OLED, and related device array display. Such arrangements have been described in U.S. Pat. No. 8,125,559, pending U.S. patent application Ser. Nos. 12/419,229 (priority date Jan. 27, 1999), 13/072,588, and 13/452,461. The present invention expands further upon this.

U.S. Pat. No. 8,125,559, pending U.S. patent application Ser. Nos. 12/419,229 (priority date Jan. 27, 1999), 13/072,588, and 13/452,461 additionally teach how such a light-field sensor can be used together with signal processing software to create lensless-imaging camera technology, and how such technology can be used to create an integrated camera/display device which can be used, for example, to deliver precise eye-contact in video conferencing applications.

In an embodiment provided for by the invention, each LED in an array of LEDs can be alternately used as a photodetector or as a light emitter. At any one time, each individual LED would be in one of three states:
A light emission state,
A light detection state,
An idle state.
   as can be advantageous for various operating strategies. The state transitions of each LED can be coordinated in a wide variety of ways to afford various multiplexing, signal distribution, and signal gathering schemes as can be advantageous.

Leveraging this in various ways, in accordance with embodiments of the invention and as taught in pending U.S. patent application Ser. No. 13/180,345, an array of inorganic-LEDs, OLEDs, or related optoelectronic devices is configured to perform at least some functions of two or more of:
a visual (graphics, image, video, GUI, etc.) image display (established industry practice),
a lensless imaging camera (for example, as taught in pending U.S. patent application Ser. Nos. 12/828,280, 12/828,207, 13/072,588, and 13/452,461),
a tactile (touchscreen) user interface (for example, as taught in pending U.S. patent application Ser. No. 12/418,605),
a proximate (non-touch) gesture user interface (for example as taught in U.S. Pat. No. 6,570,078 Section 2.1.7.2 as well as claims 4 and 10, and more recently as taught in an LCD technology context in M. Hirsch, et. al., “BiDi Screen: A Thin, Depth-Sensing LCD for 3D Interaction using Light Fields”, available at http://web.media.mit.edu/˜mhirsch/bidi/bidiscreen.pdf, visited Jul. 9, 2012).

These arrangements, as discussed in pending U.S. patent application Ser. No. 13/180,345 and further developed in the present invention, advantageously allow for a common processor to be used for two or more display, user interface, and camera functionalities.

The result dramatically decreases the component count, system hardware complexity, and inter-chip communications complexity for contemporary and future mobile devices such as cellphones, smartphones, PDAs, tablet computers, and other such devices.

In systems that do not implement the HDTP functionality, the invention still offers considerable utility. Note only are the above complexity and component savings possible, but additionally the now widely manufactured RF capacitive matrix arrangements used in contemporary multi-touch touchscreen can be replaced with an entirely optical user interface employ an OLED display such as that increasingly deployed in cellphones, smartphones, and Personal Digital Assistants (“PDAs”) manufactured by Samsung, Nokia, LG, HTC, Phillips, Sony and others.

Inorganic and Organic Semiconductors

FIG. 40 depicts a representation of the spread of electron energy levels as a function of the number of associated electrons in a system such as a lattice of semiconducting material resultant from quantum state exclusion processes. As the number of associated electrons in a system increases, the separation between consecutive energy levels decreases, in the limit becoming an effective continuum of energy levels. Higher energy level electrons form a conduction band while lower energy electrons lie in a valence band. The relative positions vertically and from column-to-column are schematic and not to scale, and electron pairing effects are not accurately represented.

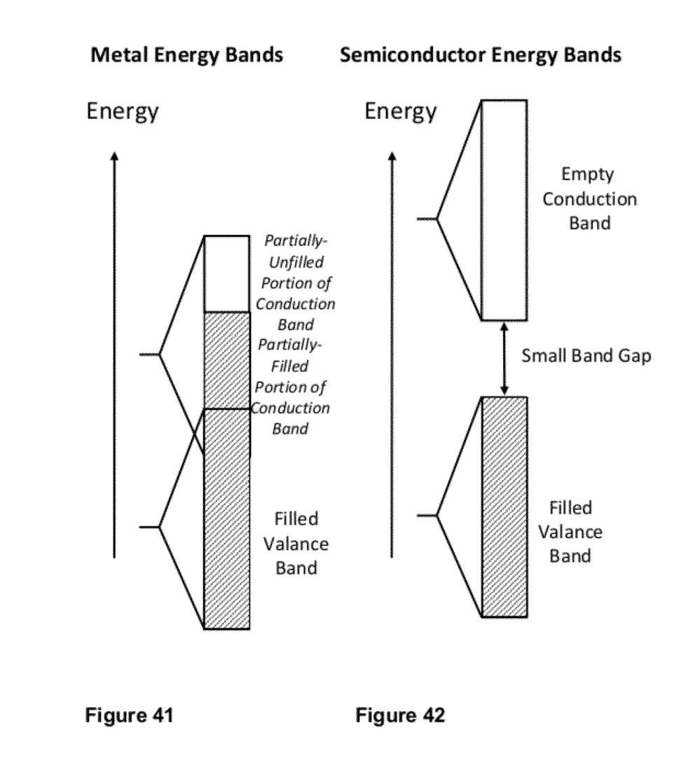

FIG. 41 depicts an example electron energy distribution for metals, (wherein the filled valance band overlaps with the conduction band).

FIG. 42 depicts an example electron energy distribution for semiconductors; here the filled valance band is separated from the conduction band by a gap in energy values. The “band gap” is the difference in energy between electrons at the top of the valence band and electrons at the bottom of the conduction band. For a semiconductor the band gap is small, and manipulations of materials, physical configurations, charge and potential differences, photon absorption, etc. can be used to move electrons through the band gap or along the conduction band.

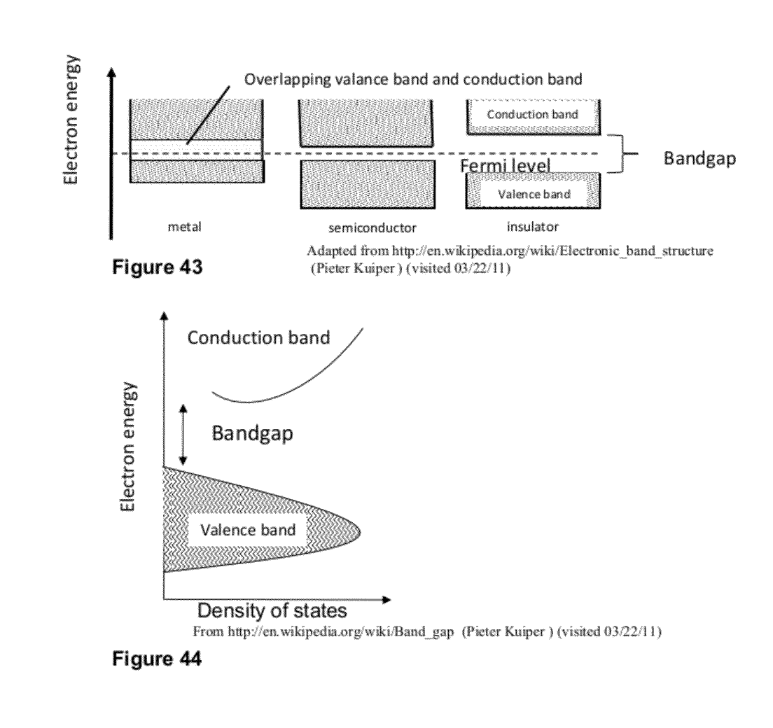

Elaborating further, FIG. 43 (adapted from Pieter Kuiper, http://en.wikipedia.org/wiki/Electronic_band_structure, visited Mar. 22, 2011) depicts an exemplary (albeit not comprehensive) schematic representation of the relationships between valance bands and conduction bands in materials distinctly classified as metals, semiconductors, and insulators. The band gap is a major factor determining the electrical conductivity of a material. Although metal conductor materials are shown having overlapping valance and conduction bands, there are some conductors that instead have very small band gaps. Materials with somewhat larger band gaps are electrical semiconductors, while materials with very large band gaps are electrical insulators.

The affairs shown in FIG. 39 and FIG. 42 are related. FIG. 44 (adapted from Pieter Kuiper, http://en.wikipedia.org/wiki/Band_gap, visited Mar. 22, 2011) depicts how the energy distribution of electrons in the valance band and conduction band vary as a function of the density of assumed electron states per unit of energy, illustrating growth of the size of the band gap as the density of states (horizontal axis) increases. The energy distribution of electrons in the valance band and conduction band are important to light emission and light sensing processes as photons are (respectively) emitted or absorbed via electron energy transitions, wherein the wavelength of the photon is related to the associated change in electron energy.

Light Sensing by Photodiodes and LEDs

Electrons can move between the valence band and the conduction band by means of various processes that give rise to hole-electron generation and hole-electron recombination. Several such processes are accordingly related to the absorption and emission of photons which make up light.

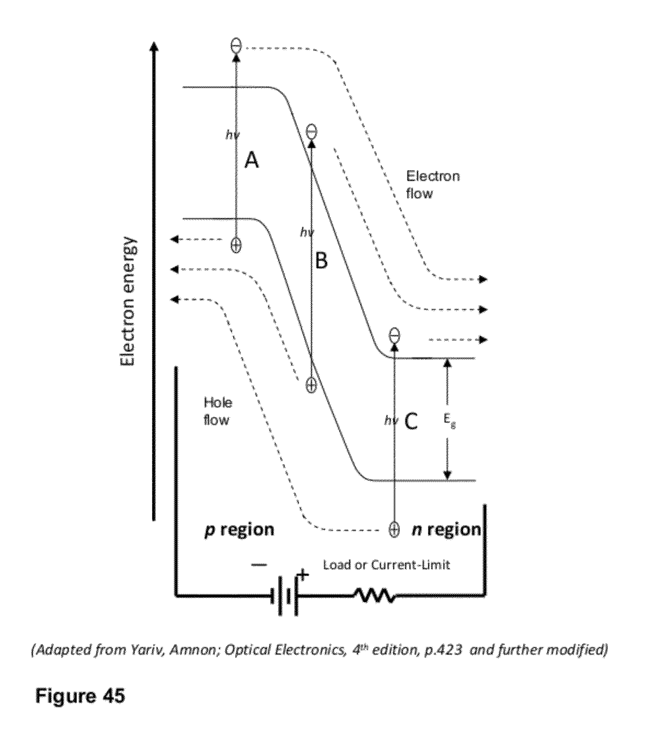

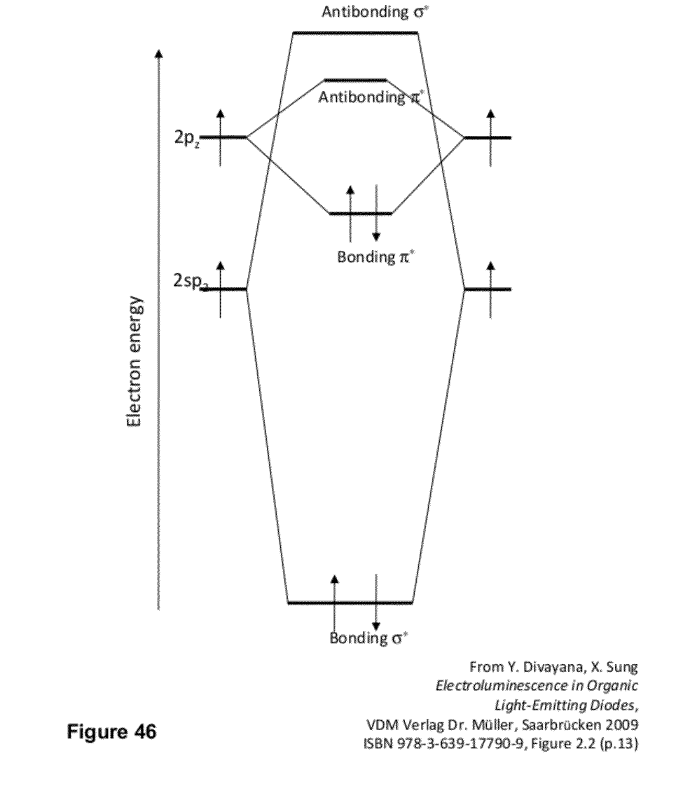

Light detection in information systems (for example, as in image sensors, light detectors, etc.) is typically performed by photosite CCD (charge-coupled device) elements, phototransistors, CMOS photodetectors, and photodiodes. By way of example, FIG. 45 (adapted from A. Yariv, Optical Electronics, 4th edition, Saunders College Press, 1991, p. 423) depicts three exemplary types of electron-hole creation processes resulting from absorbed photons that contribute to current flow in a PN diode. Emitted photons cause electrons to drop through the band gap while absorbed photons of sufficient energy can excite electrons from the valance band though the band gap to the conduction band.

Photodiodes are often viewed as the simplest and most primitive form of semiconductor light detector. A photodiode typically comprises a PIN (P-type/Intrinsic/N-type) junction rather than the more abrupt PIN (P-type/N-type) junction of conventional signal and rectifying diodes. However, photoelectric effects and capabilities are hardly restricted to PIN diode structures. In varying degrees, virtually all diodes are capable of photovoltaic properties to some extent.

In particular, LEDs, which are diodes that have been structured and doped for specific types of optimized light emission, can also behave as (at least low-to-medium performance) photodiodes. Additionally, LEDs also exhibit other readily measurable photo-responsive electrical properties, such as photodiode-type photocurrents and related accumulations of charge in the junction capacitance of the LED. In popular circles Forrest M. Mims has often been credited as calling attention to the fact that that a conventional LED can be used as a photovoltaic light detector as well as a light emitter (Mims III, Forrest M. “Sun Photometer with Light-emitting diodes as spectrally selective detectors” Applied Optics, Vol. 31, No. 33, Nov. 20, 1992). More generally LEDs, organic LEDs (“OLEDs”), organic field effect transistors, and other related devices exhibit a range of readily measurable photo-responsive electrical properties, such as photocurrents and related photovoltages and accumulations of charge in the junction capacitance of the LED.

In an LED, light is emitted when holes and carriers recombine and the photons emitted have an energy lying in a small range either side of the energy span of the band gap. Through engineering of the band gap, the wavelength of light emitted by an LED can be controlled. In the aforementioned article, Mims additionally pointed out that, as a photodetector, LEDs exhibit spectral selectivity with at a light absorption wavelength related to that of the LED's emission wavelength. More details as to the spectral selectivity of the photoelectric response of an LED will be provided later.

Attention is now directed to organic semiconductors and their electrical and optoelectrical behavior. Conjugated organic compounds comprise alternating single and double bonds in the local molecular topology comprising at least some individual atoms (usually carbon, but can be other types of atoms) in the molecule. The resulting electric fields organize the orbitals of those atoms into a hybrid formation comprising a a-bond (which engage electrons in forming the molecular structure among joined molecules) and a π-cloud of loosely associated electrons that are in fact delocalized and can move more freely within the molecule. These delocalized π-electrons provide a means for charge transport within the molecule and electric current within larger-structures of organic materials (for example, polymers).

Combinations of atomic orbital modalities for the individual atoms in a molecule, together with the molecular topology (defined by the network of σ-bonds) and molecular geometry, create molecule-scale orbitals for the delocalized π-cloud of electrons and in a sense for the electrons comprising σ-bonds. Interactions among the electrons, in particular quantum exclusion processes, create an energy gap between the Highest Occupied Molecular Orbital (“HOMO”) and Lowest-Unoccupied Molecular Orbital (“LUMO”) for the delocalized π electrons (and similarly does so for the more highly localized σ-bond electrons). FIG. 46 (adapted from Y. Divayana, X. Sung, Electroluminescence in Organic Light-Emitting Diodes, VDM Verlag Dr. Müller, Saarbrücken, 2009, ISBN 978-3-639-17790-9, FIG. 2.2, p. 13) depicts the electron energy distribution among bonding (π and σ) and antibonding (π* and σ*) molecular orbitals in for two electrons in an exemplary conjugated or aromatic organic compound. In such materials, typically the energy gap between the π and π* molecular orbitals correspond to the gap between the HOMO and LUMO. The HOMO effectively acts as a valence band in a traditional (inorganic) crystal lattice semiconductor and the LUMO acts as effective equivalent to a conduction band. Accordingly, energy gap between the HOMO and LUMO (usually corresponding to the gap between the π and π* molecular orbitals) behaves in a manner similar to the band gap in a crystal lattice semiconductor and thus permits many aromatic organic compounds to serve as electrical semiconductors.

Emitted photons cause electrons to drop through the HOMO/LUMO gap while absorbed photons of sufficient energy can excite electrons from the HOMO to the LUMO. These processes are similar to photon emission and photo absorption processes in a crystal lattice semiconductor and can be used to implement organic LED (“OLED”) and organic photodiode effects with aromatic organic compounds. Functional groups and other factors can vary the width of the band gap so that it matches energy transitions associated with selected colors of visual light. Additional details on organic LED (“OLED”) processes, materials, operation, fabrication, performance, and applications can be found in, for example:
Z. Li, H. Ming (eds.), Organic Light-Emitting Materials and Devices, CRC Taylor & Francis, Boca Raton, 2007, ISBN 1-57444-574-X;
Z. Kafafi (ed.), Organic Electroluminescence, CRC Taylor & Francis, Boca Raton, 2005, ISBN 0-8247-5906-0;
Y. Divayana, X. Sung, Electroluminescence in Organic Light-Emitting Diodes, VDM Verlag Dr. Müller, Saarbrücken, 2009, ISBN 978-3-639-17790-9.

It is noted that an emerging alternative to OLEDs are Organic Light Emitting Transistors (OLETS). The present invention allows for arrangements employing OLETS to be employed in place of OLEDs and inorganic LEDs as appropriate and advantageous wherever mentioned throughout the specification.

Potential Co-Optimization of Light Sensing and Light Emitting Capabilities of an Optical Diode Element

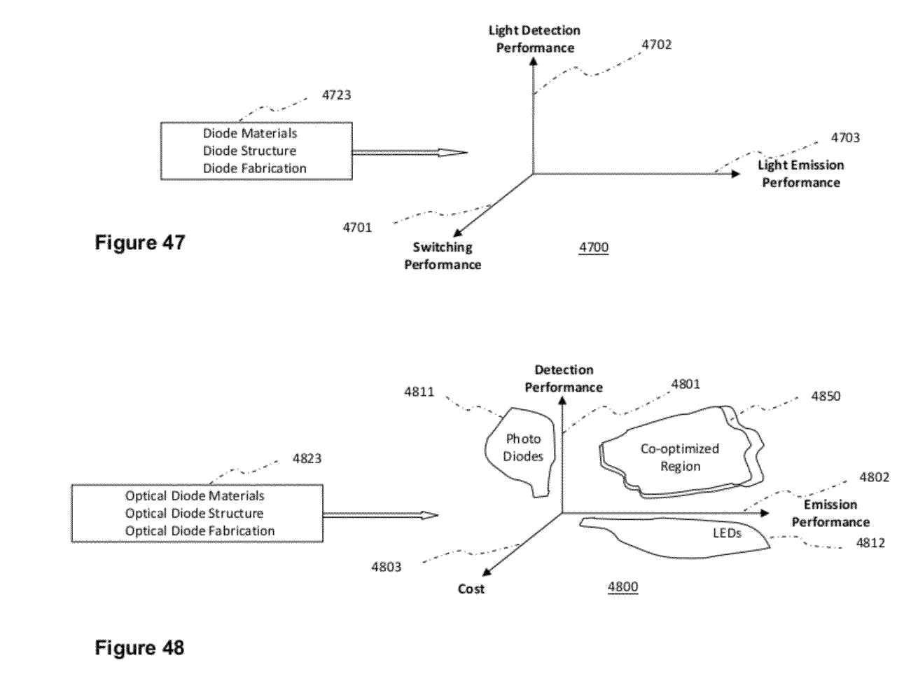

FIG. 47 depicts an optimization space 4700 for semiconductor (traditional crystal lattice or organic material) diodes comprising attributes of signal switching performance, light emitting performance, and light detection performance. Specific diode materials, diode structure, and diode fabrication approaches 4723 can be adjusted to optimize a resultant diode for switching function performance 4701 (for example, via use of abrupt junctions), light detection performance 4702 (for example via a P-I-N structure comprising a layer of intrinsic semiconducting material between regions of n-type and p-type material, or light detection performance 4703.

FIG. 48 depicts an exemplary “metric space” 4800 of device realizations for optoelectronic devices and regions of optimization and co-optimization.

Specific optoelectrical diode materials, structure, and fabrication approaches 4823 can be adjusted to optimize a resultant optoelectrical diode for light detection performance 4801 (for example via a P-I-N structure comprising a layer of intrinsic semiconducting material between regions of n-type and p-type material versus light emission performance 4802 versus cost 4803. Optimization within the plane defined by light detection performance 4801 and cost 4803 traditionally result in photodiodes 4811 while optimization within the plane defined by light emission performance 4802 and cost 4803 traditionally result in LEDs 4812. The present invention provides for specific optoelectrical diode materials, structure, and fabrication approaches 4823 to be adjusted to co-optimize an optoelectrical diode for both good light detection performance 4801 and light emission performance 4802 versus cost 4803. A resulting co-optimized optoelectrical diode can be used for multiplexed light emission and light detection modes. These permit a number of applications as explained in the sections to follow.

Again it is noted that an emerging alternative to OLEDs are Organic Light Emitting Transistors (OLETS). The present invention allows for arrangements employing OLETS to be employed in place of OLEDs and inorganic LEDs as appropriate and advantageous wherever mentioned throughout the specification.

Electronic Circuit Interfacing to LEDs Used as Light Sensors

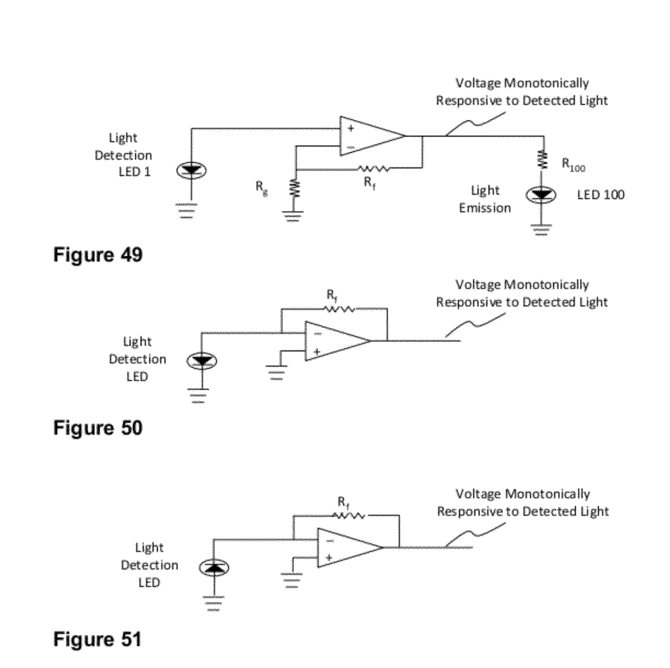

FIGS. 49-52 depict various exemplary circuits demonstrating various exemplary approaches to detecting light with an LED. These initially introduce the concepts of received light intensity measurement (“detection”) and varying light emission intensity of an LED in terms of variations in D.C. (“direct-current”) voltages and currents. However, light intensity measurement (“detection”) can be accomplished by other means such as LED capacitance effects—for example reverse-biasing the LED to deposit a known charge, removing the reverse bias, and then measuring the time for the charge to then dissipate within the LED. Also, varying the light emission intensity of an LED can be accomplished by other means such as pulse-width-modulation—for example, a duty-cycle of 50% yields 50% of the “constant-on” brightness, a duty-cycle of 50% yields 50% of the “constant-on” brightness, etc. These, too, are provided for by the invention and will be considered again later as variations of the illustrative approaches provided below.

To begin, LED1 in FIG. 49 is employed as a photodiode, generating a voltage with respect to ground responsive to the intensity of the light received at the optically-exposed portion of the LED-structured semiconducting material. In particular, for at least a range of light intensity levels the voltage generated by LED1 increases monotonically with the received light intensity. This voltage can be amplified by a high-impedance amplifier, preferably with low offset currents. The example of FIG. 49 shows this amplification performed by a simple operational amplifier (“op amp”) circuit with fractional negative feedback, the fraction determined via a voltage divider. The gain provided by this simple op amp arrangement can be readily recognized by one skilled in the art as

1+(R_{f}/R_{g}).

The op amp produces an isolated and amplified output voltage that increases, at least for a range, monotonically with increasing light received at the light detection LED1. Further in this example illustrative circuit, the output voltage of the op amp is directed to LED100 via current-limiting resistor R100. The result is that the brightness of light emitted by LED100 varies with the level of light received by LED1.

For a simple lab demonstration of this rather remarkable fact, one can choose a TL08x series (TL082, TL084, etc.) or equivalent op amp powered by +12 and −12 volt split power supply, R100 of ˜1 KΩ, and R_{f}/R_{g} in a ratio ranging from 1 to 20 depending on the type of LED chosen. LED100 will be dark when LED1 is engulfed in darkness and will be brightly lit when LED1 is exposed to natural levels of ambient room light. For best measurement studies, LED1 could comprise a “water-clear” plastic housing (rather than color-tinted). It should also be noted that the LED1 connection to the amplifier input is of relatively quite high impedance and as such can readily pick up AC fields, radio signals, etc. and is best realized using as physically small electrical surface area and length as possible. In a robust system, electromagnetic shielding is advantageous.

The demonstration circuit of FIG. 49 can be improved, modified, and adapted in various ways (for example, by adding voltage and/or current offsets, JFET preamplifiers, etc.), but as shown is sufficient to show that a wide range of conventional LEDs can serve as pixel sensors for an ambient-room light sensor array as can be used in a camera or other room-light imaging system. Additionally, LED100 shows the role an LED can play as a pixel emitter of light.

FIG. 50 shows a demonstration circuit for the photocurrent of the LED. For at least a range of light intensity levels the photocurrent generated by LED1 increases monotonically with the received light intensity. In this exemplary circuit the photocurrent is directed to a natively high-impedance op amp (for example, a FET input op amp such as the relatively well-known LF-351) set up as an inverting current-to-voltage converter. The magnitude of the transresistance (i.e., the current-to-voltage “gain”) of this inverting current-to-voltage converter is set by the value of the feedback resistor Rf. The resultant circuit operates in a similar fashion to that of FIG. 49 in that the output voltage of the op amp increases, at least for a range, monotonically with increasing light received at the light detection LED. The inverting current-to-voltage converter inverts the sign of the voltage, and such inversion in sign can be corrected by a later amplification stage, used directly, or is preferred. In other situations it can be advantageous to not have the sign inversion, in which case the LED orientation in the circuit can be reversed, as shown in FIG. 51.

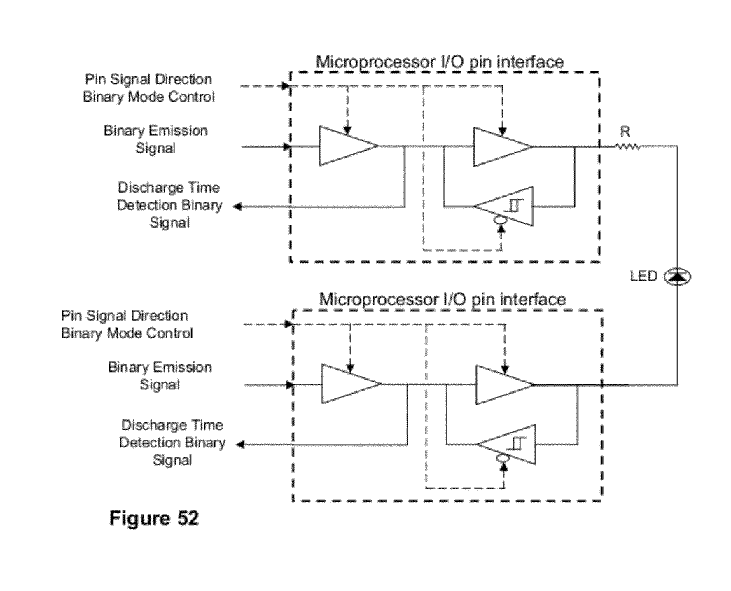

FIG. 52 shows an illustrative demonstration arrangement in which an LED can be for a very short duration of time reverse biased and then in a subsequent interval of time the resultant accumulations of charge in the junction capacitance of the LED are discharged. The decrease in charge during discharge through the resistor R results in a voltage that can be measured with respect to a predetermined voltage threshold, for example as can be provided by a (non-hysteretic) comparator or (hysteretic) Schmitt-trigger. The resulting variation in discharge time varies monotonically with the light received by the LED. The illustrative demonstration arrangement provided in FIG. 52 is further shown in the context of connects to the bidirectional I/O pin circuit for a conventional microprocessor. This permits the principal to be readily demonstrated through a simple software program operating on such a microprocessor. Additionally, as will be seen later, the very same circuit arrangement can be used to variably control the emitted light brightness of the LED by modulating the temporal pulse-width of a binary signal at one or both of the microprocessor pins.

Multiplexing Circuitry for LED Arrays

For rectangular arrays of LEDs, it is typically useful to interconnect each LED with access wiring arranged to be part of a corresponding matrix wiring arrangement. The matrix wiring arrangement is time-division multiplexed. Such time-division multiplexed arrangements can be used for delivering voltages and currents to selectively illuminate each individual LED at a specific intensity level (including very low or zero values so as to not illuminate).

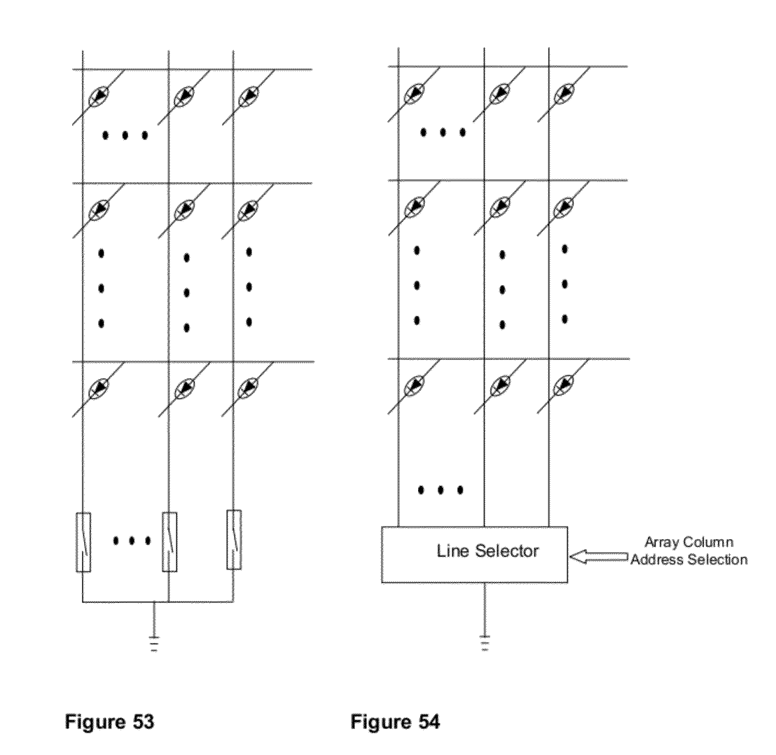

An example multiplexing arrangement for a two-dimensional array of LEDs is depicted in FIG. 53. Here each of a plurality of normally-open analog switches are sequentially closed for brief disjointed intervals of time. This allows the selection of a particular subset (here, a column) of LEDs to be grounded while leaving all other LEDs in the array not connected to ground. Each of the horizontal lines then can be used to connect to exactly one grounded LED at a time. The plurality of normally-open analog switches in FIG. 53 can be controlled by an address decoder so that the selected subset can be associated with a unique binary address, as suggested in FIG. 54. The combination of the plurality of normally-open analog switches together with the address decoder form an analog line selector. By connecting the line decoder's address decoder input to a counter, the columns of the LED array can be sequentially scanned.

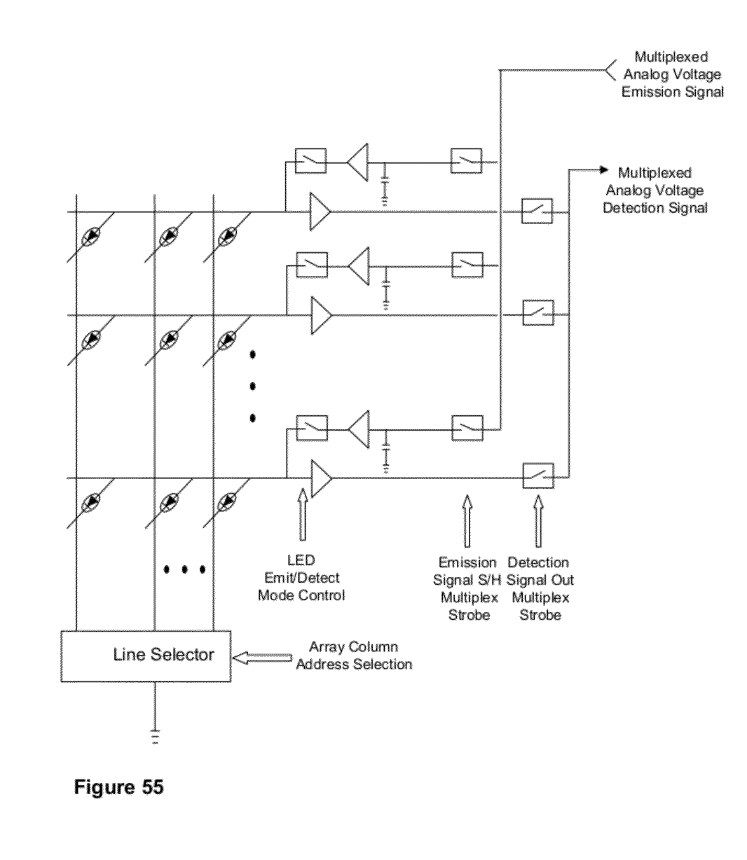

FIG. 55 depicts an exemplary adaptation of the arrangement of FIG. 54 together to form a highly scalable LED array display that also functions as a light field detector. The various multiplexing switches in this arrangement can be synchronized with the line selector and mode control signal so that each LED very briefly provides periodically updated detection measurement and is free to emit light the rest of the time. A wide range of variations and other possible implementations are possible and implemented in various products.

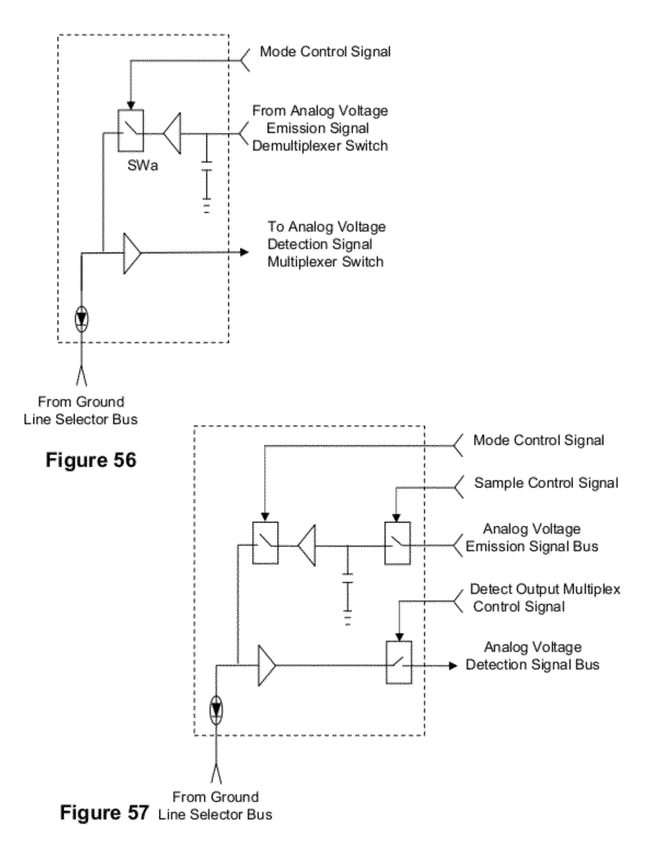

Such time-division multiplexed arrangements can alternatively be used for selectively measuring voltages or currents of each individual LED. Further, the illumination and measurement time-division multiplexed arrangements themselves can be time-division multiplexed, interleaved, or merged in various ways. As an illustrative example, the arrangement of FIG. 55 can be reorganized so that the LED, mode control switch, capacitor, and amplifiers are collocated, for example as in the illustrative exemplary arrangement of FIG. 56. Such an arrangement can be implemented with, for example, three MOSFET switching transistor configurations, two MOSFET amplifying transistor configurations, a small-area/small-volume capacitor, and an LED element (that is, five transistors, a small capacitor, and an LED). This can be treated as a cell which is interconnected to multiplexing switches and control logic. A wide range of variations and other possible implementations are possible and the example of FIG. 55 is in no way limiting. For example, the arrangement of FIG. 55 can be reorganized to decentralize the multiplexing structures so that the LED, mode control switch, multiplexing and sample/hold switches, capacitor, and amplifiers are collocated, for example as in the illustrative exemplary arrangement of FIG. 57. Such an arrangement can be implemented with, for example, three MOSFET switching transistor configurations, two MOSFET amplifying transistor configurations, a small-area/small-volume capacitor, and an LED element (that is, five transistors, a small capacitor, and an LED). This can be treated as a cell whose analog signals are directly interconnected to busses. Other arrangements are also possible.

The discussion and development thus far are based on the analog circuit measurement and display arrangement of FIG. 49 that in turn leverages the photovoltaic properties of LEDs. With minor modifications clear to one skilled in the art, the discussion and development thus far can be modified to operate based on the analog circuit measurement and display arrangements of FIG. 50 and FIG. 51 that leverage the photocurrrent properties of LEDs.

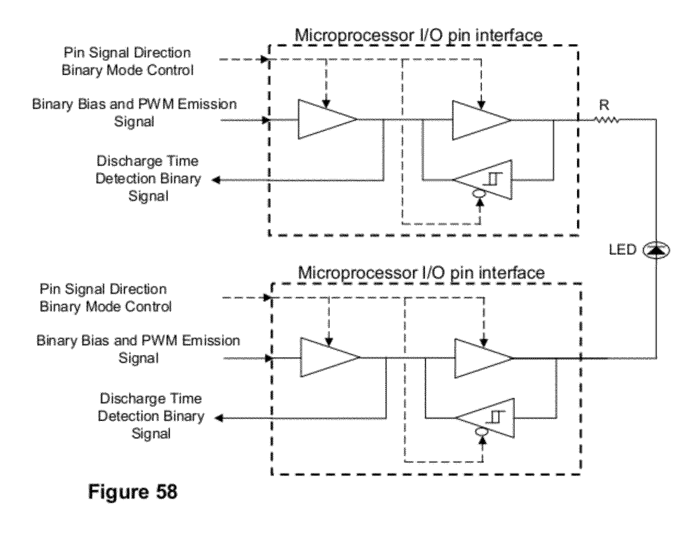

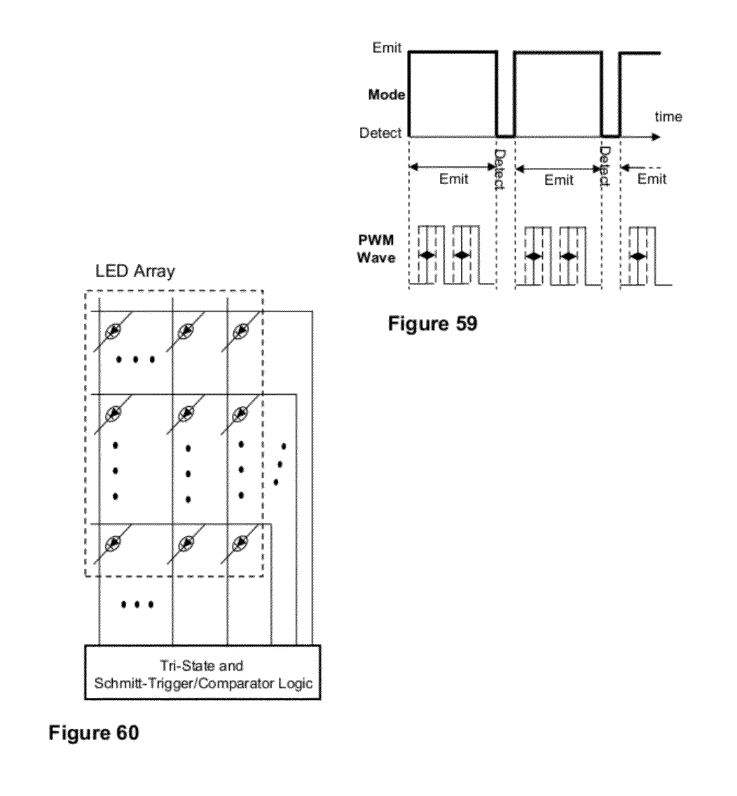

FIGS. 58-60 depict an example of how the digital circuit measurement and display arrangement of FIG. 52 (that in turn leverages discharge times for accumulations of photo-induced charge in the junction capacitance of the LED) can be adapted into the construction developed thus far. FIG. 58 adapts FIG. 52 to additional include provisions for illuminating the LED with a pulse-modulated emission signal. Noting that the detection process described earlier in conjunction with FIG. 52 can be confined to unperceivably short intervals of time, FIG. 59 illustrates how a pulse-width modulated binary signal can be generated during LED illumination intervals to vary LED emitted light brightness. FIG. 60 illustrates an adaptation of the tri-state and Schmitt-trigger/comparator logic akin to that illustrated in the microprocessor I/O pin interface that can be used to sequentially access subsets of LEDs in an LED array as described in conjunction with FIG. 53 and FIG. 54.

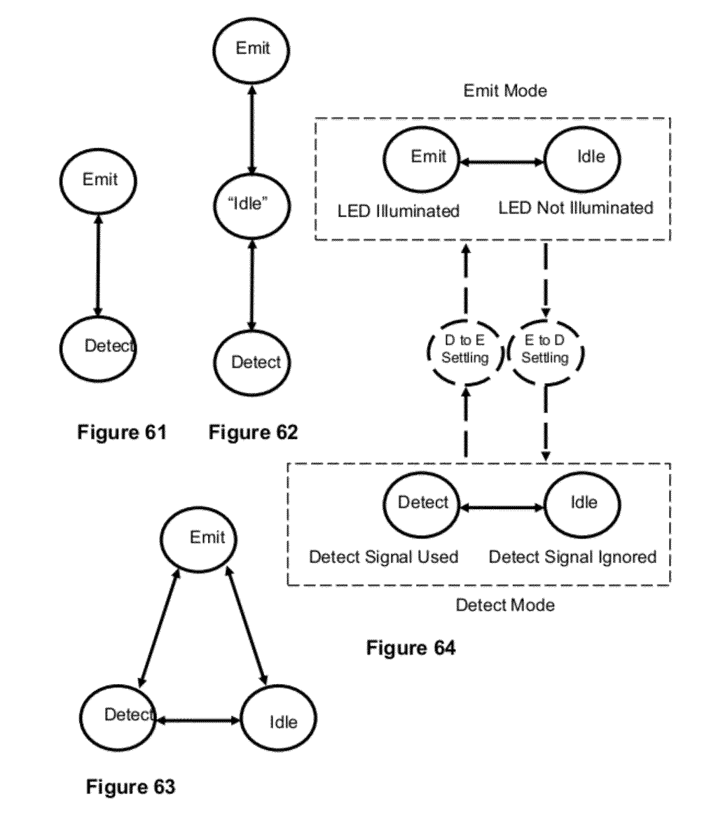

FIG. 61-63 depict exemplary state diagrams for the operation of the LED and the use of input signals and output signals described above. From the viewpoint of the binary mode control signal there are only two states: a detection state and an emission state, as suggested in FIG. 61. From the viewpoint of the role of the LED in a larger system incorporating a multiplexed circuit arrangement such as that of FIG. 55, there can a detection state, an emission state, and an idle state (where there is no emission nor detection occurring), obeying state transition maps such as depicted in FIG. 62 or FIG. 63. At a further level of detail, there are additional considerations:
To emit light, a binary mode control signal can be set to “emit” mode (causing the analog switch to be closed) and the emission light signal must be of sufficient value to cause the LED to emit light (for example, so that the voltage across the LED is above the “turn-on” voltage for that LED).
   If the binary mode control signal is in “emit” mode but the emission light signal is not of such sufficient value, the LED will not illuminate. This can be useful for brightness control (via pulse-width modulation), black-screen display, and other uses. In some embodiments, this can be used to coordinate the light emission of neighboring LEDs in an array while a particular LED in the array is in detection mode.
   If the emission light signal of such sufficient value but the binary mode control signal is in “detect” mode, the LED will not illuminate responsive to the emission light signal. This allows the emission light signal to be varied during a time interval when there is no light emitted, a property useful for multiplexing arrangements.
During a time interval beginning with the change of state of the binary mode control signal to some settling-time period afterwards, the detection output and/or light emission level can momentarily not be accurate.
To detect light, the binary mode control signal must be in “detect” mode (causing the analog switch to be open). The detected light signal can be used by a subsequent system or ignored. Intervals where the circuit is in detection mode but the detection signal is ignored can be useful for multiplexing arrangement, in providing guard-intervals for settling time, to coordinate with the light emission of neighboring LEDs in an array, etc.

FIG. 64 depicts an exemplary state transition diagram reflecting the above considerations. The top “Emit Mode” box and bottom “Detect Mode” box reflect the states of an LED from the viewpoint of the binary mode control signal as suggested by FIG. 61. The two “Idle” states (one in each of the “Emit Mode” box and “Detect Mode” box) of FIG. 64 reflect (at least in part) the “Idle” state suggested in FIG. 62 and/or FIG. 63. Within the “Emit Mode” box, transitions between “Emit” and “Idle” can be controlled by emit signal multiplexing arrangements, algorithms for coordinating the light emission of an LED in an array while a neighboring LED in the array is in detection mode, etc. Within the “Detect Mode” modality, transitions between “Detect” and “Idle” can be controlled by independent or coordinated multiplexing arrangements, algorithms for coordinating the light emission of an LED in an array while a neighboring LED in the array is in detection mode, etc. In making transitions between states in the boxes, the originating and termination states can be chosen in a manner advantageous for details of various multiplexing and feature embodiments. Transitions between the groups of states within the two boxes correspond to the vast impedance shift invoked by the switch opening and closing as driven by the binary mode control signal. In FIG. 64, the settling times between these two groups of states are gathered and regarded as a transitional state.

As mentioned earlier, the amplitude of light emitted by an LED can be modulated to lesser values by means of pulse-width modulation (PWM) of a binary waveform. For example, if the binary waveform oscillates between fully illuminated and non-illuminated values, the LED illumination amplitude will be perceived roughly as 50% of the full-on illumination level when the duty-cycle of the pulse is 50%, roughly as 75% of the full-on illumination level when the duty-cycle of the pulse is 75%, roughly as 10% of the full-on illumination level when the duty-cycle of the pulse is 10%, etc. Clearly the larger fraction of time the LED is illuminated (i.e., the larger the duty-cycle), the brighter the perceived light observed emitted from the LED.

Use of a LED Array as “Multi-Touch” Tactile Sensor Array

Multi-touch sensors on cellphones, smartphones, PDAs, tablet computers, and other such devices typically utilize a capacitive matrix proximity sensor. Typically a transparent capacitive matrix proximity sensor is overlaid over an LCD display, which is in turn overlaid on a (typically LED) backlight used to create and direct light though the LCD display from behind. Each of the capacitive matrix and the LCD have considerable associated electronic circuitry and software associated with them.

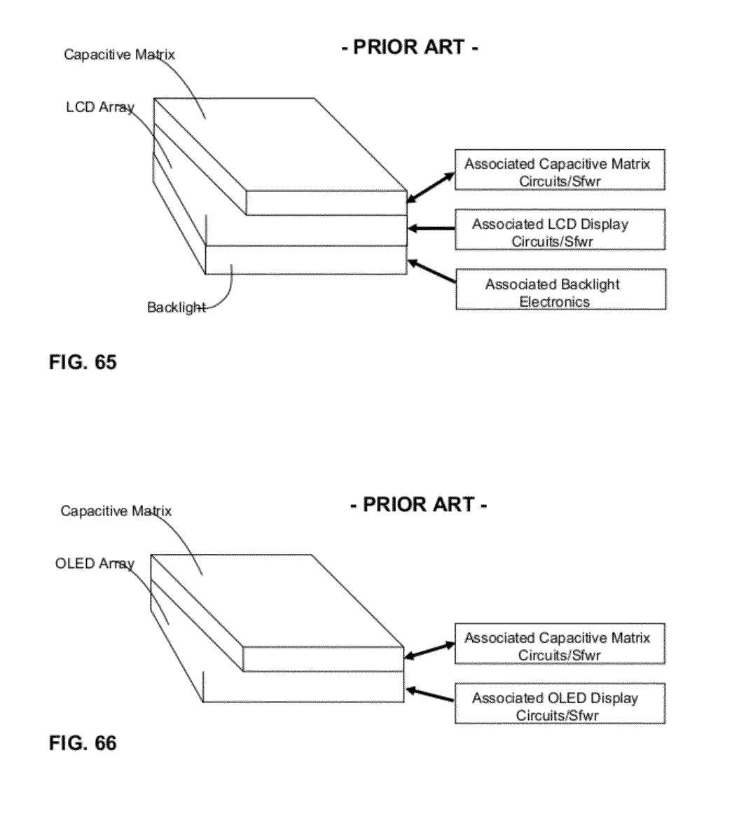

FIG. 66 depicts an exemplary modification of the arrangement depicted in FIG. 65 wherein the LCD display and backlight are replaced with an OLED array used as a visual display. Such an arrangement has started to be incorporated in recent contemporary cellphone, smartphone, PDA, tablet computers, and other portable device products by several manufacturers. Note the considerable reduction in optoelectronic, electronic, and processor components. This is one of the motivations for using OLED displays in these emerging product implementations.

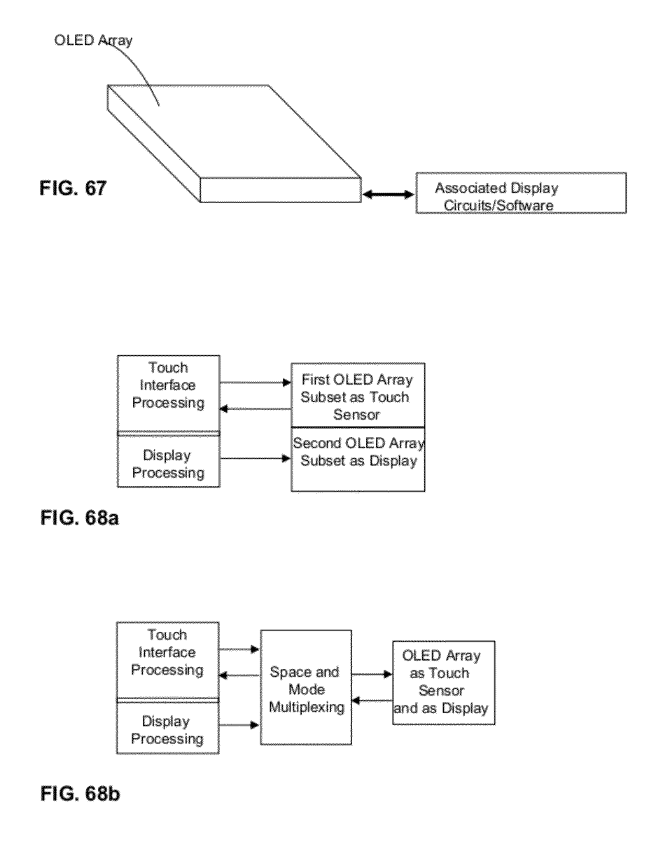

FIG. 67 depicts an exemplary arrangement provided for by the invention comprising only a LED array. In general the LEDs in the LED array can be OLEDs or inorganic LEDs. In an embodiment provided for by the invention, such an arrangement can be used as a tactile user interface, or as a combined a visual display and tactile user interface, as will be described. Note the considerable reduction in optoelectronic, electronic, and processor components over the both the arrangement depicted in FIG. 65 and the arrangement depicted in FIG. 66. This is one of among the many advantages of the various embodiments and adaptations of the present invention, as will be described.

Arrays of inorganic-LEDs have been used to create a tactile proximity sensor array as taught by Han in U.S. Pat. No. 7,598,949 and depicted in the video available at http://cs.nyu.edu/.aboutjhan/ledtouch/index.html). Pending U.S. patent application Ser. No. 12/418,605 teaches several adaptations and enhancements of such an approach, including configuring the operation of an LED array to emit modulated light that is modulated at a particular carrier frequency and/or with a particular time-variational waveform and respond to only modulated light signal components extracted from the received light signals comprising that same carrier frequency or time-variational waveform (so as to reject potential interference from ambient light in the surrounding user environment). As described earlier, FIG. 9 depicts a representative exemplary arrangement wherein light emitted by neighboring LEDs is reflected from a finger (or other object) back to an LED acting as a light sensor.

In its most primitive form, such LED-array tactile proximity array implementations need to be operated in a darkened environment (as seen in the video available at http://cs.nyu.edu/.aboutjhan/ledtouch/index.html). The invention provides for additional systems and methods for not requiring darkness in the user environment in order to operate the LED array as a tactile proximity sensor.

As taught in pending U.S. patent application Ser. No. 12/418,605, potential interference from ambient light in the surrounding user environment can be limited by using an opaque pliable and/or elastically deformable surface covering the LED array that is appropriately reflective (directionally, amorphously, etc. as can be advantageous in a particular design) on the side facing the LED array. Such a system and method can be readily implemented in a wide variety of ways as is clear to one skilled in the art.

Also as taught in pending U.S. patent application Ser. No. 12/418,605, potential interference from ambient light in the surrounding user environment can be limited by employing amplitude, phase, or pulse width modulated circuitry and/or software to control the light emission and receiving process. For example, in an implementation the LED array can be configured to emit modulated light that is modulated at a particular carrier frequency and/or with a particular time-variational waveform and respond to only modulated light signal components extracted from the received light signals comprising that same carrier frequency or time-variational waveform. Such a system and method can be readily implemented in a wide variety of ways as is clear to one skilled in the art.

In various embodiments and alternative implementations provided for by the invention, light measurements used for implementing a tactile user interface can be from unvignetted LEDs, unvignetted photodiodes, vignetted LEDs, vignetted photodiodes, or combinations of two or more of these.

Pending U.S. patent application Ser. No. 12/418,605 further teaches application of such LED-based tactile sensor for use as a touch sensor in an HDTP implementation that provides single-touch and multi-touch measurement of finger contact angles and downward pressure. The performance of such features can advantageously improve with increases in spatial resolution of the tactile sensor. U.S. patent application Ser. No. 12/418,605 additionally teaches further considerations and accommodations for interacting with high spatial resolution tactile image measurements, particularly in situations involving multi-touch and/or parts of the hand and fingers other than fingertips. Further, pending U.S. patent application Ser. No. 13/180,345 teaches among other things various physical, electrical, and operational approaches to integrating a touchscreen with OLED arrays, displays, inorganic LED arrays, and LCDs, etc. as well as using such arrangements to integrate other applications. It is also noted that pending U.S. patent application Ser. No. 11/761,978 (priority date May 15, 1999) teaches a gesture-based touchscreen employing a transparent tactile sensor.

One aspect of the present invention is directed to using an OLED array as a high spatial resolution of the tactile sensor.

Another aspect of the present invention is directed to using an OLED array as both a display and as a high spatial resolution of the tactile sensor.

Another aspect of the present invention is directed to using an OLED array as a high spatial resolution tactile sensor in touchscreen implementation.

Another aspect of the present invention is directed to using an OLED array as both a display and as a high spatial resolution tactile sensor in touchscreen implementation.

Another aspect of the present invention is directed to using an OLED array as a high spatial resolution tactile sensor in a touch-based user interface that provides multi-touch capabilities.

Another aspect of the present invention is directed to using an OLED array as both a display and as a high spatial resolution tactile sensor in a touch-based user interface that provides multi-touch capabilities.

Another aspect of the present invention is directed to using an OLED array as a high spatial resolution tactile sensor in an HDTP implementation.

Another aspect of the present invention is directed to using an OLED array as both a display and as a high spatial resolution tactile sensor in an HDTP implementation.

Another aspect of the present invention is directed to using an OLED array as a high spatial resolution tactile sensor in a touch-based user interface that provides at least single-touch measurement of finger contact angles and downward pressure.

Another aspect of the present invention is directed to using an OLED array as both a display and as a high spatial resolution tactile sensor in a touch-based user interface that provides at least single-touch measurement of finger contact angles and downward pressure.

Another aspect of the present invention is directed to using an OLED array as a high spatial resolution tactile sensor in a touch-based user interface that provides at least single-touch measurement of finger contact angles with the touch sensor.

Another aspect of the present invention is directed to using an OLED array as both a display and as a high spatial resolution tactile sensor in a touch-based user interface that provides at least single-touch measurement of finger contact angles with the touch sensor.

Another aspect of the present invention is directed to using an OLED array as a high spatial resolution tactile sensor in a touch-based user interface that provides at least single-touch measurement of downward pressure asserted on the touch sensor by a user finger.

Another aspect of the present invention is directed to using an OLED array as both a display and as a high spatial resolution tactile sensor in a touch-based user interface that provides at least single-touch measurement of downward pressure asserted on the touch sensor by a user finger.

Another aspect of the present invention provides a touch interface system for the operation by at least one finger, the touch interface physically associated with a visual display, the system comprising a processor executing at least one software algorithm, and a light emitting diode (LED) array comprising a plurality of transparent organic light emitting diodes (OLEDs) forming a transparent OLED array, the transparent OLED array configured to communicate with the processor. The at least one software algorithm is configured to operate at least a first group of OLEDS from the transparent OLED array in at least a light sensing mode. The OLEDs in the at least a first group of OLEDs are configured to detect light using a photoelectric effect when light is received for an interval of time and communicates the light detection to the processor. The at least one software algorithm is configured to produce tactile measurement information, the tactile measurement information responsive to light reflected by at least a finger proximate to the OLED array, and a portion of the reflected light is reflected to at least one OLED of the first group of the transparent OLED array, the reflected light originating from a software-controlled light source. The processor is configured to generate at least one control signal responsive to light reflected by at least one finger proximate to the OLED array.

In another aspect of the present invention, the software-controlled light source is another LED array.

In another aspect of the present invention, the LED array is acting as the software-controlled light source is another OLED array.

In another aspect of the present invention, the software-controlled light source is implemented by a second group of the transparent OLEDs from the transparent OLED array.

In another aspect of the present invention, the first group of OLEDs and the second group of OLEDs are distinct.

In another aspect of the present invention, the first group of the transparent OLEDs and the second group of the transparent OLEDs both comprise at least one OLED that common to both groups.

In another aspect of the present invention, the first group of the transparent OLEDs and the second group of the transparent OLEDs are the same group.

In another aspect of the present invention, the transparent OLED array is configured to perform light sensing for at least an interval of time.

In another aspect of the present invention, the software-controlled light source comprises a Liquid Crystal Display.

In another aspect of the present invention, the processor and the at least one software algorithm are configured to operate the transparent OLED array in a light emitting mode.

In another aspect of the present invention, the software-controlled light source is configured to emit modulated light.

In another aspect of the present invention, the reflected light comprises the modulated light.

In another aspect of the present invention, the system is further configured to provide the at least one control signal responsive to the reflected light.

In another aspect of the present invention, the system is further configured so that the at least one control signal comprises a high spatial resolution reflected light measurement responsive to the reflected light.

In another aspect of the present invention, the system is used to implement a tactile user interface.

In another aspect of the present invention, the system is used to implement a touch-based user interface.

In another aspect of the present invention, the system is used to implement a touchscreen.

In another aspect of the invention, the processor is configured to generate at least one control signal responsive to changes in the light reflected by at least one finger proximate to the OLED array.

In another aspect of the invention, the processor is configured to generate at least one control signal responsive to a touch gesture performed by at least one finger proximate to the OLED array.

Example Physical Configurations for Tactile Sensor and Display Arrangements

The capabilities described thus far can be combined with systems and techniques to be described later in a variety of physical configurations and implementations. A number of example physical configurations and implementations are described here and in pending U.S. patent application Ser. No. 13/180,345 that provide various advantages to various embodiments, implementations, and applications of the present invention. Many variations and alternatives are possible and are accordingly anticipated by the invention, and the example physical configurations and implementations are in no way limiting of the invention.

Attention is first directed to arrangements wherein a single LED array—such as an OLED display, other OLED array, inorganic LED array, inorganic LED display, etc.—is configured to operate as both a display and a touch sensor (for example for use as a touchscreen) and various generalizations of these. The earlier discussion associated with FIG. 67, for example, relates to an OLED array implementation relevant to such arrangements. There are at least two approaches for implementing such arrangements (wherein a single LED array—such as an OLED display, other OLED array, inorganic LED array, inorganic LED display, etc.—is configured to operate as both a display and a touch sensor (for example a touchscreen).
In a first example approach, the inorganic LEDs or OLEDs comprised by an (inorganic LED or OLED) LED array are partitioned into two subsets. One subset is employed as a display, while the other subset is employed as a tactile sensor. In various embodiments, individual elements of the two subsets can be spatially interleaved in various ways—for example in co-planar, non-coplanar, stacked, or other arrangements. FIG. 68a depicts an example arrangement wherein an (inorganic LED or OLED) LED array is partitioned into two subsets, one subset employed as a visual display and the other subset employed as a tactile sensor.
In a second example approach, the inorganic LEDs or OLEDs comprised by an (inorganic LED or OLED) LED array are multiplexed between or among at least a light emitting mode and a light sensing mode. The light emitting mode is used for both visual display and tactile-sensor touch-area illumination, and the light sensing mode is used for tactile sensing. FIG. 68b depicts an arrangement wherein inorganic LEDs or OLEDs comprised by an (inorganic LED or OLED) LED array are multiplexed between or among at least a light emitting mode and a light sensing mode.
   Various other implementations are possible, for example various combinations

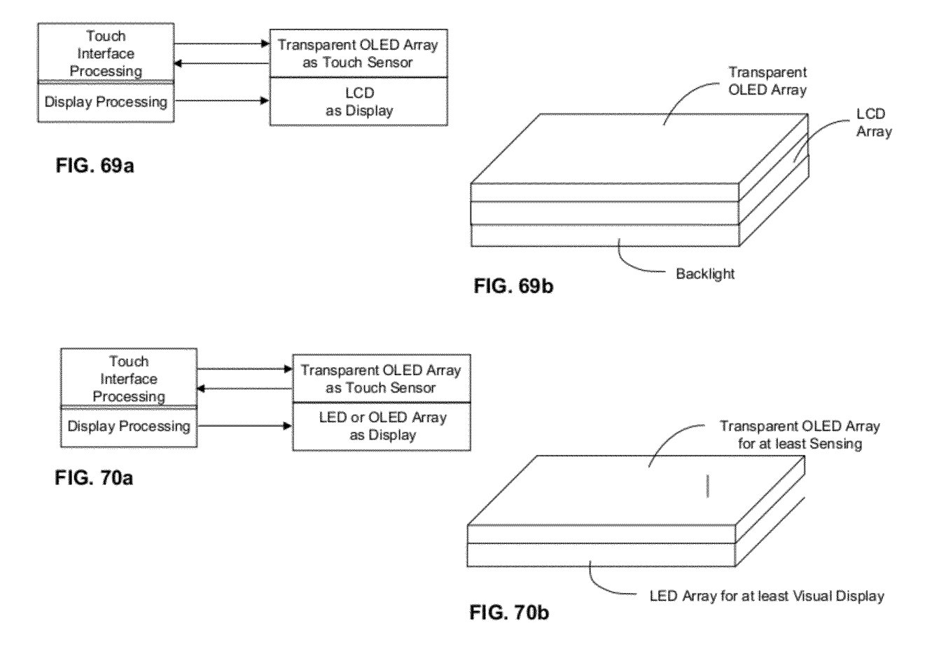

Attention is now directed to arrangements wherein a transparent LED array (inorganic LED or OLED), for example implemented with arrays of transparent OLEDs interconnected with transparent conductors, is overlaid atop an LCD display, and various generalizations of this. The transparent conductors can for example be comprised of materials such as indium tin oxide, fluorine-doped tin oxide (“FTO”), doped zinc oxide, organic polymers, carbon nanotubes, graphene ribbons, etc. There are at least three approaches for implementing such arrangements wherein a transparent LED array (inorganic LED or OLED), for example implemented with arrays of transparent OLEDs interconnected with transparent conductors, is overlaid atop an LCD display.
In a first example approach, the inorganic LEDs or OLEDs comprised by an (inorganic LED or OLED) LED array are used only in light sensing mode for tactile sensing, and the LCD is used for both a visual display and tactile-sensor touch-area illumination.
In a second example approach, the inorganic LEDs or OLEDs comprised by an (inorganic LED or OLED) LED array are partitioned into two subsets. One subset is employed as a display, while the other subset is employed as a tactile sensor. In various embodiments individual elements of the two subsets can be spatially interleaved in various ways—for example in co-planar, non-coplanar, stacked, or other arrangements. The LCD is used only as a visual display.
In a third example approach, the inorganic LEDs or OLEDs comprised by an (inorganic LED or OLED) LED array are multiplexed between or among at least a light emitting mode and a light sensing mode. The light emitting mode is used for tactile-sensor touch-area illumination, and the light sensing mode is used for tactile sensing. The LCD is used only as a visual display.
   FIG. 69a depicts an example arrangement wherein a transparent (inorganic LED or OLED) LED array is used as a touch sensor, and overlaid atop an LCD display. Various other implementations are possible, for example various combinations

FIG. 69b depicts an example implementation comprising a transparent OLED array overlaid upon an LCD visual display, which is in turn overlaid on a (typically) LED backlight used to create and direct light though the LCD visual display from behind. Such an arrangement can be used to implement an optical tactile user interface arrangement as enabled by the present invention. Other related arrangements and variations are possible and are anticipated by the invention. The invention provides for inclusion of coordinated multiplexing or other coordinated between the OLED array and LCD as needed or advantageous. It is noted in one embodiment the LCD and LED array can be fabricated on the same substrate, the first array layered atop the second (or visa versa) while in another embodiment the two LED arrays can be fabricated separately and later assembled together to form layered structure. Other related arrangements and variations are possible and are anticipated by the invention.

Attention is now directed to arrangements wherein a first transparent (inorganic LED or OLED) LED array is overlaid upon a second (inorganic LED or OLED) LED array, and various variations and generalizations of this. There are at least three approaches for implementing such arrangements and several variations wherein a first transparent (inorganic LED or OLED) LED array is overlaid upon a second (inorganic LED or OLED) LED array:
In a first example approach, the inorganic LEDs or OLEDs comprised by one of the (inorganic LED or OLED) LED array are used only in light sensing mode for tactile sensing, and the other LED array is used for both a visual display and tactile-sensor touch-area illumination.
   In one example variation of the first example approach, the top LED array serves as a tactile sensor and the bottom LED array serves as a visual display.
   In another example variation of the first example approach, the top

LED array serves as a tactile sensor and the bottom LED array serves as a visual display.
In a second example approach, the inorganic LEDs or OLEDs comprised by an (inorganic LED or OLED) LED array are partitioned into two subsets. One subset is employed as a display, while the other subset is employed as a tactile sensor. In various embodiments individual elements of the two subsets can be spatially interleaved in various ways—for example in co-planar, non-coplanar, stacked, or other arrangements. The other LED array is used only as a visual display.
   In one example variation of the second example approach, the top LED array serves as a tactile sensor and the bottom LED array serves as a visual display.
   In another example variation of the second example approach, the top LED array serves as a tactile sensor and the bottom LED array serves as a visual display.
In a third example approach, the inorganic LEDs or OLEDs comprised by an (inorganic LED or OLED) LED array are multiplexed between or among at least a light emitting mode and a light sensing mode. The light emitting mode is used for tactile-sensor touch-area illumination, and the light sensing mode is used for tactile sensing. The other LED array is used only as a visual display.
   In one example variation of the third example approach, the top LED array serves as a tactile sensor and the bottom LED array serves as a visual display.
   In another example variation of the third example approach, the top LED array serves as a tactile sensor and the bottom LED array serves as a visual display.
      FIG. 70a depicts an example arrangement wherein a transparent (inorganic LED or OLED) LED array is overlaid upon a second (inorganic LED or OLED) LED array, wherein one LED array is used for at least optical sensing and the other LED array used for at least visual display. Other related arrangements and variations are possible and are anticipated by the invention.

FIG. 70b depicts an example implementation comprising a first transparent (inorganic LED or OLED) LED array overlaid upon a second (inorganic LED or OLED) LED array. Such an arrangement can be employed to allow the first array to be optimized for one or more purposes, at least one being sensing, and the second LED array to be optimized for one or more purposes, at least one being visual display. Such an arrangement can be used to implement an optical tactile user interface arrangement as enabled by the present invention.
In one approach the second LED array is used for both visual display and tactile user interface illumination light and the first transparent (inorganic LED or OLED) LED array is used for tactile user interface light sensing.
In another approach, the first transparent (inorganic LED or OLED) LED array is used for both providing tactile user interface illumination light and for light sensing, while the second LED array is used for visual display.
   Such an arrangement can be used to implement a light field sensor and a lensless imaging camera as described earlier. Other related arrangements and variations are possible and are anticipated by the invention.

The invention further provides for inclusion of coordinated multiplexing or other coordinated between the first LED array and second LED array as needed or advantageous. It is noted in one embodiment the two LED arrays can be fabricated on the same substrate, the first array layered atop the second (or visa versa) while in another embodiment the two LED arrays can be fabricated separately and later assembled together to form layered structure. Further, In an example embodiment, the second LED array can be an OLED array. In an embodiment, either or both of the LED arrays can comprise photodiodes. Other related arrangements and variations are possible and are anticipated by the invention.

FIG. 71 depicts an example implementation comprising a first transparent (inorganic LED or OLED) LED array used for at least visual display overlaid upon a second (inorganic LED or OLED) LED array used for at least optical sensing. In an example embodiment, the either or both of the first and second LED arrays can be an OLED array. In an embodiment, either or both of the LED arrays can comprise photodiodes. Such an arrangement can be employed to allow the first array to be optimized for to be optimized for other purposes, at least one being visual display, and the second LED array to be optimized for one or more purposes, at least one being sensing. Such an arrangement can be used to implement an optical tactile user interface arrangement as enabled by the present invention.
In one approach the first LED array is used for both visual display and tactile user interface illumination light and the second (transparent OLED) LED array is used for tactile user interface light sensing. In another approach, the second (transparent OLED) LED array is used for both tactile user interface illumination light and light sensing, while the first LED array is used for visual display.
In an embodiment, the second LED array comprises vignetting structures (as described above) and serves as a light field sensor to enable the implementation of a lensless imaging camera.

Other related arrangements and variations are possible and are anticipated by the invention. The invention provides for inclusion of coordinated multiplexing or other coordinated between the first LED array and second LED array as needed or advantageous. It is noted in one embodiment the two LED arrays can be fabricated on the same substrate, the first array layered atop the second (or visa versa) while in another embodiment the two LED arrays can be fabricated separately and later assembled together to form layered structure. Other related arrangements and variations are possible and are anticipated by the invention.

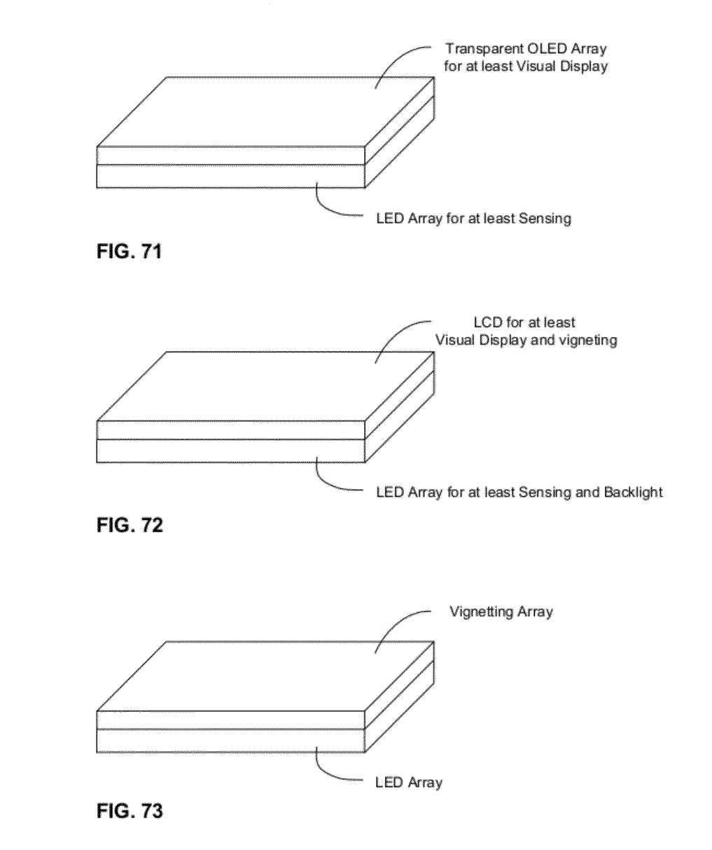

FIG. 72 depicts an example implementation comprising an LCD display, used for at least visual display, overlaid upon a second LED array, used for at least backlighting of the LCD and optical sensing. In an embodiment, the LED array can be an OLED array. In an embodiment, the LED array can comprise also photodiodes. Such an arrangement can be used to implement an optical tactile user interface arrangement as enabled by the present invention. Further, such an arrangement allows the LCD to be used for vignette formation or pin-hole camera imaging; when used for vignette formation the arrangement depicted in FIG. 72 can be used to implement a light field sensor and a lensless imaging camera as described earlier. The invention provides for inclusion of coordinated multiplexing or other coordinated between the LCD and LED array as needed or advantageous. It is noted in one embodiment the LCD and LED array can be fabricated on the same substrate, the first array layered atop the second (or visa versa) while in another embodiment the two LED arrays can be fabricated separately and later assembled together to form layered structure. Other related arrangements and variations are possible and are anticipated by the invention.

FIG. 73 depicts an example embodiment comprising an LED array preceded by a vigneting arrangement as is useful for implementing a lensless imaging camera as taught in U.S. Pat. No. 8,125,559, pending U.S. patent application Ser. Nos. 12/419,229 (priority date Jan. 27, 1999), 13/072,588, 13/452,461, and 13/180,345. In another approach to be described shortly, an LCD otherwise used for display can be used to create vignetting apertures. The invention provides for inclusion of coordinated multiplexing or other coordinated between the LED array and LCD as needed or advantageous. In another approach, a vignetting arrangement is created as a separate structure and overlaid atop the LED array. Other related arrangements and variations are possible and are anticipated by the invention. The output of the light field sensor can also or alternatively be used to implement a tactile user interface or proximate hand gesture user interface as described later in the detailed description.

In another example embodiment, the second LED array depicted in FIG. 70b is used for visual display and further comprises vignetting structures (as described above) and serves as a light field sensor to enable the implementation of a lensless imaging camera, such as taught in pending U.S. patent application Ser. Nos. 12/828,280, 12/828,207, 13/072,588, and 13/452,461, and 13/180,345.

Separate Sensing and Display Elements in an LED Array

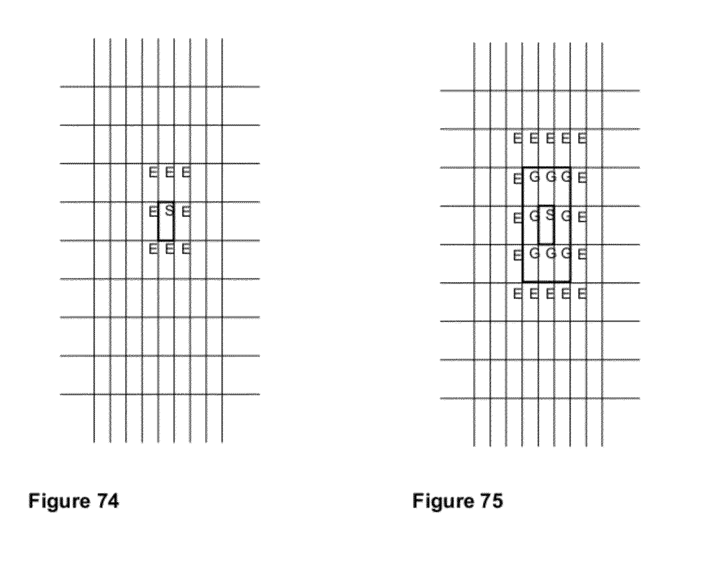

In one embodiment provided for by the invention, some LEDs in an array of LEDs are used as photodetectors while other elements in the array are used as light emitters. The light emitter LEDs can be used for display purposes and also for illuminating a finger (or other object) sufficiently near the display. FIG. 74 depicts an exemplary arrangement wherein a particular LED designated to act as a light sensor is surrounded by immediately-neighboring element designated to emit light to illuminate the finger for example as depicted in FIG. 9. Other arrangements of illuminating and sensing LEDs are of course possible and are anticipated by the invention.

It is also noted that by dedicating functions to specific LEDs as light emitters and other elements as light sensors, it is possible to optimize the function of each element for its particular role. For example, in an example embodiment the elements used as light sensors can be optimized photodiodes. In another example embodiment, the elements used as light sensors can be the same type of LED used as light emitters. In yet another example embodiment, the elements used as light sensors can be LEDs that are slightly modified versions the of type of LED used as light emitters.

In an example embodiment, the arrangement described above can be implemented only as a user interface. In an example implementation, the LED array can be implemented as a transparent OLED array that can be overlaid atop another display element such as an LCD or another LED array. In an implementation, LEDs providing user interface illumination provide light that is modulated at a particular carrier frequency and/or with a particular time-variational waveform as described earlier.

In an alternative example embodiment, the arrangement described above can serve as both a display and a tactile user interface. In an example implementation, the light emitting LEDs in the array are time-division multiplexed between visual display functions and user interface illumination functions. In another example implementation, some light emitting LEDs in the array are used for visual display functions while light emitting LEDs in the array are used for user interface illumination functions. In an implementation, LEDs providing user interface illumination provide modulated illumination light that is modulated at a particular carrier frequency and/or with a particular time-variational waveform. In yet another implementation approach, the modulated illumination light is combined with the visual display light by combining a modulated illumination light signal with a visual display light signal presented to each of a plurality of LEDs within the in the LED array. Such a plurality of LEDs can comprise a subset of the LED array or can comprise the entire LED array.

In an embodiment, the illumination light used for tactile user interface purposes can comprise an invisible wavelength, for example infrared or ultraviolet.

Sequenced Sensing and Display Modes for LEDs in an LED Array

In another embodiment provided for by the invention, each LED in an array of LEDs can be used as a photodetector as well as a light emitter wherein each individual LED can either transmit or receive information at a given instant. In an embodiment, each LED in a plurality of LEDs in the LED array can sequentially be selected to be in a receiving mode while others adjacent or near to it are placed in a light emitting mode. Such a plurality of LEDs can comprise a subset of the LED array or can comprise the entire LED array. A particular LED in receiving mode can pick up reflected light from the finger, provided by said neighboring illuminating-mode LEDs. In such an approach, local illumination and sensing arrangements such as that depicted FIG. 74 (or variations anticipated by the invention) can be selectively implemented in a scanning and multiplexing arrangement.

FIG. 75 depicts an exemplary arrangement wherein a particular LED designated to act as a light sensor is surrounded by immediately-neighboring LEDs designated to serve as a “guard” area, for example not emitting light, these in turn surrounded by immediately-neighboring LEDs designated to emit light used to illuminate the finger for example as depicted in FIG. 9. Such an arrangement can be implemented in various multiplexed ways as advantageous to various applications or usage environments.

In an alternative example embodiment, the arrangement described above can serve as both a display and a tactile user interface. In an example implementation, the light emitting LEDs in the array are time-division multiplexed between visual display functions and user interface illumination functions. In another example implementation, some light emitting LEDs in the array are used for visual display functions while light emitting LEDs in the array are used for user interface illumination functions. In an implementation, LEDs providing user interface illumination provide modulated illumination light that is modulated at a particular carrier frequency and/or with a particular time-variational waveform. In yet another implementation approach, the modulated illumination light is combined with the visual display light by combining a modulated illumination light signal with a visual display light signal presented to each of a plurality of LEDs within the in the LED array. Such a plurality of LEDs can comprise a subset of the LED array or can comprise the entire LED array.

In an embodiment, an array of color inorganic LEDs, OLEDs, OLETs, or related devices, together with associated signal processing aspects of the invention, can be used to implement a tactile (touch-based) user interface sensor.

In an embodiment, an array of color inorganic LEDs, OLEDs, OLETs, or related devices, together with associated signal processing aspects of the invention, can be adapted to function as both a color image visual display and a tactile user interface.

System Architecture Advantages and Consolidation Opportunities

The resulting integrated tactile user interface sensor capability can remove the need for a tactile user interface sensor (such as a capacitive matrix proximity sensor) and associated components.

Such an arrangement allows for a common processor to be used for display and camera functionalities. The result dramatically decreases the component count and system complexity for contemporary and future mobile devices such as cellphones, smartphones, PDAs, and tablet computers, as well as other devices.

The arrangements described above allow for a common processor to be used for display and camera functionalities. The result dramatically decreases the component count, system hardware complexity, and inter-chip communications complexity for contemporary and future mobile devices such as cellphones, smartphones, PDAs, and tablet computers, as well as other devices.

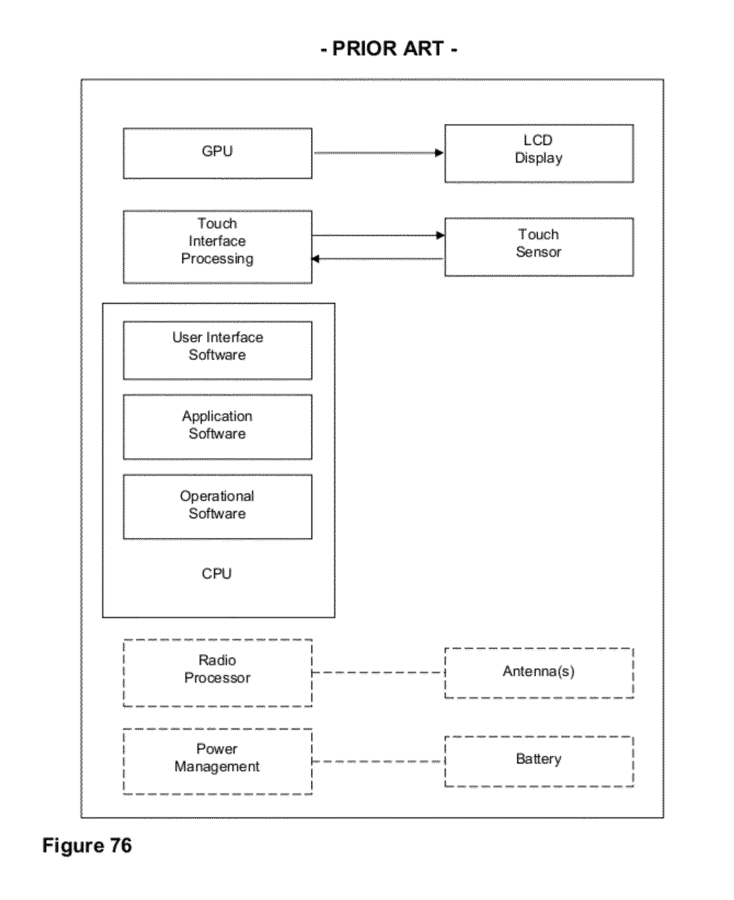

FIG. 76 depicts an arrangement comprised by mobile devices such as cellphones, smartphones, PDAs, and tablet computers, as well as other devices. Depending on the implementation and application, optionally one or more of batteries, power management, radio processing, and an antenna can also be included as advantageous or required.

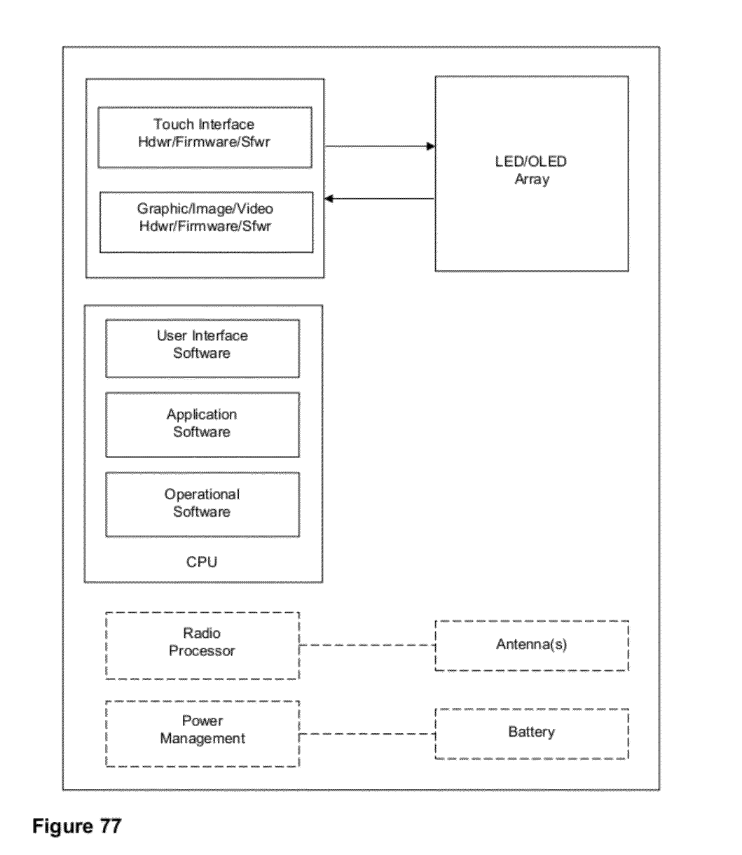

FIG. 77 depicts a variation of FIG. 76 wherein an LED array replaces the display, camera, and touch sensor and is interfaced by a common processor that replaces associated support hardware. In an embodiment, the common processor is a Graphics Processing Unit (“GPU”) or comprises a GPU architecture. Depending on the implementation and application, optionally one or more of batteries, power management, radio processing, and an antenna can also be included as advantageous or required.

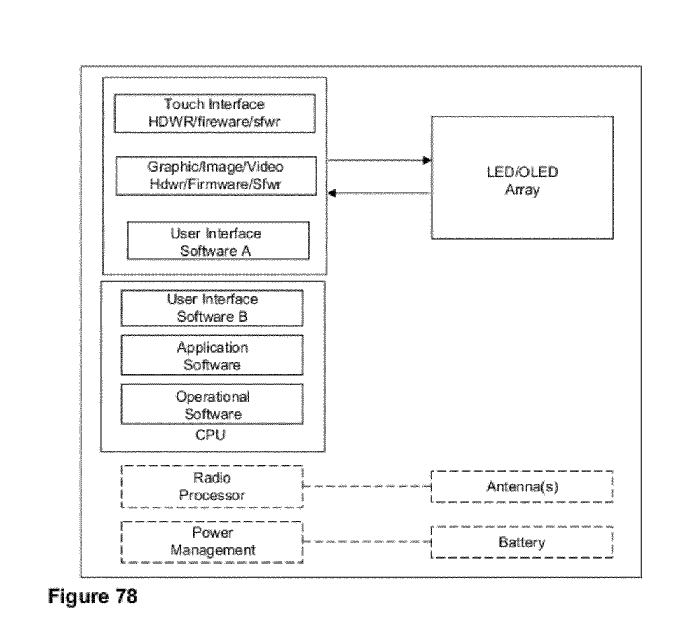

FIG. 78 depicts a variation of FIG. 77 wherein the common processor associated with the LED array further executes at least some touch-based user interface software. Depending on the implementation and application, optionally one or more of batteries, power management, radio processing, and an antenna can also be included as advantageous or required.

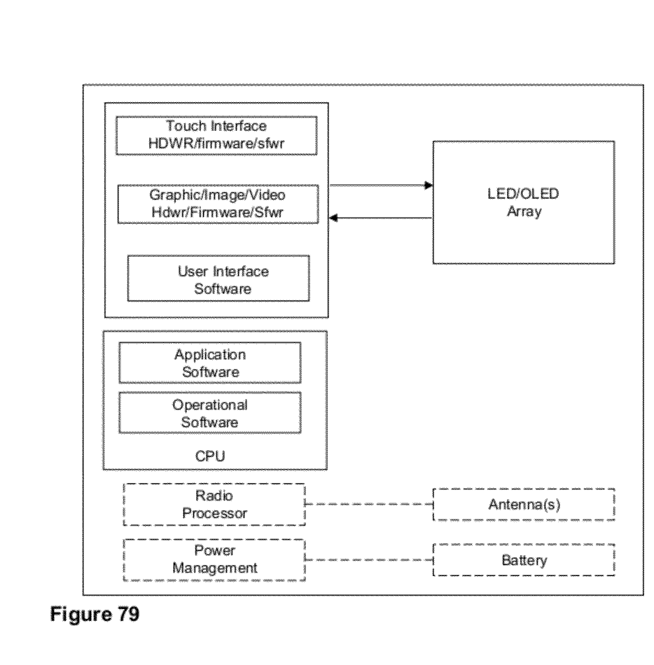

FIG. 79 depicts a variation of FIG. 77 wherein the common processor associated with the LED array further executes all touch-based user interface software. Depending on the implementation and application, optionally one or more of batteries, power management, radio processing, and an antenna can also be included as advantageous or required.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

Although exemplary embodiments have been provided in detail, it should be understood that various changes, substitutions and alternations could be made thereto without departing from spirit and scope of the disclosed subject matter as defined by the appended claims. Variations described for exemplary embodiments can be realized in any combination desirable for each particular application. Thus particular limitations, and/or embodiment enhancements described herein, which can have particular advantages to a particular application, need not be used for all applications. Also, not all limitations need be implemented in methods, systems, and/or apparatuses including one or more concepts described with relation to the provided exemplary embodiments.

I claim:

1. A touch interface system for the operation by at least one finger, the touch interface physically associated with a visual display, the system comprising:
a processor executing at least one software algorithm; and
a light emitting diode (LED) array comprising a plurality of transparent organic light emitting diodes (OLEDs) forming a transparent OLED array, the transparent OLED array configured to communicate with the processor,
wherein the at least one software algorithm is configured to operate at least a first group of OLEDS from the transparent OLED array in at least a light sensing mode,
wherein the OLEDs in the at least a first group of OLEDs are configured to detect light using a photoelectric effect when light is received for an interval of time and communicates the light detection to the processor;
wherein the at least one software algorithm is configured to produce tactile measurement information, the tactile measurement information responsive to light reflected by at least a finger proximate to the OLED array, and a portion of the reflected light is reflected to at least one OLED of the first group of the transparent OLED array, the reflected light originating from a software-controlled light source, and
wherein the processor is configured to generate at least one control signal responsive to light reflected by at least one finger proximate to the OLED array.

2. The touch interface system of claim 1 wherein the software-controlled light source is another LED array.

3. The touch interface system of claim 2 wherein the LED array is acting as the software-controlled light source is another OLED array.

4. The touch interface system of claim 1 wherein the software-controlled light source is implemented by a second group of the transparent OLEDs from the transparent OLED array.

5. The touch interface system of claim 4 wherein the first group of OLEDs and the second group of OLEDs are distinct.

6. The touch interface system of claim 4 wherein the first group of the transparent OLEDs and the second group of the transparent OLEDs both comprise at least one OLED that common to both groups.

7. The touch interface system of claim 6 wherein the first group of the transparent OLEDs and the second group of the transparent OLEDs are the same group.

8. The touch interface system of claim 1 wherein the transparent OLED array is configured to perform light sensing for at least an interval of time.

9. The touch interface system of claim 1 wherein the software-controlled light source comprises a Liquid Crystal Display.

10. The touch interface system of claim 1 wherein the processor and the at least one software algorithm are configured to operate the transparent OLED array in a light emitting mode.

11. The touch interface system of claim 1 wherein the software-controlled light source is configured to emit modulated light.

12. The touch interface system of claim 11 wherein the reflected light comprises the modulated light.

13. The touch interface system of claim 1 wherein the system is further configured to provide the at least one control signal responsive to the reflected light.

14. The touch interface system of claim 1 wherein the system is further configured so that the at least one control signal comprises a high spatial resolution reflected light measurement responsive to the reflected light.

15. The touch interface system of claim 1 wherein the system is used to implement a tactile user interface.

16. The touch interface system of claim 1 wherein the system is used to implement a touch-based user interface.

17. The touch interface system of claim 1 wherein the system is used to implement a touchscreen.

18. The touch interface system of claim 1 wherein the processor is configured to generate at least one control signal responsive to changes in the light reflected by at least one finger proximate to the OLED array.

19. The touch interface system of claim 18 wherein the processor is configured to generate at least one control signal responsive to a touch gesture performed by at least one finger proximate to the OLED array.
